(19) United States
(12) Patent Application Publication
(10) Pub. No.: US 2015/0251374 A1
(43) Pub. Date: Sep. 10, 2015

(54) Method and Machine for Transforming Initial Sealed Packagings into Irregular Cubic or Polyhedral Packagings by Means of Sealing and Cutting Flaps

(71) Applicant: Pack Save Planet, S.L., Urduliz-Bizkaia (ES)

(72) Inventor: Guillermo Lopez-Arostegui Saenz, Urduliz-Bizkaia (ES)

(21) Appl. No.: 14/566,013

(22) Filed: Dec. 10, 2014

Related U.S. Application Data
(63) Continuation-in-part of application No. 14/344,642, filed on Oct. 3, 2014.

(30) Foreign Application Priority Data
Sep. 13, 2011 (ES) P201101023
Oct. 18, 2011 (ES) P201101148
Mar. 15, 2012 (ES) P201200301
Apr. 11, 2012 (ES) P201200401
Sep. 10, 2012 (ES) P201200926

(51) Int. Cl. B31B 1/64; B31B 29/60; B65D 30/22

(52) U.S. Cl. CPC B31B 1/64; B65D 31/12; B31B 29/60; B31B 2221/20

(57) ABSTRACT

From an initial flexible sealed package, of at least two sides, intended to contain at least one fluid and in a complementary manner at least one solid or solids/granules/powdery, it becomes a modified flexible package that has a three dimensional configuration which incorporates at least one surface or support face to stay stably upright or at least one additional surface.

It comprises the first stage of pressing the outer contour perimeter or at least one of the lateral sides' perimeters of the original package inwards, through one or more impact bodies (6), to compress part of the fluid content against the outer surface of the original package, generating one, two or more flaps or triangle protruding bodies and one or more support areas or additional surfaces; and a second stage in which the configuration obtained in the first stage is permanently fixed by sealing it (preferentially in the area of the intersection of the flap and the rest of the package) through, for example, sealing jaws or sealing and cutting (8) which have a heat source of: at least one, two, three, or more than four flaps that they have wanted to originate; then this flap, can optionally be cut. Also the flap, once it is sealed, can be folded and adhered or glued to the rest of the package.

Alternatively, the flap without it being sealed and, optionally, can be folded and adhered or stuck to the rest of the packaging.

### PURPOSE OF THE INVENTION

It belongs to the packaging and container manufacture industry. Specifically, the invention refers to, according to a first object, a procedure to transform partly sealed flexible containers that contain or are assigned to contain a product that holds, at least partly, some fluid (with solids or without them), to transform the initial containers into final containers with stability to stand, increase the pressure of the container which enhances dosing and to create multiple and different types of containers. The invention fits in sectors not related to the food industry (cubic containers for motor oils, chemical products, cleaning products, cosmetics, perfumes, colognes, paints), as well as, mainly, in the food sector, for example: flexible sterilized plastic containers that hold the fluid destined to be frozen to insert the container on beverages and to make drinks colder; containers for organs transplant, cereals for breakfast, sauces, Tetrabrik® style containers but without the external cardboard layer.

### INVENTION BACKGROUND

Through the so called vertical or horizontal filling machines, the products are packaged in flexible containers, where at least part of the contents of the container is fluid, whether because the packaged product is a fluid [(liquid or/and pasty . . . ) or/and (air or/and gas . . . )], whether because the container contains some fluid, typically air, as well as a packaged at least one solid or solids products, which may be powdered, grains, bundles, pieces, etc.

Such containers, when essentially containing a fluid, such as water, sauces, etc., do not allow to be deposited on, for example, a table, in an steady way, without spilling the liquid content to the outside of the container and also when dosing with it, a bit of pressure is kept which makes it very complicated, it makes things dirty and is not hygienic. Also, none of those counts with necks or peaks coming out of the container from where it would be possible to dose comfortably. In the other hand, these containers, when also contain solids, such as cereals, snacks, etc. cannot be either deposited in a steady way in order to access to the content of the container comfortably, and also, being flat on top or from where it is poured, it is not efficient if applied with a dosing cap, since it would accumulate the solid product and whatever is wanted to be poured.

### DESCRIPTION OF THE INVENTION

This invention describes, according to a first object, a procedure to transform a flexible container, on a container that has an essentially tridimensional configuration (in other words, no of the envelope type or essentially flat), and that represents a face or support area to keep standing steadily.

The container to be transformed, also called the initial container, can be opened or closed, although it is preferable closed, and has a content which is at least partially fluid, for example liquid, thick liquid, and/or gas or air. Optionally, the content may include, other than some fluid, solid products from the previously mentioned.

The flexible containers referred present at least two faces, however they might have some additional secondary face, whether internal or external, such as the containers of the Stabilo pack® type and are sealed with two or more weldings, or, on its case, with one, two or more foldings, such as the containers of English type. The containers are produced in flexible and malleable materials of the film type on reels, being the materials possible to be selected between only plastic or also include materials of cardboard or aluminum type, as well as these can be single layer or multilayer (complex). In the other hand, they can be containers on film or on tube. Particularly, these are containers generated from at least one of two flexible and malleable films supplied on reels. It is not indispensable, but the flexible containers referred are not generally containers of the envelope type.

The initial container comprehends an external surface, as well as an external perimeter contour, in such way that the container is sealed, partially or completely (since it may be opened) by at least a sealed closing.

The procedure of the invention incorporates a first stage that tries to press rigid or semi-rigid body (also called impact clamp) laterally, in other words, in one, two or more lateral directions of the external perimeter contour, by means of a pushing mode such as the hitting or hitting one or more impact bodies against/with/in the intermediate area/end area or complete area of the external perimeter contour one, two or more lateral perimeter sides, in such way that part of the fluid is displaced to the contour of the container, producing also a local swell effect, defining at least one flap, or a body of triangle configuration with faces and of with an external perimeter contour, where simultaneously, in the area of the container which the impact body impacts with, a support face or an area limited by the support contour, or an additional surface in the external perimeter contour is generated, which allow keeping the container standing steadily, and also modify the tridimensional geometric configuration of the container.

Once generated, by means of a flap, a support face, there is a second stage that is used to keep such support face permanent, (or an additional surface in the external perimeter contour). Two alternative ways are proposed: a first way is to seal, and a second way is to fold the flap to the rest of the container and to stick it against the rest of the container.

Particularly, according to the first way, it can be noted the possibility of sealing, by one or more of the faces and/or in part of the external perimeter contour, of at least part of at least one flap of body of triangle configuration, defined on the pressing stage, using sealing clamps or rigid or semi-rigid sealing bodies that count with at least one heat source.

The second way mentioned comprehends a first stage of folding the flap, or the body of triangle configuration to the rest of the container, as well as it comprehends a second stage of adhering such flap, or such body of triangle configuration to the rest of the container, employing a means of adhesion, for example, contact glue or hot air.

The folding and adhering option may also be carried out after the sealing procedure. Also, it can be accepted that a sealed flap is cut later, to remove it from the container, leaving a bigger or smaller burr, as desired.

According to the explained before, it is stressed that the invention procedure is the only one which makes possible the manufacture of volumetric containers (not essentially flat) as the cube, the rectangular prism or the irregular polyhedra with only plastic, without the need of using sheets that comprise more rigid materials such as tetrapack's cardboard, since the procedure introduces some sealing welding lines and some flaps, which may be cut afterwards, as well as an intersection pleat between the container and the flap and being this adhered or attached to the same container body: which give the container sufficient rigidity and consistency as to stay standing steadily. Also, by means of the invention procedure, multiple and different forms of final containers are obtained, volumetric with tridimensional geometric body shapes, inconceivable until now as for example may be: the regular hexahedra, rectangular prism or irregular polyhedron. Also, these may keep standing steadily and may be of any capacity, in particular, of very small capacities (15 ml; 25 ml; 50 ml, etc.) for which until now have not been designed flexible containers that stand, which is very useful, for example, for the sauces containers (mayonnaise, ketchup) which are used in restaurants. Also the following advantages are worth stressing out:

a) The containers can also be manufactures with only plastic, since the welding lines of the sealing and cut process (sectioning) of the flaps, gives rigidity and consistency to the container. Therefore, it is not necessary to use materials such as die-cut cardboard or marked with grooves already preset on the sheets, which are winded later and introduced into the vertical packing machines.

b) Savings in logistics, having no flaps, since this makes the container to weigh less and also have a more reduced size by taking part of the wrapping.

c) Energy saving, since it avoids the cutting of trees and their later extraction of pulp and manufacture of paper reels and because, since this material is produced in the northern countries, its later distribution to the rest of the countries is avoided.

d) Environmental: by reducing waste, which mostly end up underneath the soil, since that firstly the external cardboard layer or sheet is removed and since the flap sealing and cutting system also avoids that these end up underneath the soil since they will be duly recycled in the production plant.

e) Since these tridimensional containers of the invention may be manufactured with only plastic materials, in other words, without carrying the board card layer typical of the container such as tetrabric, when opening this container and pouring the liquid from the interior, this one comes out with a constant and non discontinuous flow, due to the flexibility of the plastic material of the wrapping that makes this one to adapt and/or adjust to the internal hole of the container.

f) The versatility of the transforming machines of the invention, since that with the same machine without the need of adding new elements or pieces, containers on 3D can be manufactured in many different ways and of different sizes.

g) The adaptation and adaptability of the machines of the invention within a comprehensive solution, as another phase of the chain or line of production, of any of the manufactures that manufactures containers of at least two faces in the present time.

The procedure previously described and its variables allow obtaining a new flexible container with the mentioned characteristics. It is, therefore, another object of the invention of a container with the characteristics described, which may be obtained by means of the procedure mentioned before.

According to another aspect of the invention, this invention describes perfection in the elaboration of tridimensional containers, for example of the Tetrapak type and similar, which in general are destined to contain liquids, such as juices, milk, etc. Such containers that are obtained are simultaneously filled in vertical machines, from sheets of film reels. The film from the reels may be previously marked with foldings in order to facilitate the configuration of the container. Generally, a container body is first obtained from the winded film and then the flaps standing out of the container body are configured. In the case of a film previously marked, the flaps are defined by means of the referred folding marks. The inventions proposes to treat such flaps the same way the previously mentioned flaps are treated, to proceed to seal such flaps or, alternatively, in an analog way to the above described, fold and attach them, or also seal them and cut them after.

Transformer Machines of Initial Containers into Containers of Tridimensional Geometric Body

1—Model A of Transformer Machine:

First stage: create the initial container of at least two faces, in an inductive and spontaneous way; one, two, three, four or more of the flaps or triangles that every initial container has and also, at the same time, that the initial container transforms in form of a tridimensional geometric body.

Through some sets of clamps that form a perfect cubic cavity where the initial container which is within these clamps swallows when these clamps do not block and compress or pressure it by all its sides, so this way, naturally and spontaneously, by its own, it acquires the cubic shape by adapting to the cubic space desired to be created by the use of these clamps.

Second stage: after that, two impact clamps will be triggered; these are placed in a perpendicular way to the self-centering clamps and underneath or not of the two/one (as wanted) free clamps of superior limit. These will be placed exactly between the flaps or triangles that rose, and will be triggered by means of a pneumatic or electrical cylinder; at the same time, these might be individual, one for each side of the container that holds the flaps, or otherwise, go together in the same pneumatic or electrical cylinder of double tappet and double effect, so this way, they work at the same time.

They will fulfill two objectives, to help the container to acquire a shape of a perfect cubic figure and that the flaps or triangles have the same homogeneous size and shape on each container. Also, these will serve as base or support for the sealing and cutting flaps to hit against it.

And finally, one, two, three or four actuators or electrical or pneumatic cylinders will be triggered—one for each flap—, where each one of them will have a sealing or sealing and cutting flap integrated, which by means of a heat mode (resistance, ultrasound, friction, laser) will seal or seal and cut one, two, three or four of the flaps or triangles. Optionally, the flap can be also left: folded and attached, sealed, folded and attached, or sealed without folding.

2—B1 and B2 Model of the Transformer Machine:

First Stage: create the initial container of at least two faces, in an inductive and spontaneous way: one, two, three, four or more of the flaps or triangles that every initial container possesses and, also, at the same time, that the initial container transform into the shape of a tridimensional geometric body.

By means of one or more holding clamps or by one or more sets of two or more holding clamps, which will hold/block and/or immobilize the initial container but keeping a continuous strength on it with an adjustable cushioning, to the interior or to inside of the same initial container, in which this may be disposed/placed in the position wanted (vertically, laying horizontally, vertically to one side, vertical on different degrees of sloping, etc.): for then, the action of a hit from an impact body/clamp on one, two or more of the perimeter lateral sides, one or two flaps arise, or also by the hitting of the surrounding areas of one, two, three or more vertexes or peaks of the initial container: arise in a natural and spontaneous way, a flap. At the same time, the initial container swells or increases volume (by way of a soufflé), acquiring this way the shape of a geometric body on 3D to which we wanted to specify.

Second Stage:

Next, immediately after and for it to definitely keep the shape which was intended to be given or specify of a tridimensional geometric body: the sealing or sealing and cutting clamps will be triggered, to seal or seal and cut the flaps or triangles: by the crosswise (or approximate) of the flap which is making contact or joining the flap and the body or the rest of the container. Optionally, the flap can be also be left folded and attached, sealed, folded and attached, or sealed without folding.

3—C Model of the Vertical Transformer Machine of Containers on 3D:

This machine is designed for the initial container to be placed and be transformed, being this on a vertical standing condition where, also, all the clamps and elements that are part of it, are oriented in movement and position, in regards to the initial container.

It can additionally be added to this machine in vertical or to any of the machines of the invention, at least one or more than one of the following elements, devices or pieces:

A) Trap door which is placed below the initial container or below the holding clamp or the initial container, and is height adjustable.

B) Fixing bars which include two ways of support and place under the holding clamps:

C) Blocking fence anchored or fixed vertically on top of the trap door.

D) Guide clamp set to the tappet of a linear cylinder or of a rotating cylinder.

E) Sweeping bristles which are hooked or attached to the edge of one of the sides with more length of the trap door.

F) Air trigger to push the containers and flaps out.

G) Rotating cylinder/engine for dump truck.

H) Linear transfer units to transfer the cylinders, clamps or any other device or piece from the transformer machine sideways.

I) optic sensors, infrared, of movement, of position, etc.

J) valves that control the movement and intensity of the cylinders.

Procedure of Machine in Vertical Container Transformer on 3D:

The initial containers are transformed, being this in vertical position as for example: standing vertically, standing lying down, to one side vertically, to one side lying down. For which, all these clamps, cylinders, devices, actuators, elements or pieces that may be part of each one of the vertical transformer Machines of initial containers on volumetric containers on 3D of the invention: they will be almost suspended in the air, supported on some type of support, around the initial container.

The procedure includes the three following Stages:

First Stage:

The initial container is places between the holding clamps (3) in vertical standing position. The clamps (3) grab the initial container exactly by the crosswise area or line of this, with the purpose of making it stand out both the top and the bottom with the same amount—or approximately—of the container or part of the container. Next, the holding clamps (3) grab the initial container maintaining constant pressure (for the liquid or air/gas content distributes itself or makes pressure on the tips or side ends of the initial container) but with cushioning (for it to shrink when the container increases volume or inflates when being hit by the impact clamp (6).

The clamps or sets of two or more holding clamps (3)—as many as there are on each machine—are also triggered or propelled by linear cylinders (9) o rotating cylinders (16) or by cylinders of double effect and double tappet. Depending on the position in which the initial container is found (standing vertical, standing sideways or lying down, standing but with any sloping degree) the holding clamps (3) may be positioned or be placed in different positions: vertically from the bottom to the tops or vice versa, horizontally from left to right or vice versa.

On every transformation procedure of the initial containers, the holding clamps (3) will keep holding or grabbing the container without releasing it, which will only be released when finally the container has been transformed (once the flaps wanted or that correspond have been sealed or sealed and cut) to the cubic, rectangle prismatic or irregular polyhedric shape which is intended to be obtained.

Second Stage:

The initial container will be transformed into a cubic, rectangle prismatic or irregular polyhedric shape or of three or more faces.

This is obtained when by means of a pushing mode such as one or more impact bodies/clamps (6) which hit or hit themselves against/with one or two of the opposite sides (one in front of the other or one on the side of the other) or above any of the corners-vortexes-peaks of the initial container, therefore creating one, two, three, four or more of the flaps or triangles, since that naturally and spontaneously, when the initial container is hit by this clamp (6), this swallows acquiring, by its own, the totally volumetric shape as on 3D, which was expected to be obtained.

Each flap created transmits independently and individually the part that corresponds to the swelling, in a way of soufflé, of the container, independently of the flaps being sealed or cut.

The impact flaps (6) are propelled by linear cylinders or rotating cylinders (16) (pneumatic or electric), and are located or positioned above and/or below or at the left and/or right side of the initial container.

Immediately after, the sealing or sealing and cut clamps (8) are triggered, which will join or hit with/in the lateral surface of the sides of the impact clamp (6), therefore sealing or sealing and cutting one, two, three, four or more of the flaps/triangles that have been previously created.

4—D Model of the Transforming Machine by Means of a Robot:

First Stage: create on the initial container of at least two faces, in an inductive and spontaneous way: one, two, three, four or more of the flaps or triangles that every initial container possesses and, also, at the same time, that the initial container transforms into the shape of a tridimensional geometric body.

In which the claw of the robot that counts with holding clamps grabs and/or blocks and also directs and/or manipulates the initial container, therefore conducting one or more times any of the lateral sides or vortexes of the initial container: with/in/against/above one or more immobile and/or mobile impact clamps of one or two pieces, therefore creating one or two flaps every time.

The initial container may be grabbed both by the crosswise area of the center or to the center as by the center itself, or also by any of its sides and/or ends opposing or contrary to the side where the flaps or triangle shape bodies are going to be created.

This clamp will have the wanted or specified width and length as for to create a flap or triangle, which depending on the width of this: The bigger the width of the impact clamp, the bigger will be the flap. Therefore, at the same time of creating one or more of the flaps or triangles, the initial container of at least two faces: the corresponding part will swell (the bigger the flap, the bigger will be the volume of the container, due to that the size of the wrapping will be reduce but on the other hand there is still the same amount of the packaged content in the interior) transforming this way, in an inductive/natural and spontaneous way, the initial container into a container with the shape of a volumetric tridimensional geometric body shape.

Second Stage: the flaps or triangles that have been created or which are wanted from these: by means of two sealing or sealing and cutting clamps that align themselves, these will seal or seal and cut transversely (or approximately) one, two, three, four or more of these flaps/triangles. Optionally, the flap can also be left: folded and attached, sealed, folded and attached, or sealed without folding.

5—E Model of the Transformer Machine by Means of Two Robots:

First Stage: create in the initial container of at least two faces, in an inductive and spontaneous way: one, two, three, four or more of the flaps or triangles that every initial container possesses and, also, at the same time, that the initial container transforms itself into a tridimensional body shape.

The first robot counts with or has attached on its claw, one or more sets of two or more holding clamps.

The second robot counts or has attached one, two or more double/triple/quadruple sets of clamps as well as any of the pieces, elements or devices of any of the transformer machines of initial containers into 3D containers, of the invention.

The first robot of 5/6 axis, therefore, has the function of directing the initial container into a particular fixed place and in the correct position (also the robot, it it were the case or depending of the transformer machine to be used, it can rotate the container above itself, therefore placing any of its lateral sides in the position wanted), once the initial container is grabbed-held-blocked and/or immobilized but with regulating-adjustable cushioning.

Also, three robots may be used: in which one grabs, directs and/or immobilizes the initial container and the other two robots that count with sets of clamps on their claws, hit with the impact clamp two of the sides (one in front of the other) of the initial container.

Second Stage: the same procedure than the explained in the previous section, in the transformer machine by means of a robot.

6—Procedure through the Creation of Flaps or Triangles, which are Later Attached or Adhered to the Body or the Rest of the Container that has Previously Acquired Already the Shape of a Geometric Body on 3D:

This procedure includes two stages:

First Stage: one or more impact clamps (6) which hit or hit themselves with/against/in the intermediate area (the part wanted between two vertexes or corners), partial area (always leaving without hitting the wanted area of one of the corners or vortexes), end area (hitting only the wanted part of the vortex or corner) or complete area (hitting the totality), or vice versa, of one, two or more of the lateral sides or lateral borders that border the perimeter of the initial container of at least two faces, this way appearing or creating one or more flaps or triangles or one or two flaps or triangles for each lateral side, and for, also, at the same time and instantaneously, the initial container swallows or increases its volume, due to that there has been a reduction (proportional to the size of each clamp or triangle created, since that the bigger the flap, the bigger will be the volume transmitted) of the size of the wrapping of the initial container and maintaining this the same amount of packaged content in the interior, which will cause with this, that in a natural and spontaneous way by itself, the initial container acquires or transforms itself into the shape wanted to be obtained of geometric body on 3D of three or more faces.

Second Stage: immediately after having created the flap(s) or the triangle(s) wanted, and that the initial container has acquire the shape of a volumetric tridimensional geometric body that we wanted to give or obtain, these flaps or triangles (as many as we may want) by means of a mode, will be permanently folded and attached to the rest of the container. Optionally and before the flaps are attached to the container: the flap or triangle may be sealed (by the intersection of the flap and the container) by means of one or more sealing clamps.

7—Procedure to Transform Initial Containers into Containers of Tridimensional Geometric Body by Means of Emptying and Folding:

Transformer of initial containers of at least two faces, into containers of tridimensional geometric body which only contains air and/or gas on the inside.

On this case, it is only about modifying/adapting the packaging machine in vertical/horizontal that manufactures the initial containers and which is available on the markets in the present day, for instead of being able to package or fill with fluid [(liquid or/and pasty . . . ) or/and (air or/and gas . . . )], and with at least one solid or solids/powdered/granulated or without them, fluid (air and/or gas) is packaged or filled only on the inside of the initial containers.

Next, this initial container shall be transformed into the wanted shape of a tridimensional geometric body and afterwards, by means of a way of emptying the air and/or gas contained inside it, it will be emptied, this way being folded over itself. After that, it will be packed and finally, taken to other production plants, where by means of filling, any substance or object wanted will be packaged

Also, it can be adhered/attached on the top part of this type of container, a “dosing cap” of the tetrabrik type, therefore on one hand allowing an easy and practical filling/packaging of the container and, in the other hand, to facilitate the emptying of air of the container with the shape of a tridimensional geometric body.

In any case, these caps are optional, since it would be enough to only introduce any substance or content through any of the dosing necks or outstanding tips that would have been previously created for such end or for the occasion. Therefore, the filling machine in vertical, will perforate the plastic of any of the outstanding necks or tips as a way of dispensers, for later introducing by them anything wanted to be packaged and, finally, once these finish filling, conclude with the sealing or sealing and cutting of this perforated outstanding neck, tip, or mouth.

8—Welding Lines of the Invention and of the Containers Already Transformed with the Shape of a Tridimensional Geometric Body.

Perimeter Welding Lines (1)

Any of the containers transformed on 3D of the invention may carry or have at least one or more than one Perimeter welding lines (2) in vertical, in horizontal or with different degrees of slope.

These welding lines (1) are placed or located in regards to the containers already transformed into the shape of volumetric figure on 3D: in the half or in the middle of any container or of each face of the container, therefore if we cut the container by this welding line (1), this would split in two segments always equal longitudinally or equal halves, being these two halves and provided that we have the container in front of us (detailed view) and in vertical standing position: One twin part of the front side of the container, and the other twin part of the back side of the container already transformed with the shape of the volumetric figure on 3D that was wanted to be obtained or required. These welding lines (1) are located placed or may be located in regards to the initial containers: on any of the perimeter lateral sides (1) that the initial container may have. Being possible to have for each container: one, two, three, four or as many lateral sides (1) that the initial container may have, provided that the initial container has the shape of an irregular figure, or that it is not cubic nor rectangular prismatic.

Perpendicular welding lines (2), that appear or result of the sealing or sealing and cutting action of the flaps or bodies of triangular shape, that have been previously created. There may be placed on each container transformer on 3D as many flaps or triangles that can be created on an initial container. The welding lines (2) are perpendicular to the perimeter lateral sides or welding lines (1).

When it is more optimized is when it is sealed or sealed and cut by the part or area of intersection (or approximate), between the flap and the rest of the container.

Also, these welding lines (2) may be made in different ways, as for example, rectilinear, diagonal, curvilinear, semicircular, semicircular elliptical, semicircular concave or convex, sinuous, of teeth or saw, of many lines in different directions and with the slope and shape wanted.

Also, if we start from an initial container which is sealed by all of it external perimeter contour, at the creation of any of these flaps, by the center of this welding line (2), it can be seen the detail of how exactly there are some perpendicular marks to this welding line (1), due to that at the creation, sealing or sealing and cutting of the flap or triangle, the perimeter welding line is crossed (1) (made by the vertical/horizontal filling machines that manufacture initial containers of at least two faces) with the perpendicular welding line (2).

Edge Welding Lines (3).

Any flexible container or of the containers transformed on 3D of the invention, may carry or at least have one or more edge welding lines (3).

These welding lines (3), can be both horizontal and vertical, or in different degrees of slope and always be left placed or located on the ends or at the laterals (edge) of the containers already transformed on 3D.

These are carried out by means of two sets of pinching clamps (19) with catch/pinch the part wanted from these edges, leaving as the result of the welding sealing, the amount of burr/flap wanted. These weldings are optional, and they are carried out after the initial container has been transformed to the shape of a figure on 3D.

Also, these welding lines (3) have the function of giving or providing more rigidity or consistency to the container, as well as provide a weld line opening through which opening the container.

Longitudinal Welding Lines (4).

Any of the containers transformed on 3D of the invention may carry o have at least one or more than one Longitudinal welding lines (4). On the initial containers, this welding line (4) is located or may be located, if we look at the container facing it in a detailed view, one in the front face and/or the other in the back face, exactly at the middle and longitudinally from the top down or the bottom up.

These welding lines (4), are located or are placed (looking at the container facing it in a detailed view and being this standing, in vertical position and sideways) in regards to the containers already transformed with the shape of a tridimensional geometric body; one in the front face and/or the other in back face, in which this/these are in vertical position (or with different degrees of vertical slope) exactly in the middle and longitudinally from the top down or from the bottom up.

Multiform Welding Lines (5).

Any of the containers transformed on 3D of the invention may carry or have at least one or more of the multiform welding lines (5), in vertical, in horizontal o with different degrees of slope. The welding lines (5) can be done and are placed in regards to the containers already transformed into the shape of a volumetric figure on 3D; on any of the lateral sides or edges both on the top part as on one side and the other, or even also on the lateral edge sides of the lower part of the container on 3D that works as a support base.

These welding lines (5), may be done or are placed in regards to the initial containers: on any of the perimeter lateral sides, but when it is more optimized is when the part wanted from the perimeter lateral sides of the top and/or the side parts on one side and to the other of the initial container is sealed and cut.

The perimeter lateral side is the lowest part of the initial container, the part wanted from it can also be sealed or sealed and cut, although in most of the cases it is left without sealing or sealing and cutting, since this lateral side will later be used (once the initial container has been transformed on 3D) as part of the face or support base where the container on 3D will settle and keep standing.

These multiform welding lines (5) may be carried out or may be had or be of different forms, as for example: rectilinear in horizontal, rectilinear in diagonal, semicircular, curvilinear, semicircular elliptical, semicircular convex or concave, sinuous, of teeth or of saw, of several lines in different directions and with the slope and shape (rectilinear, sinuous, curvilinear, semicircular) wanted.

Next, Different Processes or Techniques of the Invention

9—Multiform Clamps of Sealing and Cutting Over Plane.

A process by which any of the initial containers of at least two faces are going to transform into multiple and different shapes of tridimensional geometric body (unique and spectacular containers due to their complex polyhedric shapes and because, also, in most of the cases, outstanding necks and/or tips/peaks are created in a way of a dispenser, with which one can pour the packaged content in the interior of the container by tearing the fissure already made in the burr or perimeter flap that surrounds any of these tips or peaks.

Therefore, it is only about carrying out the initial container—it can also be done once the initial container has been transformed, by never on the face where flaps have been created) selected or sealed and cuts with a set of two clamps (one of sealing and cutting and the other of impact or normal clamp, which align in parallel and which when triggered placed themselves over plane by both faces of the initial container) one or more of the parts wanted or of the transversal part of the top part (it can also be done on the bottom or on any of the sides that the initial container may have and adding up the sides that may be wanted) of the initial container, in which two or three of the adjacent sides can be caught-smashed if it is an initial container of squared or rectangular shape, or otherwise also of more adjacent sides, if it is an initial container of irregular shape in which there are more than four sides/vortexes.

Sealings and cuttings of multiple and different shapes and combinations can be done between them, of different types of lines: oblique, rectilinear, curved, curvilinear, elliptical, diagonal, sinuous, of saw, etc.

The can also be circular and of the size wanted, producing with these a hole that may be used as a handle in/by which the container already transformed in a tridimensional geometric body may be hung.

This procedure and processes explained in the previous section, in which the parts wanted from the initial container are sectioned, can also be done—same as any method/mechanism/operation—by directly attaching or substituting this type of multiform and multidirectional clamps to the sets of two clamps of the filling and packaging machines in vertical, which are the ones that manufacture the initial container of at least two faces.

10—Impact and Multiform Sealing or Sealing and Cutting Clamps.

The sealing or sealing and cutting of the flaps or triangles it generally transversal and is carried out by the area or line that joins or makes contact between the flap and the body or the rest of the container: it can be done or be originated being this not only rectilinear, but it also can be in diagonal, in curve, of elliptical curve or of semicircle and concave (seeing its vortexes to the inside) or convex (seeing its vortexes to the outside), in the form of saw tips, etc. Depending on one option or another, and also whether it is carried out in four (or the maximum amount that can be originated) of the flaps or in only one, two or three of these, we will obtain a container that, even if it has or it is principally distinguished, the shape of the container already transformed into the shape of a tridimensional geometric body that was pretended to be produced from the beginning, despite these welding lines of different and irregular shapes, will transmit or produce an effect on the container, which will make the volume, the shape or the outline of the container to transform again. In most of the cases, the already transformed container will alter its shape again (more curvy, arched, with vortexes, peaks or tips outstanding, etc.) even not much, since the container will maintain or will continue to show the same shape of the first transformation, as for example happens if we use a sealing or sealing and cutting clamp and an impact clamp in which the two types of clamps have the same form of elliptical semicircle laying in horizontal position in regards to each flap or triangle, since these when triggered and when attaching one to the other are going to seal or seal and cut four of the flaps making that each flaps arches to the outside, with which it will produce the rounding effect on the initial container (of two faces and four lateral sides and with the shape of a rectangular square: causing with this that the initial container transforms into a tridimensional geometric body with the shape of a cylinder or elliptical cylinder.

11—Expelling Clamps.

A process or method to control the exact amount of fluid, we want to be packaged in the interior of the initial container. Therefore, the size of the wrapping of the initial container will be regulated or controlled in regards to the amount of fluid [(liquid or/and pasty) or/and (air or/and gas)] that we want to be packaged in the interior of the initial container of at least to faces.

This is possible, when installing from below and along with the sealing or sealing and cutting clamp or clamps; one expelling clamp located in horizontal position and outstanding a little more in regards to the sealing and sealing and cutting clamp, therefore being able to exercise a smashing in a controlled and adjustable way (to the exact measure wanted to be set) above the two faces from out of the initial container and of at least two faces. This way, it will be expelled upwards and also to the interior of the initial container, which is not sealed yet on the top, the amount of fluid [(liquid or/and pasty) or/and (air or/and gas)] that we want. In turn and at the same time, we also expel in its totality and on its majority, any bubble of residual air that may remain or be found on the interior of the initial container of at least two faces.

Therefore this method has two functions: to calculate the volumetric that we may want the initial container to have, and to reduce or remove the air bubbles from the interior of the initial container.

12—Flap or Triangle Expelling Clamps.

Optionally, this same system already explained in the previous section can also be used or applied with each one of the flaps or triangles before these are sealed and cut, when joining or attaching the sealing or sealing and cutting clamp with/along with the impact clamp. Even if this were the case it will not be very necessary if the clamps (6, 8) are equal or are wider or bigger than the size of the flap or triangle that has been originated, since that, in a natural and spontaneous way, the two faces or the flaps (when joining the sealing/sealing and cutting clamp with the impact clamp) fold and join completely, therefore expelling the content (packed in the interior) that may remain trapped between the two faces of the flap.

Therefore, this process may provide in a more efficient way, even more if fits, in which there is no remaining fluid [(liquid or/and pasty) or/and (air or/and gas)] or solid trapped in the interior of the flap or triangle.

13—Pinching Clamps.

I have also developed a system or process for the containers, once they have been already transformed into the wanted shape of geometric body, to be given (although this is not necessary) more stability, rigidity or consistency, as well as provide a weld line opening through which opening the container, by means of what I have called pinching clamps which are described in the following:

It is about, therefore, carrying out any of the edges on a cubic, rectangular prismatic or irregular polyhedron: a folding in which there is always a remaining burr and/or welding line outstanding to the outside of the edge. This achieves, by means of a set of pinching clamps (one of impact and the other of sealing), that will catch (the part that may be wanted) to the left and to the right of the edge, which will therefore cause that a burr or welding line is produced, outstanding from the container.

The resulting burrs, and provided that the sealing of the container is guaranteed, may be left with the millimeters desired outstanding from the container.

14—Multiform Clamps and Rectilinear Clamps.

A clamps device (or set of 2 parallel clamps) which seals and cuts the containers (or initial containers) of at least two faces transversely and horizontally from the top and the bottom, is a device with two different types of clamps (or sets of two parallel twin clamps) of sealing and cutting, in which one of them is set of parallel twin clamps for sealing and cutting in a rectilinear way in horizontal position (being this the normally used) and the other set of twin and parallel clamps for sealing and cutting will be multiform (never rectilinear in horizontal and if it is going to be of multiple and of different shapes as for example: one or more in diagonal, one or more curvilinear, one or more sinuous, one or more rectilinear with one or more curvilinear, with saw type tip, two or more rectilinear placed on the degrees of different slope wanted, two or more lines in which these can be combined and be of any shape, with the degrees of slope wanted and also in the direction wanted, one or more semicircular and/or elliptical semicircular concave or convex, one or more elliptical semicircular(s) concave or convex with one or more rectilinear on the degrees of slope wanted, etc.)

These two different sets of twin and parallel clamps will interact together by means of mode of going alternating and combining, in which one after the other or one next to the other will be activating themselves, manufacturing with this on each manufacturing cycle (on which these sets of two parallel rectilinear clamps are activated or triggered three times (first: the set of two parallel rectilinear clamps, second: the set of two multiform parallel clamp, third: again the same set of two parallel rectilinear clamps)) at the same time one after the other: two different sealed containers or initial containers of at least two faces, which I have named or called the “ON” container and the “OFF” container.

15—Apply a Second Light Welding by Means of the Filling Machines in Vertical/Horizontal that Manufacture Containers of Two Faces, and Which are Available in the Market Nowadays.

A second lighter welding can be carried out, although this is optional, next or below and very close (at one, two, three millimeters) of any of the perimeter welding lines (1) of the outer perimeter contour of the initial container, which are used to seal the packaged content in the interior of the initial containers. This second light welding is done with few heat transmission in order to alternate the plastic less, so this way and by later doing the welding line (2) of the sealing or sealing and cutting of the flaps or triangles, this has a higher resistance or a better sealing exactly at the center of the flap/triangle, or at the center of the welding line (2) where the cross between the two welding lines (1, 2) is produced.

### DESCRIPTION OF THE DRAWINGS

In order to complete the description being done and with the objective of helping to a better understanding of the characteristics of the invention, according to a preferential example of the practical fulfillment of the same, a set of drawings accompanies as part of the description which has represented in an illustrative and not limiting way, the following:

FIG. 1: shows a general perspective of the machine of the model [a].

FIG. 2: show a detailed view of the lifting of the machine of the model [a].

FIG. 3: shows a view of the container holding system with adjustable cushioning in horizontal: models [b1/b2].

FIG. 4: shows a plant view of the container holding system with adjustable cushioning in vertical: models [b1/b2].

FIG. 5: shows a plant view of the cubic transformation machine of the model [b1] with quadruple/triple clamps: sealing/cutting and impact.

FIG. 6: shows a plant view of the cubic transformation machine of the model [b2] with sealing/cutting and impact clamps in diagonal.

FIG. 7: shows a detailed view of the lifting of a machine [c] in vertical transformer on 3D, where the initial container of bag of two faces and sealing with water in its interior is trapped (caught by the intermediate transversal area) between the holding clamps (3), being this the starting point for the start of the transformation of this initial container into 3D.

Each set of triple clamps (6, 8), is joined to a tapped from a pneumatic or electrical linear cylinder, at the same time, these two sets (up and down) are joined to the same frame, which is impelled by a pneumatic or electrical cylinder, with the only function of making the two triple sets to retract to move aside, therefore setting up space (mostly in the top part, above the holding clamps) for the initial container to be able to be introduced within the holding clamps (3), whether falling from a conveyor belt or slide, or for the robot arm or mechanical arm to place the initial container in the exact place and position.

The two impact (6) and sealing (8) or sealing and cutting (8) clamps in this case, have a triangular prism shape.

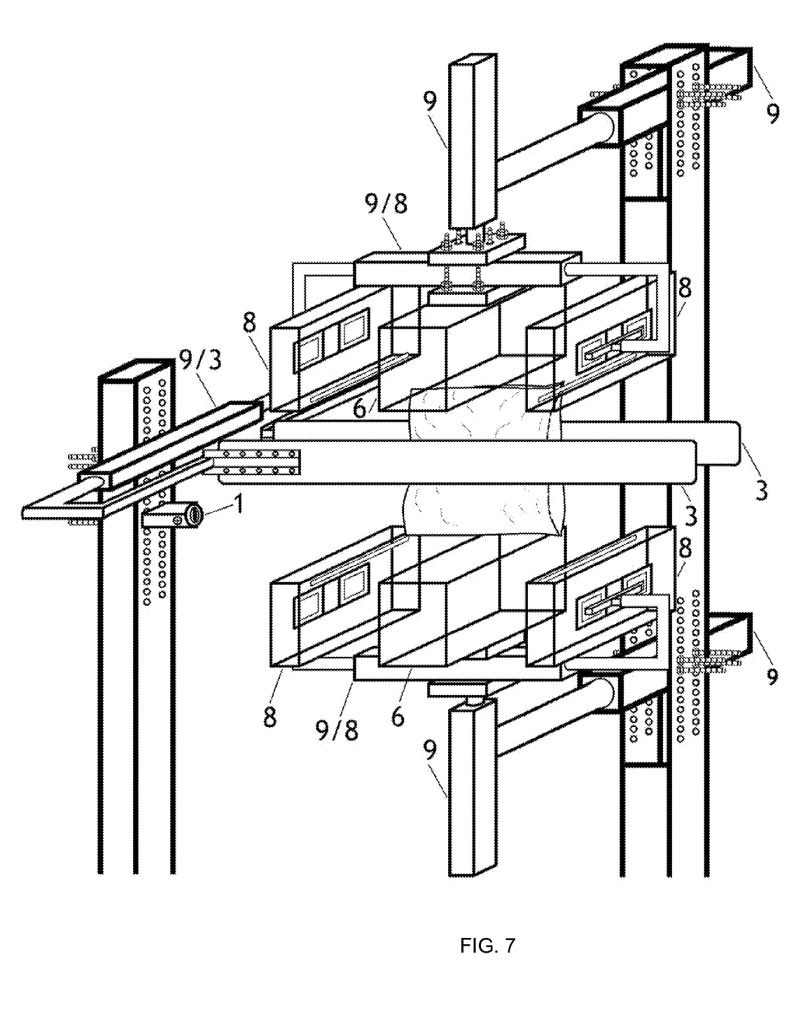

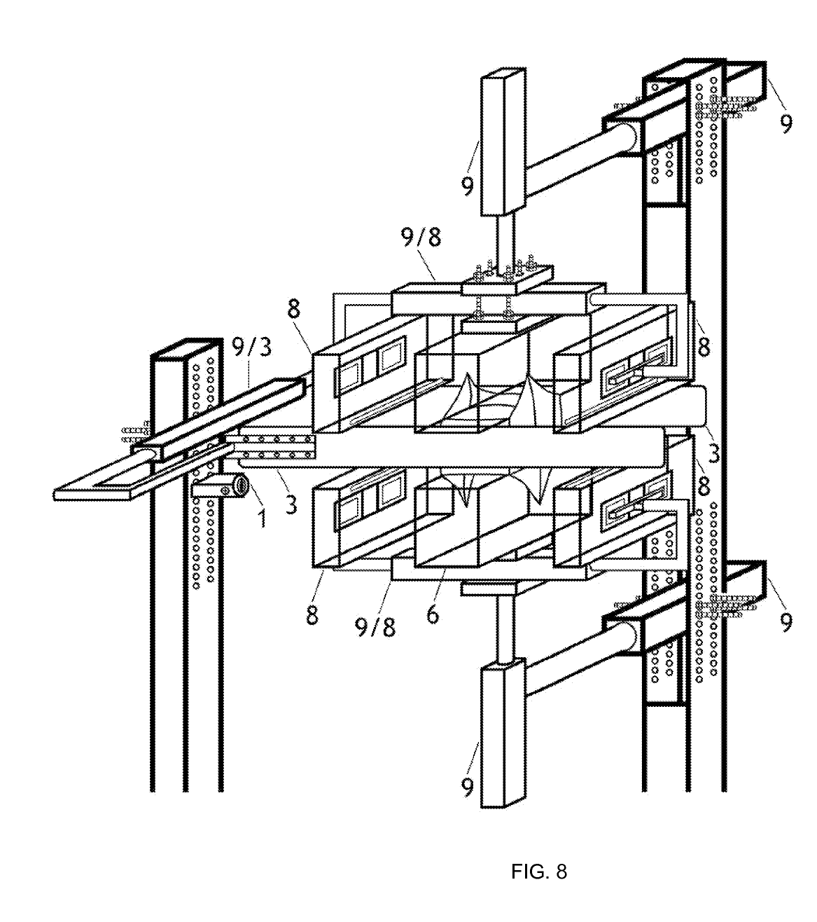

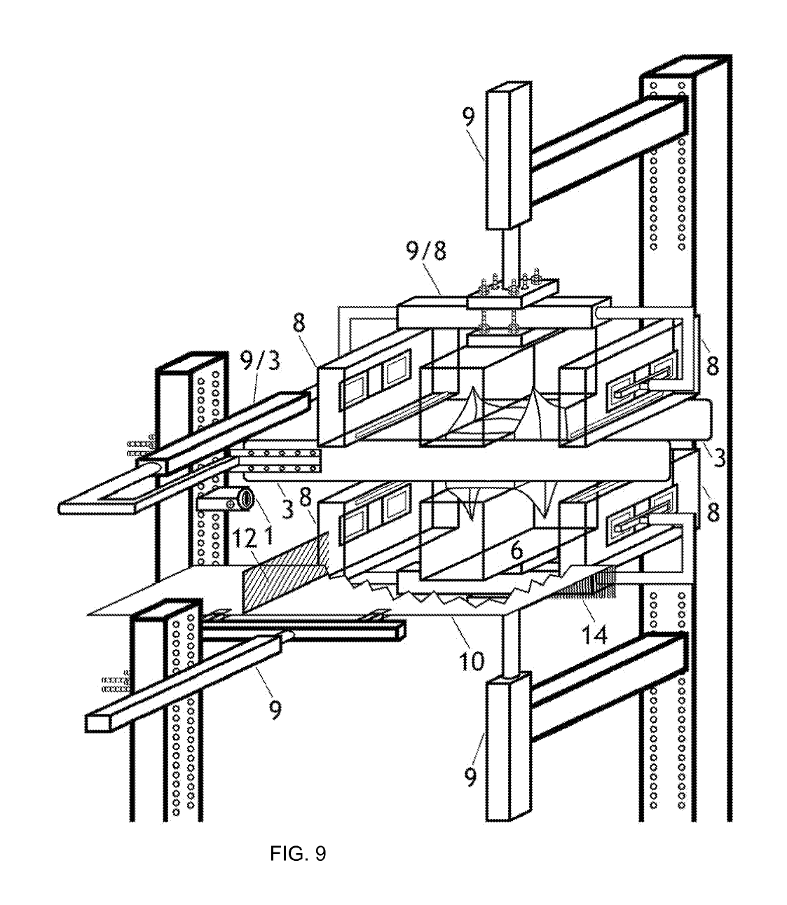

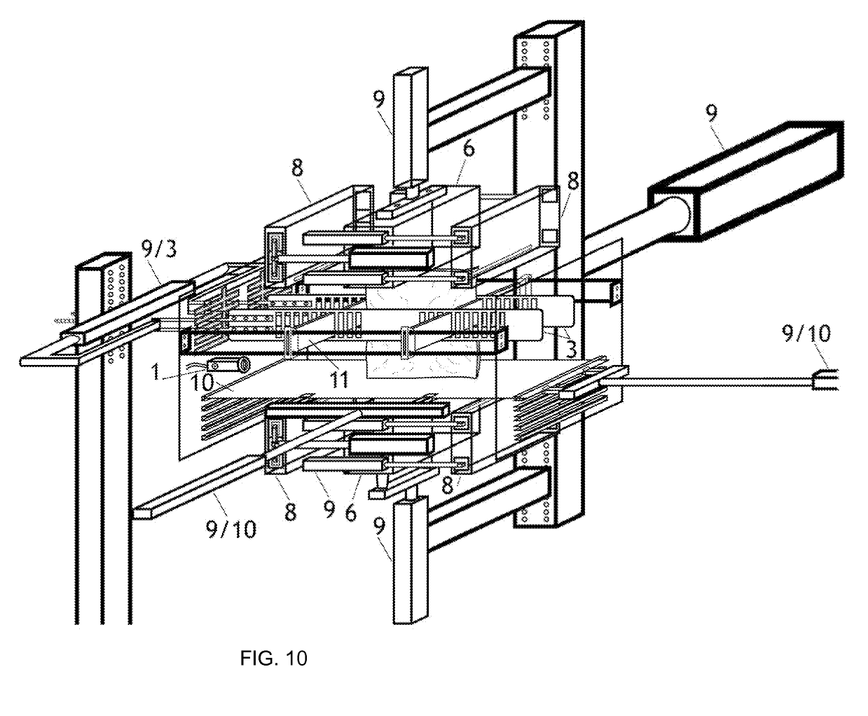

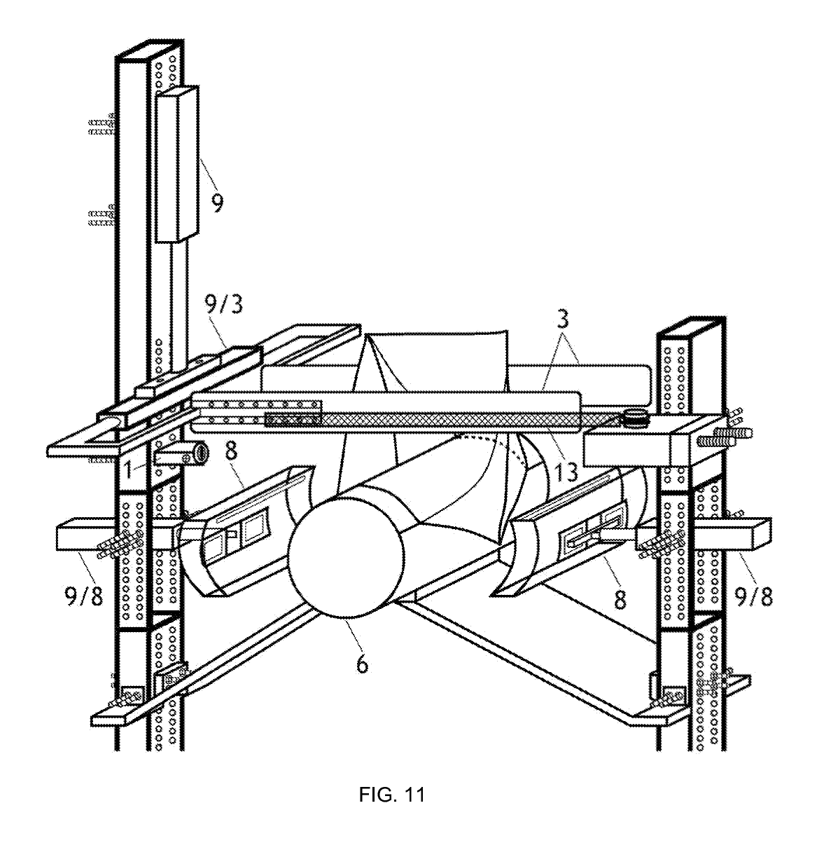

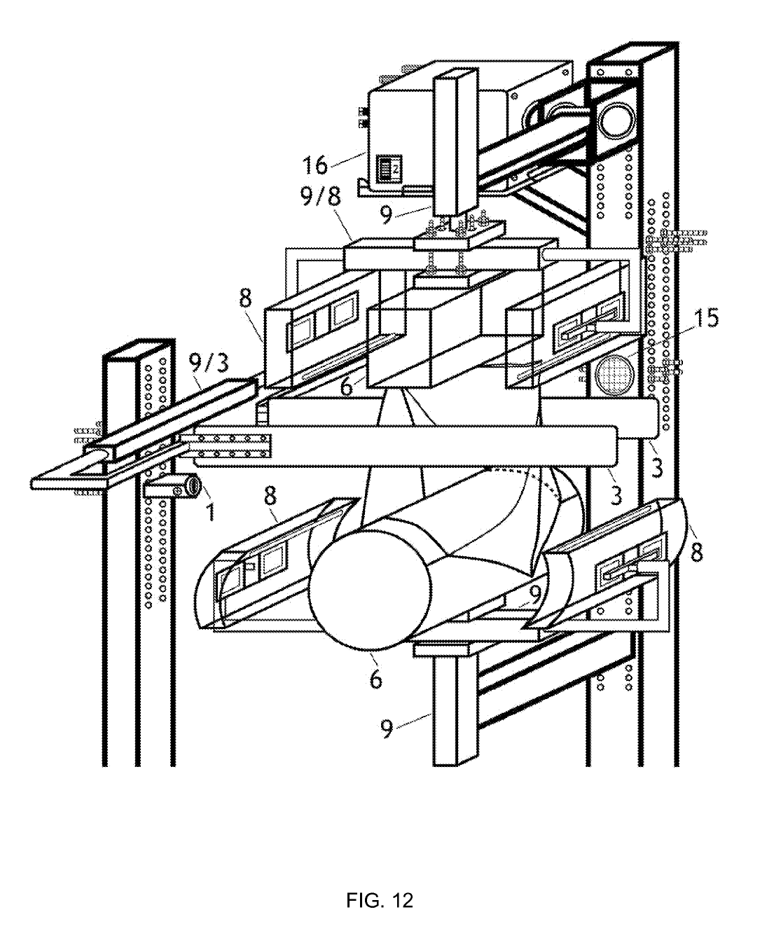

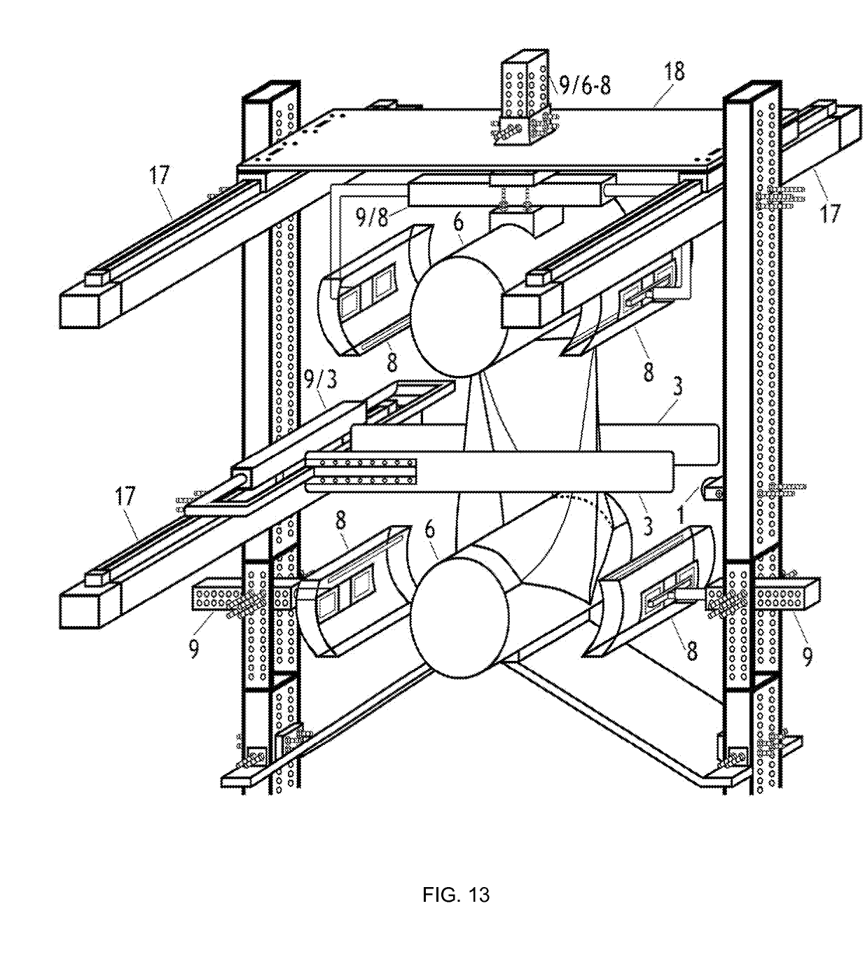

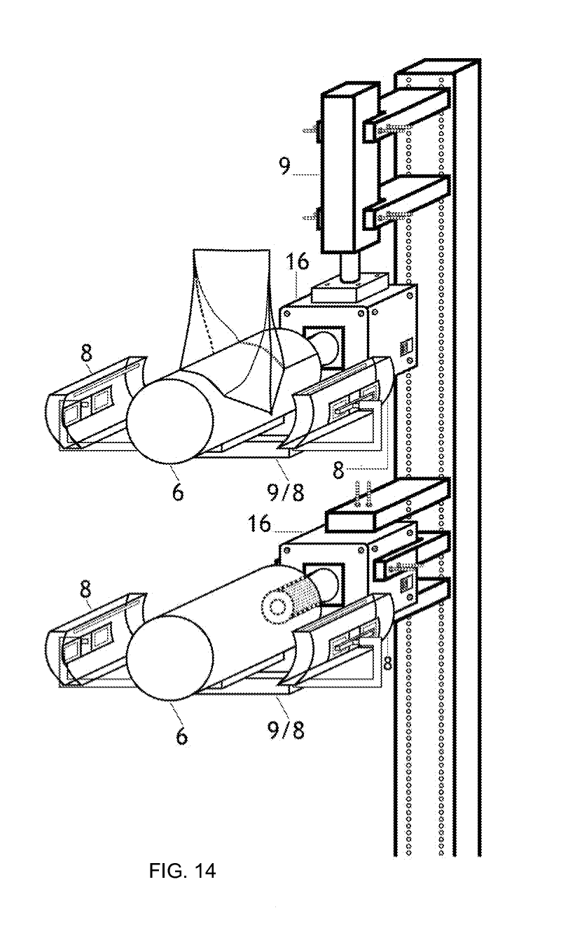

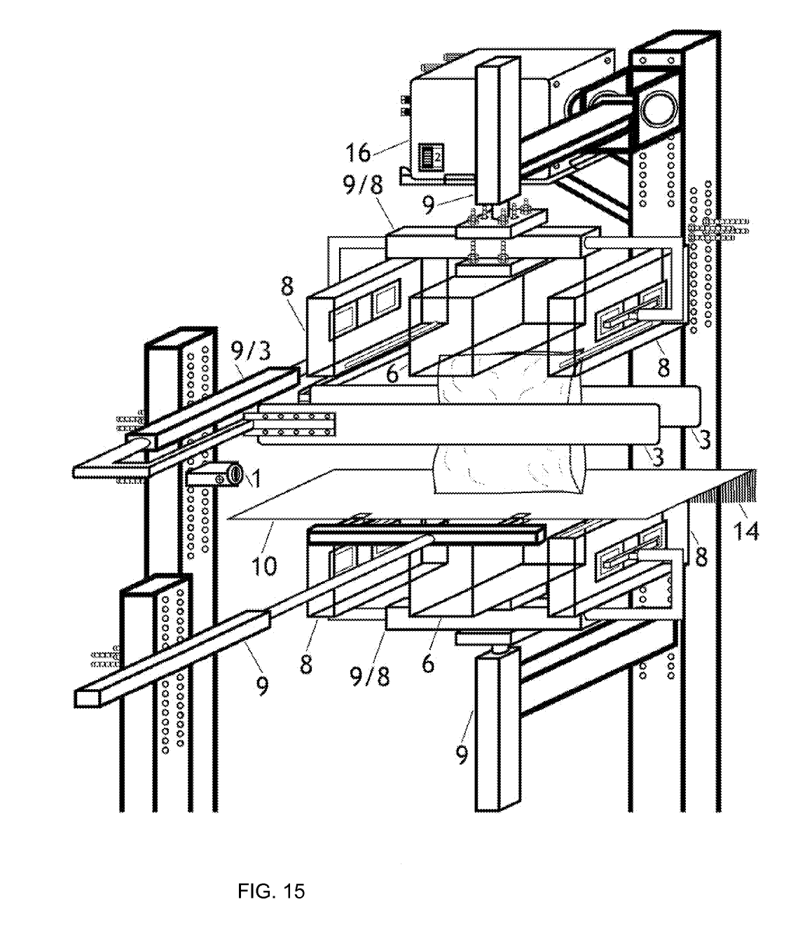

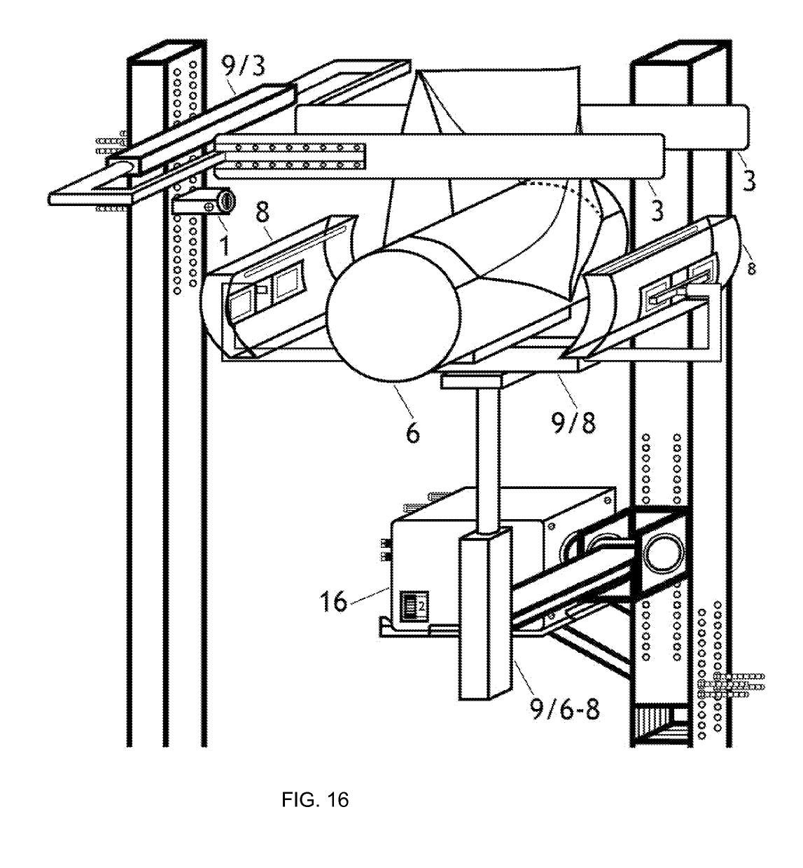

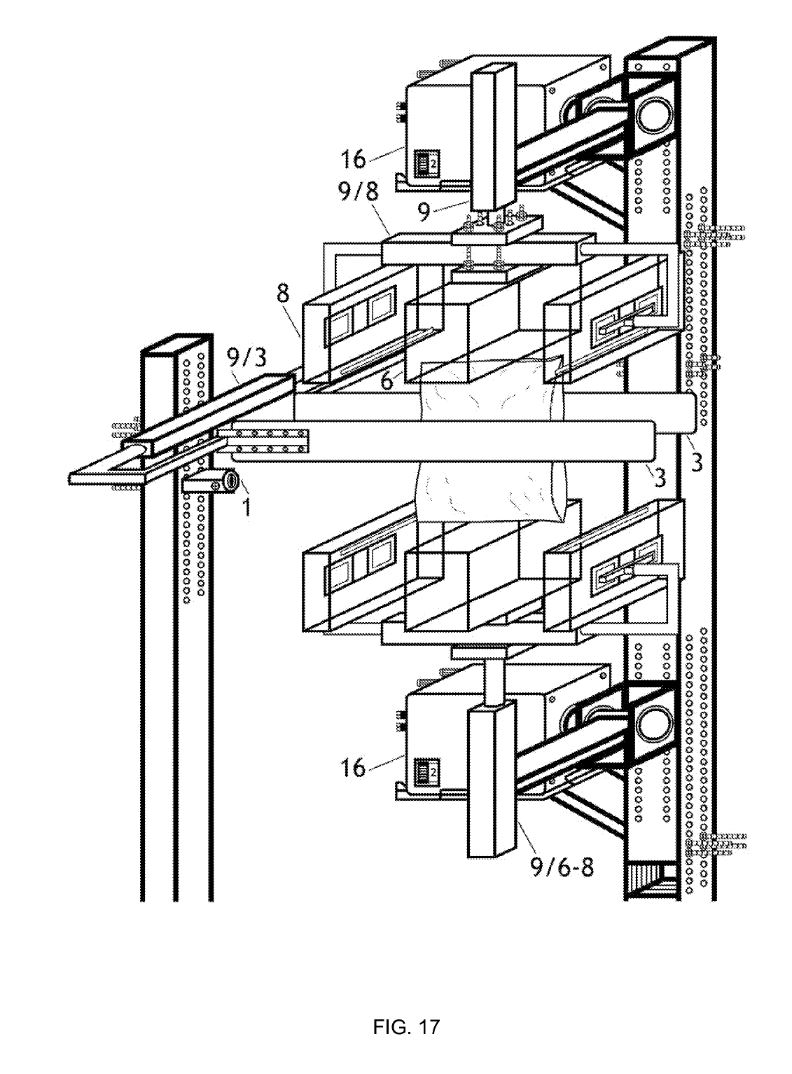

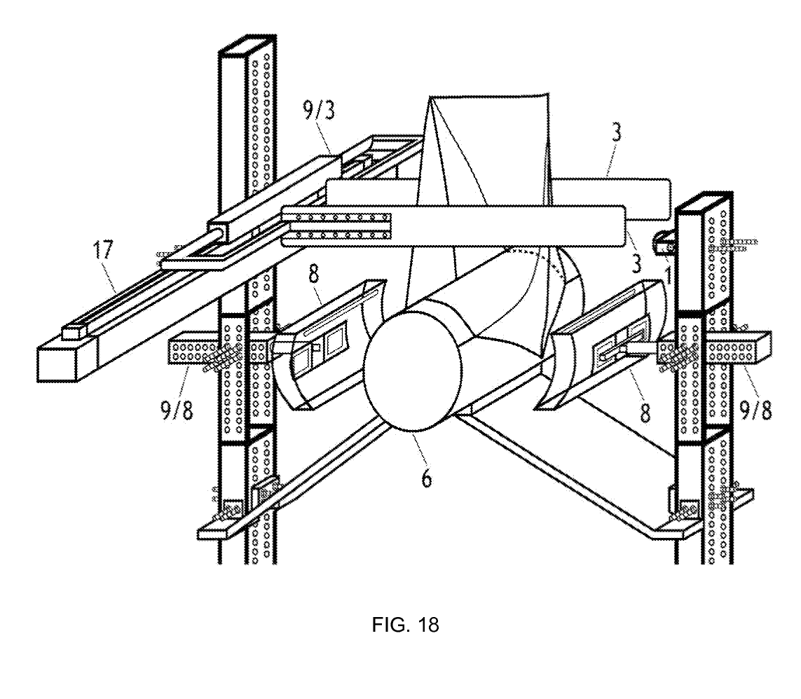

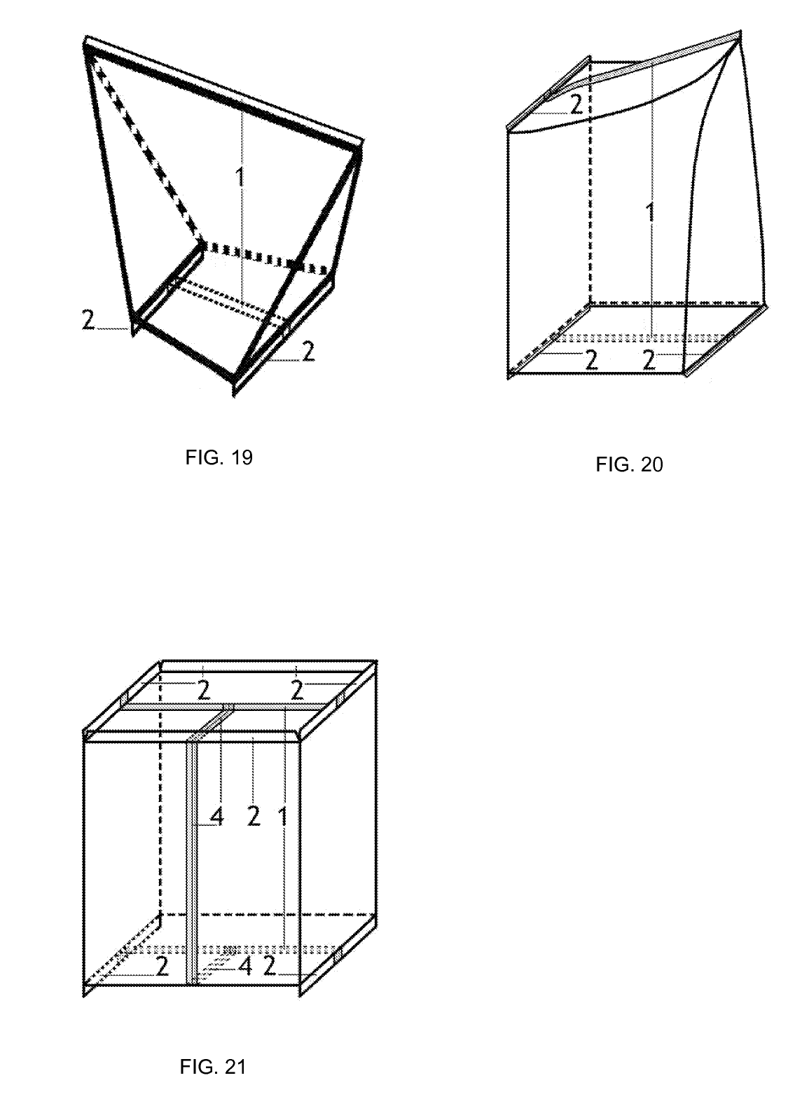

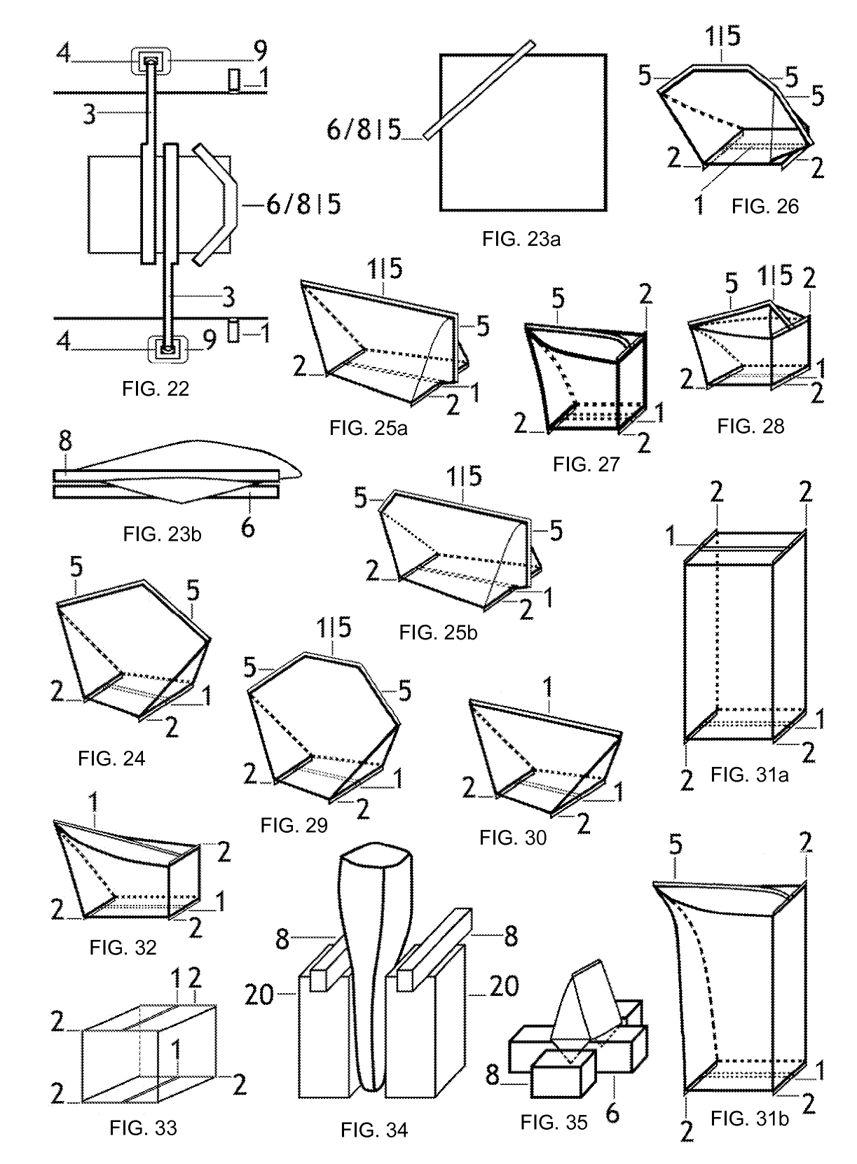

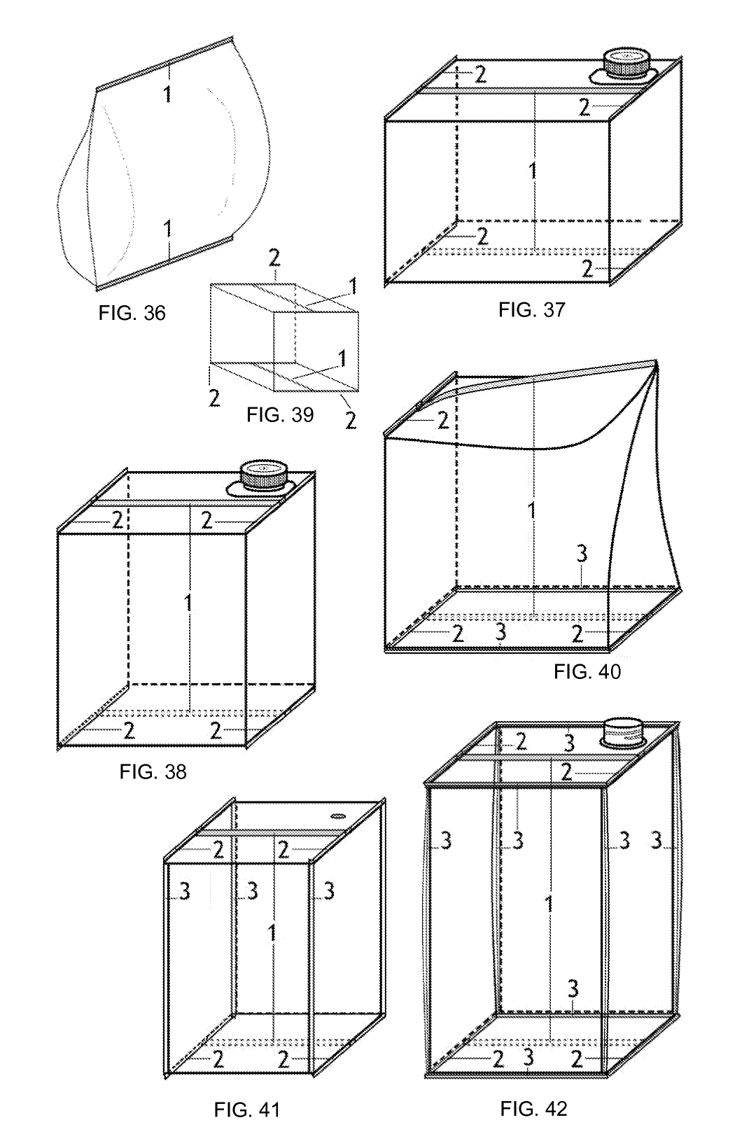

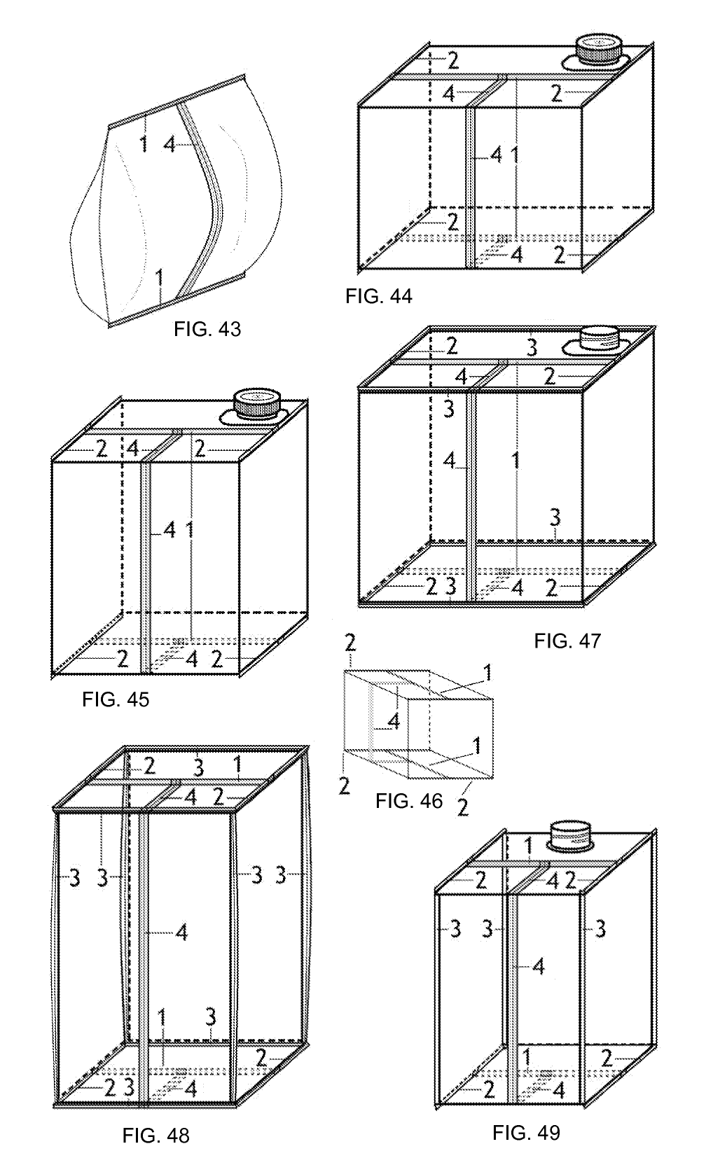

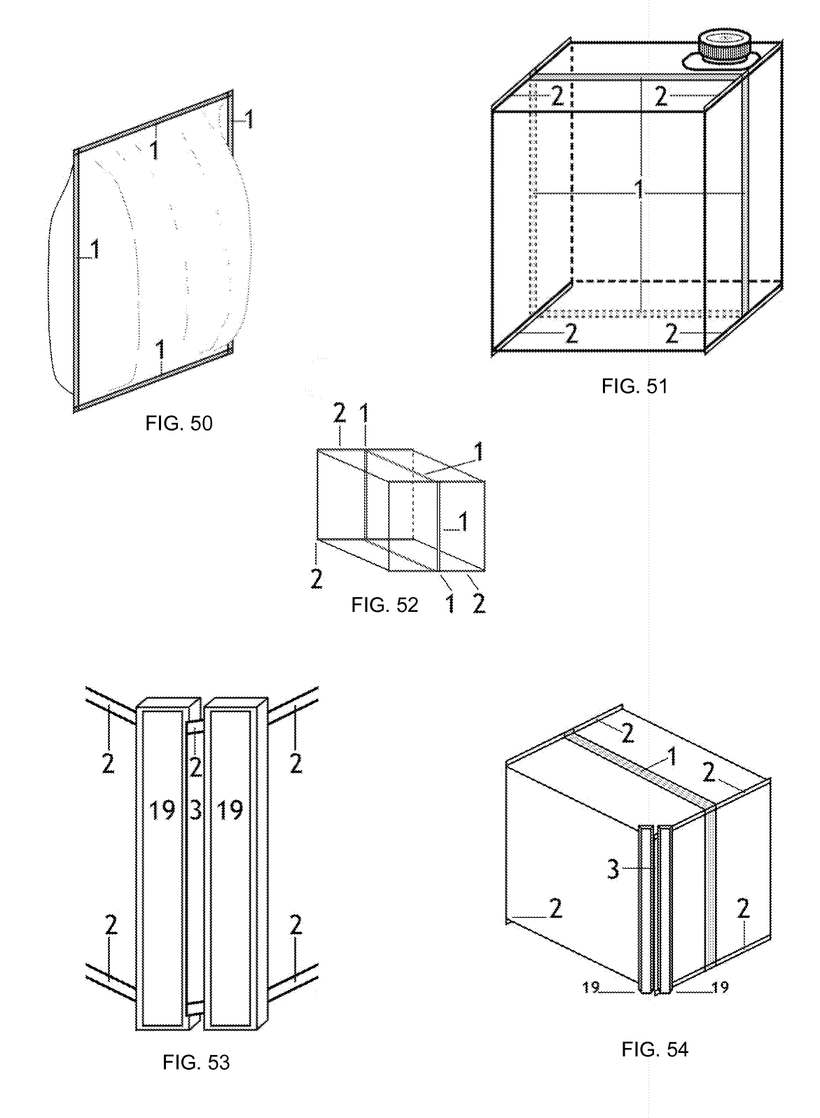

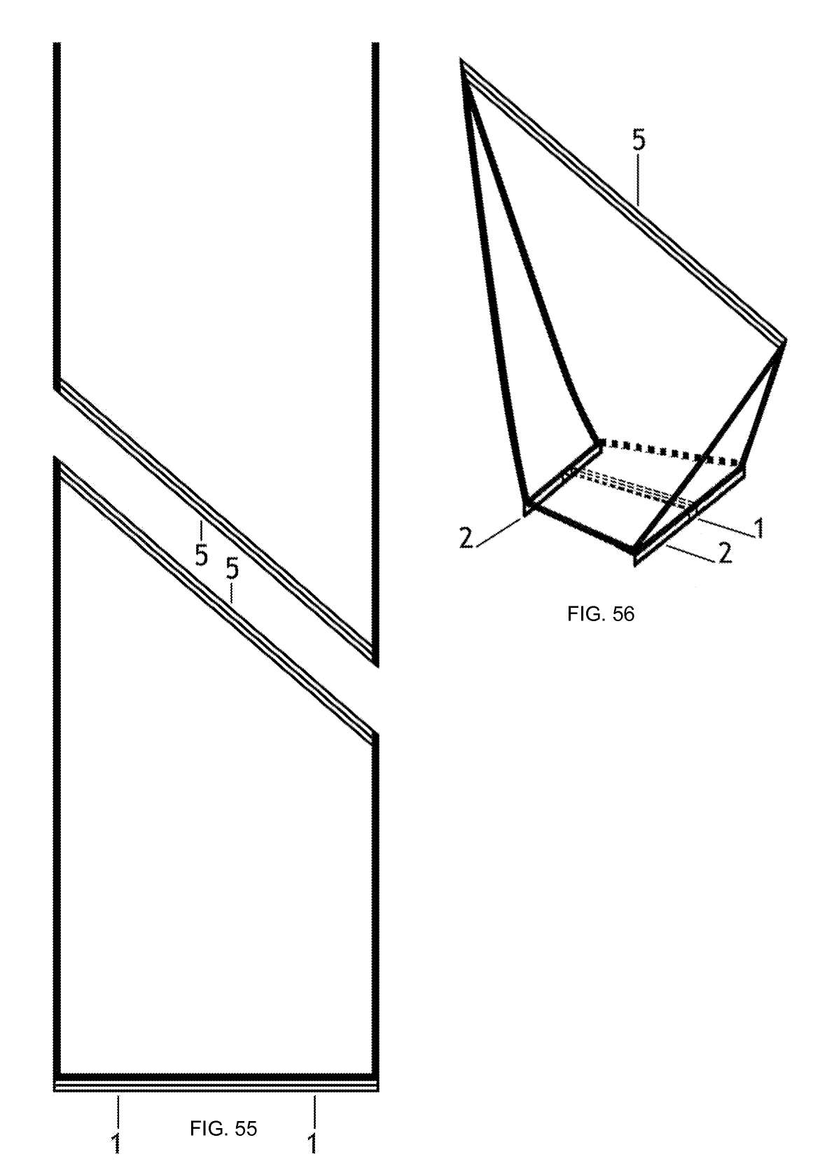

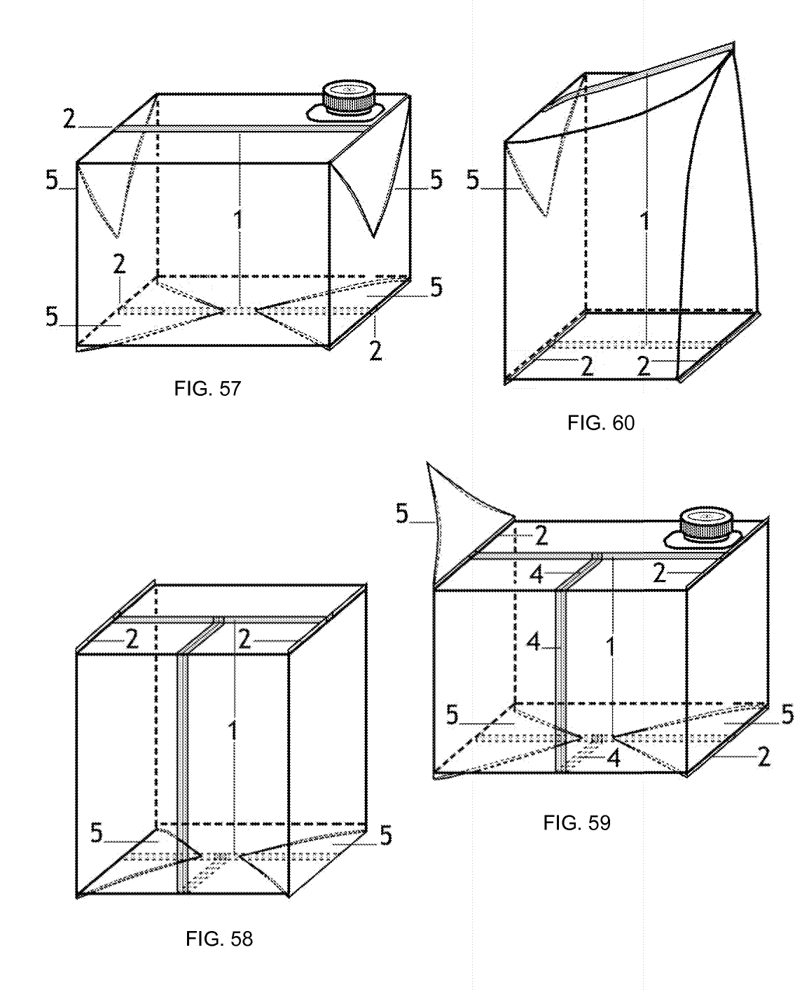

FIG. 8: show a detailed view of the lifting of the machine of the model [c] from FIG. 7, but in this case the two impact clamps have been triggered (6) both the upper as the lower one, which the initial container has been inflated with, this way acquiring the shape of a cubic figure but with the four flaps still without sealing nor cutting (sectioning).

FIG. 9: show a detailed view of the lifting of the machine of the model [c] en where, also, a trap door (10) has been added to support and to level the wanted height (in regards to the holding clamps (3)) the initial container. This has sweeping bristles incorporated (14) which guarantee that the already cubic container does not remain deposited above the clamps (6, 8) and, also on top of this trap door (10) transversely from side to side, a blocking fence (12) which will help the initial container that has introduced by the lateral and above the trap door, to stand exactly on the place where it will meet or slightly hit with this blocking fence (12), since that the set of three clamps from the top does not count with cylinders to move with therefore allowing free space on top of the holding clamp/clip.

In this case the impact bodies have been triggered (6), which the initial container has inflated with, acquiring this way the cubic figure but with the four flaps still not being sealed or cut.

FIG. 10: it shows the same detailed view of the lifting of the machine of the model [c] of the FIGS. 7 and 8 with impact clamps (6) with a rectangular prism shape. Also, a trap door (10) and two fixative bars (11) have been added, which will delimit the exact place in the initial container will be deposited in. The two sets of triple clamps (6, 8) are joined on the same frame that will be triggered by the same cylinder, this way allowing enough space for the initial container to be deposited without difficulty between the fixative bars (11) and above the trap door (10). Also, the sealing and cutting clamps (8) are adhered to the impact clamp (6) by means of pneumatic or electrical mini cylinders which are precisely fixed to two of the lateral faces (front and rear) of the impact clamp (6). The trap door (10) can be opened to different directions. Two vertical supports have also been added to the sides, therefore it is possible to support the infrared or optic sensor (1) on it and also the fixing bars that (11) and, also, will be used for supporting the trap door (10) and the holding clamps (3).

FIG. 11: it shows a detailed view of the lifting of the machine of the [c] model, which only carries, in the bottom part, an impact clamp (6) and two sealing clamps (8) and sealing and cutting clamps (8), in which all the clamps (6, 8) cannot move upstream nor downstream.

The only impact clamp (6) has a cylinder shape and is immobile (6) (since it cannot move), it is also anchored/fixed to the two columns (to the left and to the right) and which, in this case, these two supports (to the left and to the right) form a figure of a cross in V (looking downwards).

Each one of the sealing clamps (8) or sealing and cutting clamps (8), is anchored or fixed to the columns to the left and to the right that support the whole of the machine.

The machine counts with a guiding clamp (13) which is fixed to the tapped of a spin cylinder (16), for moving the container already transformed on 3D to the exterior (conveyor belt, vessel, etc.), but provided that the holding clamp (3)—which is fixed to the linear cylinder (9) in vertical position—is lift upwards impelled by this linear cylinder (9).

FIG. 12: it shows a detailed view of the lifting of the machine of the [c] model, which carries two sets of triple clamps with the shape of a rectangular prism, where the set of clamps (6, 8) from the top is attached to a spin cylinder/motor for dump truck (16), and the set of clamps (6, 8) of the bottom part is static anchored to the columns and being the impact clamp (6) of a cylindrical shape (more appropriate for initial container of big sizes such as the half litter or a litter). At the same time each one of these sets is fixed to the tappet of a spin cylinder/engine.

Also, an air trigger (15) has been added to them, this way to eject or to throw to the outside or to a conveyor belt (which will slide exactly below), to the container already transformed on 3D.

FIG. 13: it shows a detailed view of the lifting of the machine of the [c] model, which counts with two triple sets:

on the bottom part, a triple set in which the impact clamp has the shape of a cylinder and is immobile (6) (by not being able to move), this is also anchored/fixed to the two columns (to the left and to the right) and which, in this case, these two supports (to the left and to the right) form a figure of a cross in V (looking downwards).

Each one of the sealing and cutting clamps (8), is anchored or fixed to the columns to the left and to the right that support the whole of the machine.

on the top part, a triple set in which the impact clamp has the shape of a cylinder and is mobile (6) since it is not able to move, because this triple set is fixed/anchored to a platform (18) which slides on the highest part, by means of a cylinder (pneumatic or electric) in vertical that propels this triple set, which crosses the platform (18) anchoring to this with screws (adjustable) to the middle line and central spot of this platform (each clamp (6, 8) can go separately, independently anchored to the platform). These two linear transfer units with platform only are used to enable or to leave free space exactly on top of the holding clamp (3), so this way the initial container can be deposited or placed between these holding clamps or at the starting point.

Also, the holding clamp (3) is fixed to the linear transfer unit (17), in order to be able to conduct or transfer, with a movement from left to right of these, with the objective of moving the container already transformed on 3D to a conveyor belt that has been opportunely installed exactly below, and which when these holding clamps (3) open, the container already transformed on 3D will fall exactly above the conveyor belt.

FIG. 14: It shows a machine of the [e] model, in which there is a triple or quadruple set of clamps (6, 8) on the top part and, on the bottom part, there is another triple or quadruple set of clamps (6, 8): in which both align themselves vertically and being a separation between them which at least has to be higher than the length of the initial container, so this way the initial container to be transformed on 3D may be able to go through or be introduced between the set of triple or quadruple clamps. The impact clamp(s) (6) of each triple or quadruple set of clamps (6, 8) are fixed to the tappet of a spin cylinder (16), and the sealing and cutting clamps (8) of each triple or quadruple set of clamps (6, 8) are fixed to their corresponding impact clamps (6). From here, the initial container will join or hit—whether falling to the emptiness or whether being dragged by a mechanical arm or robot arm—over the top part of the impact clamps (6) to create two flaps. After this the sealing and cutting clamps (8) will seal these two flaps but without cutting them, so the container is held by both clamps (6, 8). In the same way, the container will rotate 180° downwards due to that the impact clamp (6) of the top part is fixed to the tappet of a spin cylinder (16). Once the container is hanging (trapped by the clamps (6, 8)) downwards and is positioned between the two impact clamps (6) of the two sets of clamps (6, 8), this will be impelled downwards by means of the impact clamp (6) (due to that the spin cylinder (16) that impels this impact clamp (6), at the same time, is fixed to a linear cylinder (9) placed in vertical position) so being able to do that the lateral side in horizontal of the bottom part of the container embed-hits in/with/against the impact clamps (6) of the triple or quadruple set of clamps (6, 8) which are located at the bottom, therefore creating or originating the other two flaps of the container. After this, the sealing and cutting clamps (8) of the set of clamps (6, 8) of the bottom part will be triggered so therefore sealing one or the two flaps of the bottom part of the container. Instantly, and at the same time or simultaneously, the flaps from the top part of the container which are trapped-grabbed by the clamps (6, 8) of the triple or quadruple set of the top part will be cut, this way and once the sealing and cutting clamps (8) of the set of clamps (6, 8) from the top part are triggered, opening themselves or going back to the starting point; the impact clamp (6) and the two sealing and cutting clamps (8) from the bottom part (which are trapping-holding the two flaps of the part from below of the container) will be rotated downwards 180 degrees (since also the spin cylinder (16) which impels this impact clamp (6) at the same time is fixed to a linear cylinder (9) placed in vertical position), so this way the initial container already transformed to the shape of a geometric figure that we wanted, is hanging and almost touching the surface from the top of a conveyor belt which occasionally is located and slides exactly underneath. Finally, immediately after, one or two flaps which are trapped-grabbed will be cut, for the container to finally fall standing and in vertical over the conveyor belt located underneath.

FIG. 15: it shows a detailed view of the lifting of the machine of the [c] model, to which a trap door (10) and some sweeping bristles have been added (14), and also counts with two sets of triple clamps, in which the set of clamps (6, 8) from the top, goes attached to the tappet of a spin cylinder/engine for dump truck (16) this way enabling space for the initial container to be able to be entered between the holding clamps/clip or to the start or beginning point. The sensor (1) detects the initial container when being entered between the holding clamps (3), this way giving the order to start the transformation of the initial container into a shape of tridimensional geometric body.

FIG. 16: it shows a detailed view of the lifting of the machine of the [c] model, in which there is only a triple set of clamps (6, 8), where the impact body (6) has a cylindrical shape and, also, these are attached to the same tappet of a linear cylinder (6) with which being able to move upwards and downwards, make the container to get free from the action area of the holding clamps (3). Also, the cylinder of this linear tappet is fixed to the tappet of a spin cylinder/engine (16) this way being able to move a quarter (or more) of a spin upwards and downward, so this way the container already transformed on 3D is deposited smoothly over/on a conveyor belt or vessel.

FIG. 17: it shows the detailed view of the lifting of a machine of the [c], model that carries two sets of triple clamps with the shape of a rectangular prism, set to the tappet of a spin cylinder/engine (16), in which the cylinder (16) from the top releases or enables space for the initial container to be able to be entered into the machine or between the holding clamps (3) and, the cylinder (16) from the bottom, when spinning downwards, enables to be deposited smoothly to the container already transformed into a tridimensional geometric body over/on a conveyor belt or vessel.

FIG. 18: it shows the detailed view of the lifting of the same machine than FIG. 11, but which in this case has been added a unit of linear transfer (17), with which it will conduct or transfer with a movement from left to right to the holding clamps/clip (3), with the only objective—once being already transformed the initial container into a container with the shape of a cubic figure—of moving this new container, this way this is not exactly above the clamps (6, 8) when the holding clamps/clips (3) open; this way, this new cubic container will be deposited or will be pushed to fall downwards or to a conveyor belt that will be opportunely installed exactly underneath.

FIG. 19: the same container than the one on FIG. 30, but in this case the initial container from which we start for being transformed, has a higher and less wider shape or a shape more rectangular than square, this way the container already transformed with the shape of the hull of a ship turned upside down, is more stretched upwards or more than the double of height than the length of the width of the face that acts as a base of the lowest part of the container already transformed.

FIG. 20: the same container than the one on FIG. 40, but in this case the initial container from which we start for being transformed has a higher and less wider shape or a shape more rectangular than square, this way the container already transformed with the shape of a Jar with a dosing neck, is longer upwards or the double or more than the double of height. Also, in this case, both lateral sides (where a flap has not been created, sealed and cut) parallel to the face that acts as a base, have not originated and sealed or sealed and cut with a set of twin and parallel pinching clamps, an edge welding line (3).

FIG. 21: container transformed into the shape of a tridimensional geometric body with the shape of a rectangular prism. The initial container from which it is started to be transformed, has a rectangular shape (of four sides in angles straight), since this has a rectangular shape, on the lower part as on the higher part of the initial container, a rectilinear has been sealed and cut in horizontal position, corresponding to the perimeter welding lines (1). Afterwards, to this initial container, four flaps or triangles (welding lines (2)) have been originated, sealed and cut; two of them as in the lateral side (or in the two of the faces of the container already transformer into a cube or on 3D) of the lowest part as on the highest part of this initial container. Also, in the two lateral sides (where a flap has not ben originated, cut and sealed) parallel to the face of the highest part, an edge welding line (3) has been originated and sealed with a set of two twin and parallel pinching clamps (19). Also, this container with the shape of a rectangular prism or also the initial container from which it is started for being transformed, carry or have a longitudinal welding line (4) on one of the lateral faces placed in vertical. In this case, the initial container from which it is started for later being transformed into the shape of a tridimensional geometric body, has not been fabricated with rectilinear welding lines (1) placed in vertical as for the left side as for the right side. On this rectangular prism container, in order to give an exit to the content (when it is more optimized is with solids as for example: dried fruits, potatos, snacks) packaged on its interior, a face from more to the top of this container will be lifted, grabbing and stretching this face or upper cover upwards, in such way that this cover will detach easily when separating or detaching from the perimeter welding lines (1) and of edge (3).

FIG. 22: Set of two multiform clamps of three rectilinear ones placed in different directions, which will seal and cut (sectioning) by the two faces of the initial container, this way creating multiple forms of irregular polyhedrons and, also, outstanding tips or dispenser necks on the container that will later be transformed into containers with the shape of volumetric tridimensional geometric bodies. This sectioned part, and once the initial container is transformed, when originating, sealing and cutting two flaps from the part or on the lateral perimeter side from lower, this initial container will be transformed into the shape of a tridimensional geometric body from FIG. 8.

FIG. 23a: Set of two multiform clamps of an only rectilinear place in diagonal, in which this is sealing and cutting by the two faces of the initial container, which has four sides and a squared shape. This sectioned part, once that in the lateral side that acts as a base of this container, two flaps (to the left and to the right) are originated, sealed or sealed and cut, this initial container will transform into the shape of a tridimensional geometric body from FIG. 28.

FIG. 23b: the set of two multiform clamps (parallel and twin of an only rectilinear placed in diagonal) and the initial squared container, corresponding to the set of clamps and to the initial container represented on FIG. 23a, in which it is being sealed and cutting by the two faces and in two of its lateral adjacent sides of this initial container.

FIG. 24: container transformed into the shape of a tridimensional geometric shape of irregular polyhedron, with a shape similar to a pot. The initial container from which it is started for being transformed, has an irregular shape (not of four sides with all its angles straight and, on this case, more to the width than to the height), since it has been sealed and cut with multiform clamps by its two faces and by the part from above it, as indicated with the welding lines (5), in the lowest part of the initial container, it has been sealed and cut a rectilinear place in horizontal position corresponding to the welding line (1). Afterwards it has been originated, sealed and cut to it, two flaps or triangles (welding lines (2)) on the lateral side that acts as a base, for which this initial container has been transformed into an irregular polyhedric container of geometric body on 3D with a shape similar to a pot. On this case, the initial container from which it is started for later being transformed in the shape of a tridimensional geometric body, has not been fabricated (although it can also carry them) not even with longitudinal welding lines (4) and neither with rectilinear welding lines (1) placed in vertical as on the left side as for the right side.

FIG. 25a: container transformed into the shape of a tridimensional geometric body of irregular polyhedron, with a shape similar to the body of a Bison/Cow. the initial container from which it is started to be transformed, has an irregular shape (not of four sides with all its angles straight, and, on this case, more to the width than to the height), since it has been sealed and cut with multiform clamps by its two faces and by the top part, as indicated with the welding lines (5); on the lowest part of the initial container, a rectilinear has been sealed and cut, placed in horizontal position corresponding to the perimeter welding line (1). Afterward, to this initial container it has been originated, sealed and cut, two flaps or triangles (welding lines (2)) on the lateral side that acts as a base, therefore this initial container has been transformed into an irregular polyhedric container of geometric body on 3D with a shape similar to a Bison or of a Cow. As another option, the number 1 (discarding number 5) of the lateral side of the highest part of the container indicated that since the beginning—before being transformed—this initial container had the shape of a square or of a rectangle, this way the sealing and cutting by the two faces corresponding to the welding line (5) in vertical on the right side of the container has been carried out later with multiform clamps, once the container has already been transformed into the shape of a tridimensional geometrical body. In this case, the initial container from which it is started for later being transformed into the shape of a tridimensional geometrical body has not been manufactured (although it can also carry them) neither with longitudinal welding lines (4) nor with rectilinear welding lines (1) placed in vertical both on the left side and the right side.

FIG. 25b: the same container from FIG. 25a, but in this case one more sealing and cutting has been carried out with multiform clamps, as can be seen on the welding line (5) in diagonal which is watching downwards, on the left side and higher on this irregular polyhedric container. This welding line (5) can be carried out at the same time of the manufacture of the initial container or otherwise also when the initial container has already been transformed into a tridimensional geometrical body.

FIG. 26: container transformed into the shape of a tridimensional geometric body or irregular polyhedron, with a shape similar to the one of a Dinosaur. The initial container from which it is started has an irregular shape (not of four sides with all its angles straight and, in this case, more to the width than to the height or more squared than rectangular), since this has been sealed and cut by both sides and by the top part with multiform clamps as shown on the welding lines (5), on the lowest part of the initial container a rectilinear has been sealed and cut, placed in a position which is horizontal corresponding to the perimeter welding line (1). Subsequently, two flaps or triangle (welding lines (2)) have been originated, sealed and cut on the lateral side that acts as a base (or the lowest part), for which this initial container has been transformed into an irregular polyhedric container of tridimensional geometric body with a shape similar to the one of a Dinosaur. As another option, the number 1 (discarding the other three number 5) of the lateral side of the highest part of the container indicates that from the beginning and prior to being transformed, the initial container had the shape of a square or of a rectangle, for which the sealing and cutting by the two faces corresponding to the welding lines (5) in diagonal (one on the left side and two on the right side) to the container have been done, subsequently, with multiform clamps, once the container had already been transformed into the shape of a tridimensional geometric body. In this case, the initial container from which it is started for being subsequently transformed into the shape of a tridimensional geometric body has not been manufactured (although it can also carry them) neither with longitudinal welding lines (4) nor with rectilinear welding lines (1) placed in vertical both on the left side as on the right side.

FIG. 27: container transformed into the shape of a tridimensional geometric body of irregular polyhedron, with a shape similar to the one of a Jar. The initial container from which it is started to be transformed has an irregular shape (no of four sides in a straight angle and, in this case, more to the width than height or more squared than rectangular), since a rectilinear in diagonal has been sealed and cut to it with a few degrees of slope (of 10 or 15) with a set of two multiform clamps; the two adjacent lateral sides from the top part (whether on the left side or on the right side), as indicated with the welding line (5); on the lowest part of the initial container, a rectilinear placed horizontally has been cut and sealed, corresponding to the perimeter welding line (1). Subsequently, three flaps or triangles (welding lines (2)) have been originated, sealed, cut to this initial container, two on the lateral side of the lowest part that acts as a base, and one (whether on the left side or on the right side) on the lateral side or on the highest part of this container (or of the initial container). As another option, it can also be sealed and cut once the container has been already transformed into the shape of a tridimensional geometric body with a set of two multiform clamps with the same shape, in order to make the same welding line (5) or rectilinear in diagonal of 10 or 15 degrees of slope, already explained previously. In this case, the initial container from which it is started for later being transformed into the shape of a tridimensional geometric body has not been manufactured (although it can carry them) neither with longitudinal welding lines (4) nor with rectilinear welding lines (1) located vertically both to the left side as to the right side.

FIG. 28: container transformed into the shape of a tridimensional geometric body of irregular polyhedron with a shape similar to the one of a House with a three-pitched roof. The initial container from which it is started to be transformed, has an irregular shape (not of four side with all its angles straight and, in this case, more to the width than to the height and more squared than rectangular), since two rectilinears in diagonal have been sealed and cut by its two faces and by the highest part with multiform clamps, as indicated with the welding lines (5); on the lowest part of the initial container, a rectilinear in horizontal has been sealed and cut, corresponding to the perimeter welding line (1). Subsequently, three flaps or triangles (welding lines (2)) have been originated, sealed and cut, two on the lateral side of the lowest part that acts as a base, and one whether on the left side or whether on the right side of the highest part of this container (or initial container). In this case, the initial container from which it is started for later being transformed into a shape of a tridimensional geometric body has not been manufactured (even though it can also carry them) neither with longitudinal welding lines (4) nor with rectilinear welding lines (1) placed vertically both on the left side as to the right side.

FIG. 29: container transformed into the shape of a tridimensional geometric body of irregular polyhedron with a shape similar to the one of a flying saucer. The initial container from which it is started to be transformed, has an irregular shape (not of four side with all its angles straight and, in this case, more to the width than to the height and more rectangular than squared), since two rectilinears in diagonal have been sealed and cut by its both faces and by the highest part with multiform clamps, as indicated with the welding lines (5); on the lowest part of the initial container, a rectilinear in horizontal has been sealed and cut, corresponding to the perimeter welding line (1). Subsequently, two flaps or triangles (welding lines (2)) have been originated, sealed and cut on the lateral side that acts as a base (or of the lowest part), for which this initial container has been transformed into an irregular polyhedric container of tridimensional geometric body with a shape similar to the one of a flying saucer. As another option, the number 1 (discarding the other two number 5) of the lateral side of the highest part of the container indicates that from the beginning and prior to being transformed, the initial container had the shape of a square or of a rectangle, for which the sealing and cutting by the two faces corresponding to the welding lines (5) in diagonal of the left side and of the right side of the container has been carried out later with multiform clamps, once the container had already been transformed on 3d. In this case, the initial container from which it is started for being subsequently transformed into the shape of a tridimensional geometric body has not been manufactured (although it can also carry them) neither with longitudinal welding lines (4) nor with rectilinear welding lines (1) placed in vertical both on the left side as on the right side.

FIG. 30: container transformed into the shape of a tridimensional geometric body of irregular polyhedron, with a shape similar to the one of a ship's Hull, but turned upside down. The initial container from which it is started to be transformed has an irregular shape (of four sides will all its angles straight and more to the width than to the height), since a rectilinear in horizontal, corresponding to the perimeter welding line (1) has been sealed and cut on it on both faces, both on the top part as on the low part. Subsequently, two flaps or triangles (welding lines (2)) have been originated, sealed and cut to this initial container on the lateral side that acts as a base (or of the lowest part), therefore this initial container has been transformed into an irregular polyhedric container of tridimensional geometric body with a shape similar to the one of the Hull of a ship, but turned upside down. In this case, the initial container from which it is started for being subsequently transformed into the shape of a tridimensional geometric body has not been manufactured (although it can also carry them) neither with longitudinal welding lines (4) nor with rectilinear welding lines (1) placed in vertical both on the left side as on the right side.

FIG. 31a: container transformed into the shape of a tridimensional geometric body with the shape of a rectangular prism, higher than wide. The initial container from which it is started to be transformed has a regular shape (of four sides in straight angle), since this does not have a rectangular shape on the lower part and on the highest part of the initial container, a rectilinear has been sealed and cut horizontally, corresponding to the perimeter welding line (1). Subsequently, four flaps or triangles (welding lines (2)) have been originated, sealed and cut to this initial container, two of these on the lateral side (or on the two faces of the container already transformed into a rectangular prism or on 3D) both on the lowest part as on the highest part. In this case, the initial container from which it is started for being subsequently transformed into the shape of a tridimensional geometric body has not been manufactured (although it can also carry them) with longitudinal welding lines (4) on the front face and/or on the back face, nor with rectilinear welding lines (1) placed in vertical both on the lateral side of the left and/or the right side of the initial container. A cap or a straw can be attached to this parallelepiped container, provided that a hole has been previously done on the top face, from where it is possible to introduce a straw or from where the contents packaged on the inside can come out, for example a beverage.

FIG. 31b: container transformed into the shape of a tridimensional geometric body of irregular polyhedron, with a shape similar to the one of a Jar. The initial container from which it is started to be transformed has an irregular rectangular shape (no of four sides in a straight angle) (the two lateral sides of the sides have three times higher length than the lateral sides from the top and the bottom) since a rectilinear has already been sealed and cut diagonally to it with a few degrees of slope (of 10 or 15) with a set of two multiform clamps, both lateral adjacent sides of the highest part (whether of the left side as of the right side) as indicated with the welding line (5); on the lowest part of the initial container, a rectilinear placed in horizontal position has been sealed and cut, corresponding to a perimeter welding line (1). Subsequently, three flaps or triangles (welding lines (2)) have been originated, sealed and cut to this initial container: two on the right side of the lowest part that acts as a base, and one (whether on the left side as on the right side) on the lateral side or on the highest past of this container (or of the initial container). As another option, it can be also sealed and cut once the container has been already transformed into the shape of a tridimensional geometric body, with a set of multiform clamps with the same form, this way to make the same welding line (5) or rectilinear in diagonal of about 10 or 15 degrees of slope, already previously mentioned. In this case, the initial container from which it is started for later being transformed into the shape of a geometric tridimensional body, has not been produced (although it can also carry them) neither with longitudinal welding lines (4) nor with rectilinear welding lines (1) places vertically both on the left side as on the right side.

FIG. 32: container transformed into the shape of a tridimensional geometric body of irregular polyhedron, with a shape similar to the one of a magic Lamp. The initial container from which it is started to be transformed has a regular shape (of four sides in straight angle and, in this case, more to the width than to the height), since this has a square or rectangular shape both on the lowest part as on the highest part of the initial container, a rectilinear, placed in horizontal position, corresponding to the perimeter welding lines (1), has been sealed and cut. Subsequently, three flaps or triangles (welding lines (2)) have been originated, sealed and cut to this initial container, two on the lateral side of the lowest part that acts as a base, and one (whether on the left side as on the right side) on the lateral side or on the highest part of this container (or initial container). In this case, the initial container from which it is started for later being transformed into the shape of a geometric tridimensional body, has not been produced (although it can also carry them) neither with longitudinal welding lines (4) nor with rectilinear welding lines (1) places vertically both on the left side as on the right side.

FIG. 33: container transformed into the shape of a tridimensional geometric body of irregular polyhedron, with a shape of a Cube. The initial container from which it is started to be transformed has a regular shape (of four sides in straight angle), since it has a squared shape on the lowest part as on the highest part of the initial container, a rectilinear, placed in horizontal position, corresponding to the perimeter welding lines (1), has been sealed and cut. Subsequently, four flaps or triangles (welding lines (2)) have been originated, sealed and cut to this initial container, two of them on the lateral side (or in two of the faces of the container already transformed into a cube or on 3D) of the lowest part as on the highest part of this initial container. In this case, the initial container from which it is started for later being transformed into the shape of a geometric tridimensional body, has not been produced (although it can also carry them) neither with longitudinal welding lines (4) nor with rectilinear welding lines (1) places vertically both on the left side as on the right side of the initial container.

FIG. 34: Set of two twin ejector clamps (20) which align and that can be triggered by means of a linear clamp (9) or by spin (16) or of double tappet and double effect. On the drawing it can be seen how, before the two sealing and cutting clamps which are located exactly above the two ejector clamps, the two ejector clamps (20) have been already triggered and have started to smash the two faces of the initial container, which is located exactly in the middle and between this ejector clamps (20).

FIG. 35: an immobile impact clamp and two sealing clamps (8) or sealing and cutting clamps (8) which align themselves located to the left and to the right respectively of the impact clamp which in this case is immobile. The two sealing or sealing and cutting clamps (8) can be triggered by means of a linear clamp (9) or of spin (16) or of double tappet and double effect. In the drawing it can be seen how before the triggering of the two sealing (8) or sealing and cutting clamps (8) which will seal or seal and cut the two flaps or triangles originated, there is exactly above the impact clamp and placed vertically, an initial container, whose lateral side of the lowest part is attached between the immobile impact clamp, having originated this way two flaps or triangles on each side (to the left and to the right) of the immobile impact clamp. This initial container could have placed exactly above or on the impact clamp, on the following ways:

By falling directly and to the emptiness from a conveyor belt or also from a vertical filling machine which fabricates initial containers of at least two faces, which a strategically exactly located above.

Directed by the claw of the arm of a robot, which has previously picked up and/or

Blocked this initial contained by the top area or part, therefore directing this against or above of the impact clamp (6).

FIG. 36: a flexible initial container (of tube) of two faces, which has been manufactured by a machine of vertical filling of liquids or solids, available on the market nowadays. This initial container is of two seals: two perimeter welding lines (1) above and below. Also, on its interior, fluid [(liquid or/and pasty) or/and (air or/and gas)] has been packaged with solids or without them.

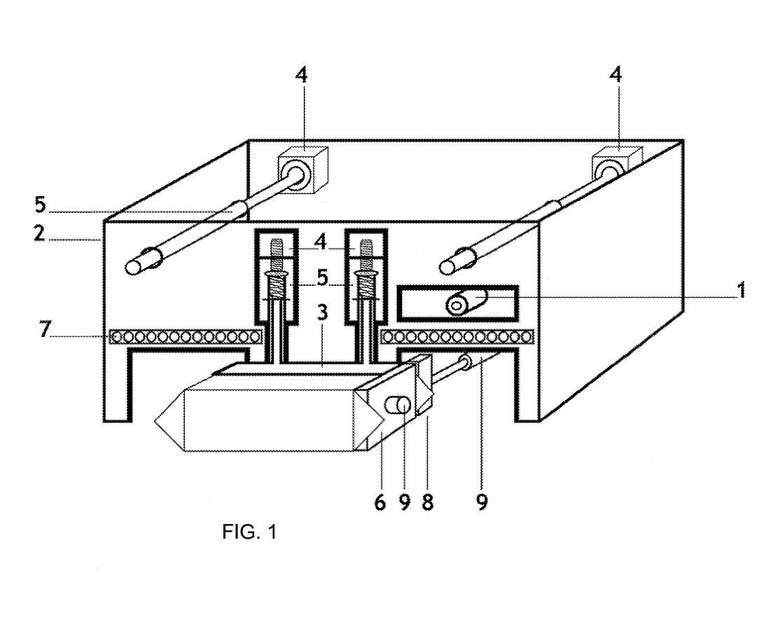

FIG. 37: it shows an overlook of the lifting of a container with six faces, being in this case of plastic only. In this case, it has the following welding lines: two perimeter or central welding lines (1) on the highest and lowest face which belong to the perimeter welding lines (1) of the initial container of two faces from FIG. 1 and, it also has or carries the four perpendicular welding lines (2) which belong to the sealing and cutting of the four flaps or triangles which have been previously originated on the initial container from FIG. 1, by been transformed into this shape of container of rectangular prism by any of the transforming machines on 3D of the invention. On the top face, it has a cap adhered or attached (by means of a material such as contact glue) in order to serve the content of the interior.

FIG. 38: it shows the same overlook of a rectangular prismatic container as on the previous figure, but in this case it has a shape more to the height than to the width.

FIG. 39: it shows a view of the lifting of a flexible, sealed and totally cubic container. Also, it has a small size since it will act as an ice cube by being a plastic container which has water on its interior. It is worth remarking, also, that this container has been produced intentionally with the welding lines (or flap-burr) of smaller size, both the ones of the sealing and cutting (2) of the four flaps, as the ones of two perimeter or central welding lines (1). On the top face, it has no cap attached, since the water inside the container will not be dosed nor served.

FIG. 40: container transformer into the shape of a tridimensional geometric body of irregular polyhedron, with a shape similar to the one of a magic lamp. The initial container from which it is started to be transformed, as a regular shape (of four sides on straight angles and, in this case, more to the width), since it has a rectangular shape, in which the length of the width of the face that acts as a base is equal or even less than the length of the height of the container. On the lowest part and the highest part of the initial container, a rectilinear has been sealed and cut in horizontal position, corresponding to the perimeter welding line (1). Subsequently, three flaps or triangles (perpendicular welding lines (2)) have been originated, sealed and cut to this initial container, two on the lateral side of the lowest part that acts as a base, and one on the perimeter lateral side or on the highest part (whether on the right side as on the left side) of this container or the initial container. Also, on both lateral sides or edges (where no flap has been originated, sealed and cut) parallel to the face that acts as a base, an edge welding line (3) has been originated and sealed with a set of two pinching clamps (19) twin and parallel for each edge. Also, in this case we have not attached or added any type of cap, therefore it will open by tearing due to that a fissure has been made, in part of the burr of the highest part of the tip or vortex of the container. Also, in this case, the initial container from which it is started and which will be later transformed in the shape of a geometric body on 3D has not been produced (although they can also carry them) nor with longitudinal welding lines (4) nor with perimeter welding lines (1) placed vertically both on the left side as on the right side.

FIG. 41: it shows a view of the lifting of a cubic container of six faces, flexible and sealed with the shape of a rectangular prism (more to the height than to the width). In this case, it has the following welding lines:

two perimeter or central welding lines (1) on the highest and lowest face that belong to the perimeter welding lines (1) of the initial container of two faces from FIG. 1.

four lines of perpendicular welding (2) belonging to the sealing and cutting of the four flaps or triangles that have be previously originated on the initial container from FIG. 1 by being this one transformer into this form of container of rectangular prism by any of the transforming Machines of the invention.

four lines of edge welding (3): on the four lateral sides or edges in vertical of this container already transformed into the shape of a rectangular prism.

On the other hand, it carries no cap at all, and it does have a hole for a straw.

FIG. 42: it shows a view of the lifting of a container with the shape of a rectangular prism (more to the height than to the width) of six faces, flexible, sealed and of a similar size or equivalent to the one from a one litter container of the tetrabrik® type. It has the following welding lines:

two perimeter welding lines (1) to the longitudinal half of the highest and lowest face of this container already transformed into the shape of a rectangular prism. All these welding lines (1) are already present or belong to the perimeter welding lines (1) of the initial container of two faces from FIG. 1.

four perpendicular welding lines (2) belonging to the sealing and cutting of the four flaps or triangles that have been originated, previously, on the initial container from FIG. 1, by this being transformed into this type of container of rectangular prism shape by any of the transformer machines on 3D of the inventions.

four edge welding lines (4) in horizontal (two on the highest face and another two on the lowest face) located on the lateral sides (or edges) both on the highest face as on the lowest one, where the flaps have not been originated, sealed and cut.

four edge welding lines (3): on the four lateral sides or edges in vertical of this container already transformed into the shape of a rectangular prism.

On the top face, it has a cap adhered or attached (by means of a mode such as the contact glue) in order to dose the content of its interior.

There edge welding lines (3) in which the burr, flap or clipped folding can be appreciated, have been produced by means of game of two pinching clamps (19), even though they can also be done directly by means of vertical filling machines that manufacture the initial containers. Also, this edge welding lines (3) will give or provide a higher rigidity and stability to the container already transformer on 3D. It has also a cap adhered on the highest part.

FIG. 43: a flexible initial container of two faces, which has been manufactured by a vertical filling machines of liquids or solids, available on the market nowadays. The initial container is of 3 seals: two perimeter welding lines (1) up and down and a longitudinal welding line (4). Also, on its interior, fluid [(liquid or/and pasty) or/and (air or/and gas)] has been packaged with solids or without them.

FIG. 44: it shows the same overall overview of the same type of cubic container than on FIG. 37, but in this case it has one more welding line: the longitudinal welding line (4) in vertical and on the center of the face.

FIG. 45: it shows the same general overview than on FIG. 38, but in this case it has one more welding line: the longitudinal welding line (4) in vertical, located on the center of the front face or on the face on the back of the container already transformed.

FIG. 46: it shows the same general overview of the same type of container than FIG. 39, but in this case it is about a cubic container which has one more welding or sealing line, in which it is a longitudinal welding line (4) in vertical, located close to the center of the front face or on the face on the back of the container already transformed.

FIG. 47: it shows a view of the lifting of a flexible, sealed and totally cubic container, which in this case has the following welding lines:

four perpendicular welding lines (2) when two flaps or triangles are originated, sealed and cut, both on the highest face as on the lowest one of the container already transformed on 3D.

a longitudinal welding line (4) in vertical, located on the half of the front face or the face in the back of this container already transformed on 3D

four edge welding lines (4) in horizontal (two on the highest face and another two on the lowest face), located on the lateral sides (or edges) both on the highest face as on the lowest face, where four flaps have not been originated, sealed and cut. Also, it carries a cap (stopper) to serve the content of the interior.

FIG. 48: it shows the same general overview than on FIG. 42, but in this case it has been added one more welding line, being this a longitudinal welding line (4) in vertical, located on the center of the front face or on the face on the back of the container already transformed on 3D. Also, it does not carry any type of cap attached or adhered.

FIG. 49: it shows the same general overview of the same type of container with the shape of a rectangular prism as the one on FIG. 41, but in this case one more welding line has been added, in which this a longitudinal welding line (4) in vertical, located on the center of the front face or on the face on the back of the container already transformed on 3D. Also, it carries a cap-stopper adhered or attached to the top face of this container, this way to serve the content of the interior.

FIG. 50: a flexible initial container of two faces, which has been manufactured by a vertical filling machine of liquids or solids, available in the market nowadays. This initial container is of four seals: four perimeter welding lines (1): in horizontal up and down, and one in vertical in the lateral side of the left and of right. Also, in its interior it contains fluid or has fluid packaged [(liquid or/and pasty) or/and (air or/and gas)] with at least one solid or solids or without them.

FIG. 51: it shows a general overview of the lifting of a container with six faces which has more of the shape of a cube than of a rectangular prism. This container, in this case, is produced with only plastic materials, and has the following welding lines:

four perimeter welding lines (1) to the longitudinal half of the highest face and of the lowest face and, also, to the longitudinal face of the face in vertical both on the right side as on the left side. All the welding lines (1) are already present or belong to the perimeter welding lines (1) of the initial container of two faces from FIG. 50.

four perpendicular welding lines (2) which belong to the sealing and cutting of the four flaps or triangles which have been previously originated on the initial container from FIG. 50, by been this transformed into the shape of a rectangular prism container by any of the transforming machines on 3D of the invention. On the top face, it carries a cap adhered or attached (by means of a mode such as the contact glue) this way to serve the content of the interior.

FIG. 52: it shows a view of the lifting of a flexible, sealed and totally cubic container. Also, it has a small size, since it will be used as an ice cube by being a plastic container which contains water on its interior. It shall also be noted that this container has been also manufactured with the welding lines (or flap-burr) of smaller size, both for the sealing and cutting (2) of the four flaps as for the four central and perimeter welding lines (1). On the face from the top, it doesn't carry a cap or stopper adhered, since the water in the interior of the container is not going to be dispensed or served.

FIG. 53: it shows an extended detailed view of the lifting of a set of two pinching clamps which will seal and cut one of the edges in vertical of a cubic container. In the middle of these clamps the burr or folding can be appreciated, originated by the action of the pinching clamps (19), which, according to the situation, are meant for the sealing to for the sealing and cutting of this edge.

FIG. 54: it shows a general view of the lifting of the cubic container from FIG. 53, in which two pinching clamps (19) have trapped, smashed or pinched one of the vertical edges of the cubic container.

FIG. 55: Part of the plastic material used to package or, otherwise, two containers manufactured by a vertical or horizontal filling machine, which is the factory of the containers of at least two faces. Two containers with two faces can be seen on it, these have been manufactured with a set of two multiform clamps (twin and parallel) with the shape of a rectilinear place in diagonal position and, also, combining and alternating cyclically one after the other, by a set of two clamps (twin and parallel) with a rectilinear shape located in horizontal position. Therefore, one is the initial container “ON” and the other in the initial container “OFF”, in which on this case in particular, both containers have the same shape by one is placed backwards in regards to the other. The container from above have not been sealed and cut yet by the set of two rectilinear clamps (twin and parallel) placed in horizontal position.

FIG. 56: container transformed into the shape of a tridimensional geometric shape of irregular polyhedron, with a shape similar to the one of a Sail from a boat. The initial container from which it is started for later being transformed, has an irregular shape (not of four sides in straight angles and, in this case, more to the height than to the width or more rectangular than squared), since this a rectilinear in diagonal of around 45 to 60 degrees of slope has been sealed and cut with a set of two multiform clamps: two on the lateral adjoining sides from the top part (whether on the left side as on the right side), as indicated with the welding line (5). On the lowest part of the initial container, a rectilinear placed in horizontal position has been sealed and cut, corresponding to the perimeter welding line (1). Subsequently, on this initial container, two flaps or triangles (welding lines (2)) have been originated, sealed and cut on the lateral side that acts as a base (or of the lowest part), therefore this initial container has been transformed into a irregular polyhedron with the shape of a tridimensional geometric body with a shape similar to the one of the Sail of a boat. In this case, the initial container from which it is started to later being transformed into the shape of a tridimensional geometric body has not been manufactured (although it can carry them) neither with longitudinal welding lines (4), nor with rectilinear welding lines (1) placed vertically both on the left side as on the right side.

FIGS. 57-60: These illustrate a diversity of examples in which it can be appreciated different configuration that the finished containers may adopt, particularly the sealing lines made above the flaps or above the external surface of the initial container during the transformation procedure. This way, for example, one of the faces from the finished container mat contain two flaps: one or two are sealed and cut, and in the other hand the other face from the front, which also contains two flaps, one or two (sealed or without being sealed by the intersection between the container and the flap) are adhered with contact glue to the rest/body of the container of cubic shape or totally volumetric (regular hexahedron, rectangular prism, irregular polyhedron . . . ). Also, a container may be modified keeping the same characteristics and several shapes by being able of leaving in the manufacture processes by means of the transforming machines, one or more flaps or triangles that are originated, without sealing or cutting, this way for them to be used an outstanding tips as a way of dispenser. Therefore, they can carry or have at least one, two or three welding lines of the type (2) corresponding to two or three flaps or triangles.

In the other hand, the flap can also be left sealed, but leaving this sealed without being adhered or attached to the rest/body of the transformed container.

### PREFERENTIAL FULFILLMENT OF THE INVENTION

Next, a description of the preferential fulfillments of the invention is presented, complementing the information provided in the figures previously described.

According to a first object of the invention, a procedure for transforming an initial flexible container into a final flexible container is presented. The initial container may be both open as closed, it presents at least two faces and it has an external surface and an external perimeter contour, defined by at least a lateral perimeter side, which is partially filled or in its totality by at least one sealed or folded closing. Also, the containers possess a content which is partially or totally fluid, being able to contain [(liquid or/and pasty) or/and (air or/and gas)] and optionally at least one solid or solids, powdered, granulates.

The procedure of the invention comprehends a first stage that tries to push, by using at least one impact body (6), rigid or semi rigid, into one, two or more lateral directions of the external perimeter contour, through hitting or one or more impact bodies (6) hitting themselves against/between/with/in against/with/in the intermediate zone, partial zone, end zone or full zone, of one, two or more of the lateral perimeter sides/borders of the initial container, or vice versa (the lateral perimeter side against/in the clamp/impact body (6)); in such way that part of the fluid is transferred into the contour of the container, increasing the pressure in the interior of the container, as well as producing a local swelling effect, defining at least one flap, or a body of triangular configuration, supplied of faces and external perimeter contour, where simultaneously, on the area of the container which impacts the impact body (6) with, a support face or an area limited by a contour of support, or an additional surface on the external perimeter contour is generated, which allow to keep the container standing steadily, and also the geometric tridimensional configuration of the container is modified.

Flaps can also be originated one by one, two by two, three by three, four by four or more by more, at the same time, without that altering the final outcome of the container transformed on 3D which is what was wanted to be obtained.

Subsequently, a second staged is produced, which refers to keeping the same configuration obtained on the first stage.

Two alternatives are proposed to carry out the second stage:

A first alternative proposed to seal one or more of the faces and/or in part of the external perimeter contour, of a least part of at least one flap or of a body of triangular configuration, defined in the previous stage, using sealing clamps (8) or rigid or semi rigid sealing bodies, which have at least on type of heat source, in order to permanently keep the support face or the area limited by a contour of support, or the additional surface generated in the external perimeter contour.

It is also possible, after carrying out a sealing first, to proceed to cut the flap or body of triangular shape leaving the millimeters wanted of burr and/or welding.

It is also possible to, after carrying out a sealing first, to proceed to the folding and to the attaching and adhesion of the flap or figure of triangular shape to the rest/body of the container.

A second alternative refers to carry out a folding of the flap, or the body of triangular configuration to the rest of the container, and then to adhere such flap or such body of triangular configuration to the rest of the container by using an adhesion method, as for example contact glue or hot air.

On any of the cases, the sealing of the flap or flaps is carried out preferentially in an area of intersection of each flap with the rest of the container. In function of the circumstances, the flaps may be cut leaving burrs of more or less thickness, or substantially null.

On any of the cases exposed, the first stage of pushing may be carried out directing the initial container into the body of impact (6), whether it is manually or by using any other automated solution, as a robot supplied with claws to grab the container.

In the other hand, as shown on the figures, in order to facilitate the transformation of the containers of at least two faces into containers on 3D, specially in vertical machines, there is the possibility of incorporating an additional step of catching and/or put pressure inwards or outwards of the container in order to put pressure on the fluid packaged in the interior of the container to the ends of the contour of the container, by means of one or more holding clamps (3) or one or more sets of two or more holding clamps (3), preferable in an area non adjacent to the area or to the lateral perimeter sides in which the flaps or bodies of triangular configuration will be originated. The holding clamps (3), in turn, are configured to retract by means of a type of cushioning, when the bodies of impact (6) act, this way to allow that the container can swell or acquire the shape of a tridimensional body.

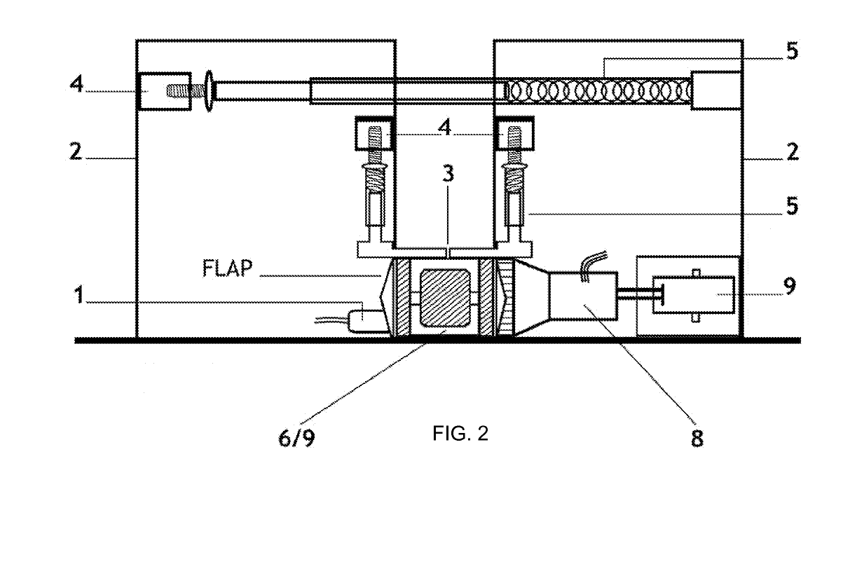

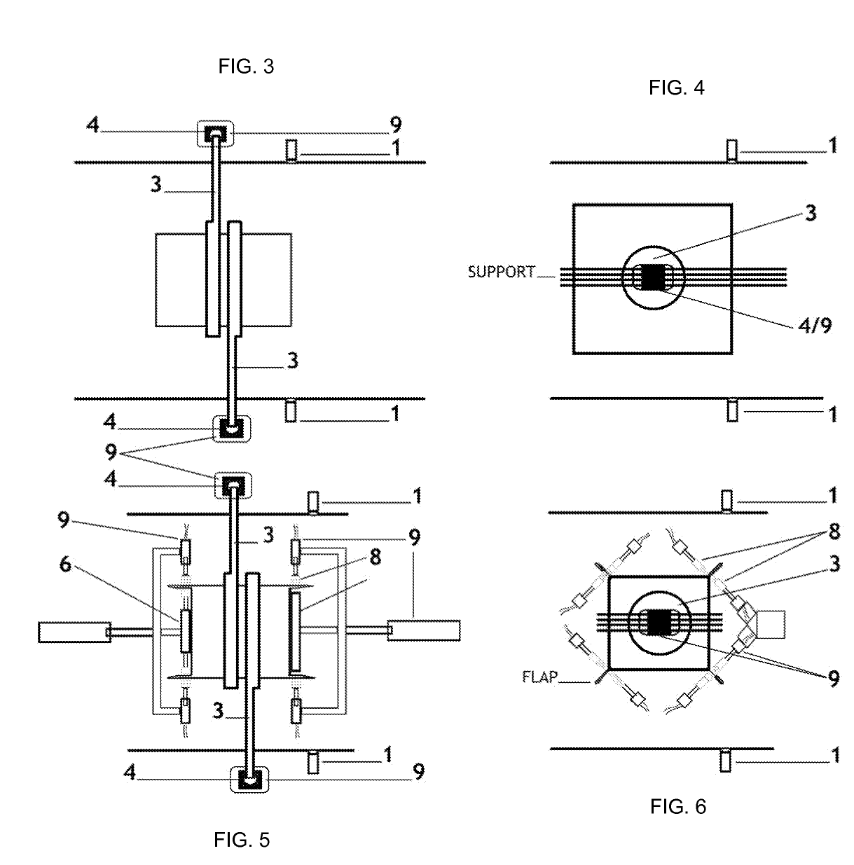

According to a preferential example, the pushing stage comprehends the generation of a hole, as well as to push and block in the totality of two or more of the lateral perimeter sides of the container by means of bodies of impact (6) and/or surfaces of impact and/or support that actuate in different directions in order to adapt the container to the hole. Particularly, as shown and explained on FIGS. 1 and 2, it can be counted with, for example of a plurality, pairs of impact bodies (6) which actuate over the contained in different directions (usually perpendicular) in such way that the surround the contained defining the hole mentioned. By pushing the container this way, the definition of the flaps is facilitated.

According to a preferential example, the pushing stage comprehends the use of a set of two clamps or two clamps (one impact clamp (6) and one sealing or sealing and cutting clamp (8)) which align themselves and are placed diagonally and to the sides (to the left and to the right) in regards to each vortex, corners or peak of the initial container of at least two faces. These two clamps (6, 8) are actuated or will be impelled forward by means of a linear cylinder (9) or of spin (16), this way to hit or bump against each one of them in/with/against one of the two adjacent sides of each vortex, corner or peak of the initial container, therefore originating a flap or body of triangular shape.

Following this, the sealing and sealing and cutting clamp (8) will seal or seal and cut the flap by the transversal line or of intersection (or approximate) between the flap and the body or the rest of the container.

Each flaps responds independently in relation to the others, in other words, the flaps can be originated, sealed and cup; one by one, two by two, three by three, four by four, or more by more.

This way, therefore, with this set of two clamps (6, 8) and depending on the part caught or pushed to the interior of the lateral sides adjacent to the vortexes or to the corners, an only flap or triangle of bigger or smaller size will appear or originate spontaneously at that moment (bigger the flap, bigger will be the volume transmitted to the rest or body of the container) outstanding to the exterior of the rest or the body of the container. The flaps or triangles are formed due to that one of the two lateral adjoining sides in which each vertex or corner is composed, folds to the inside or to the outside until making contact or to achieve to almost join or make contact with the other part of the other lateral side adjacent to this same vortex, corner or end. The flap or triangle, therefore, remains placed or is placed, outstanding to the exterior of the container, in position of perpendicularity or verticality (totally or almost totally) regarding to the lateral sides or faces of the container already transformed.

According to another aspect of the intervention, a perfection on the elaboration of tridimensional containers is described, for example of the Tetrapack type, SIG, ipi or similar, which is general are meant to contain liquids, such as juices, milt, etc. . . . and on the ones that some fluid with solids are also complementarily packaged or filled. Such containers are obtained and are simultaneously filled in vertical machines from sheets of film reels. The film of the reels may be previously marked (punched with holes/dents) with foldings in order to facilitate the configuration of the container. In general, first a container body is obtained from the winded film and then the outstanding flaps from the container body are configured. In the case of the film previously marked, the flaps are predefined by means of the referred folding marks. The invention proposes to treat such flaps the same way that the previously mentioned flaps are treated, in other words, once the flaps are configured by means of another procedures, proceed to seal such flaps or, alternatively, in a way analogue to the previously described, fold them and adhere them, or also seal them and then cut them.

In particular, the proposed procedure includes the following stages:

generate a container body from the film on the reel; and

configure flaps or bodies or triangular configurations standing out from the body of the container, with faces and of external perimeter contour; characterized by the following additional steps:

to seal, by one of more of the faces and/or in part of the external perimeter contour, of at least part or at least one flap or of a body of triangular configurations, defined on the previous stage, by using sealing clamps (8) or rigid or semi rigid sealing bodies that have at least on type of heat source in order to permanently keep the face of support or the zone limited by a contour of support, or the additional surface generated in the external perimeter contour;

And, optionally:

fold the flap, or the body of triangular configuration to the rest of the container, and

adhere such flap, or such body of triangular configuration to the rest of the container, by employing a means of adhesion, for example, contract glue or hot air.

Same way as for the procedures of transformation of containers previously described, this procedure can also include an additional step of totally or partially cutting at least one of the flaps or bodies of triangular configuration, sealed, employing at least one means of cutting or cutting element, for example a blade installed on the cutting clamp.

According to an additional aspect of the invention, several fulfillments of machines used to transform containers are continuously described with the help of the figures previously described.

According to a first fulfillment, a machine for transforming a flexible, open or closed container of at least two faces and with an external surface and of an external perimeter contour is presented, defined by at least a lateral perimeter side, which is partly or totally sealed by at least a sealed closing, where at least a part of the content of the containers comprehends some fluid, [(liquid or/and pasty) or/and (air or/and gas)] and optionally with at least one solid or solids/granulates/powders or without them,

where the machine is characterized because it includes:

cylinders or clamps which can be fixed and/or anchored by means of a type of transport as for example the one with one, two or more columns, one, two or more platforms (18), one, two or more units of linear transfer (17), to the tappet of a cylinder of one, two or more clamps:

one or more sensors (1) which will detect the initial container (or any other element, piece of action of the machine) once this has been introduced or deposited on any of the machines of the invention or between the holding clamps (3);

at least one impact clamp or body (6), rigid or semi rigid, mobile (actuated by means of a type of impelling as for example a linear cylinder (9) or spin cylinder (16) and/or at least one impact clamp or body (6) rigid or semi rigid, immobile, which when pushed in one, two or more lateral directions of the external perimeter contour, by means of the hitting or hitting one or more impact bodies (6) against/between/with/in the external perimeter contour of one, two or more lateral perimeter sides, or vice versa, at least one flap or triangular geometric body of one, two or more of the lateral perimeter sides or external perimeter contour of an initial container are originated;

one or more sealing clamps (8) or sealing and cutting clamps (8) (these are actuated by means of a type of impelling as for example a linear cylinder (9) or a spin cylinder (16)) which is used to seal or to seal and cut by one or more of the faces and/or in part of the external perimeter contour, of at least part of at least one flap or of a body of triangular configuration, defined on the previous stage, employing sealing clamps (8) or rigid or semi rigid sealing bodies, which have at least one type of heat source to permanently keep the face of support or the area marked by a contour of support, or the additional surface generated on the external perimeter contour.

According to a second fulfillment, a machine for transforming a flexible, open or closed container of at least two faces and with an external surface and of an external perimeter contour is presented, defined by at least a lateral perimeter side, which is partly or totally sealed by at least a sealed closing, where at least a part of the content of the container comprehends some fluid, [(liquid or/and pasty) or/and (air or/and gas)] and optionally solids, granulates, powders where the machine is characterized because it includes:

cylinders or clamps which can be fixed and/or anchored by means of a type of transport as for example the one with one, two or more columns, one, two or more platforms (18), one, two or more units of linear transfer (17), to the tappet of a cylinder of one, two or more clamps:

one or more sensors (1) which will detect the initial container (or any other element, piece of action of the machine) once this has been introduced or deposited on any of the machines of the invention or between the holding clamps (3);

one, two or more sets (triple and/or quadruple of clamps (6, 8)) and/or (one or two double sets) in which the impact clamp (6) of one, two or more of the double, triple or quadruple sets are mobile actuated by means of a type of impelling as for example a linear cylinder (9) or a spin cylinder (16)) and/or a clip cylinder/cylinder of double tappet and double linear or spin effect) and/or immobile; where the body or clamp of impact (6) of these sets of clamps (6, 8) originate, when pushing one, two or more lateral directions of the external perimeter contour, by means of the hitting or hitting between one or more impact bodies (6) against/between/with/in the external perimeter contour of one, two or more lateral perimeter sides, or vice versa, one, two or more flaps or triangular geometric bodies of one, two or more of the lateral perimeter sides or external perimeter contour of an initial container; and

in which the sealing clamp (8) or sealing and cutting clamp (8) seals or seals and cut by one or more of the faces and/or in part of the external perimeter contour, of at least part of at least one flap or of a body of triangular configuration, defined on the previous stage, by employing sealing clamps (8) or rigid or semi rigid bodies of sealing, which have at least one type of heat source, in order to permanently keep the area marked by a contour of support, or the additional surface generated on the external perimeter contour, where also the sealing clamps (8) and the bodies of impact (6) are selected between:
a sealing clamp (8) and a body of impact (6) aligned with a sealing clamp;
two sealing clamps (8) and a body of impact (6) which is located between the middles of the sealing clamps (8) aligned with such sealing clamps (8), and
two sealing clamps (8) and two bodies of impact (6) which are located between the middles of the sealing clamps (8) aligned with such sealing clamps (8).

The two sets of clamps (triple and/or quadruple (6, 8)) and or (one or two sets of double clamps) align or are aligned and have a separation between them in which at least as a minimum, the container or initial container enters, is introduced between them, as it also optionally has a trap door (10) [propelled by a linear and/or spin cylinder] which is positioned and moves away exactly below the initial container of holding clamp (3); therefore to act as a base of support for the initial container prior to its transformation, where the trap door is adjusted in height and has the function of putting the initial container on the exact height wanted, this way the holding clamps (3) grab the initial container—which is standing—by the zone of the center, of the edges or the zone not adjacent of the lateral perimeter side in which the flaps or triangular geometric bodies are originated.

According to a third fulfillment, a machine for transforming flexible containers is presented, characterized for having one, two or more additional holding clamps (3) or one, two or more sets of two or more clamps or pairs of holding clamps (3), this way in order to catch and/or exercise pressure to the interior or to inside the container, moving the fluid (packaged on the interior of the container) to the ends of the contour or perimeter side of the container, preferable in an area not adjacent to the area of the flaps or bodies of triangular configuration, where the holding clamps (3) are configured to retract by means of a type of cushioning, when the bodies of impact (6) actuate, in order to improve the formation of the flaps or triangular geometric bodies.

According to a fourth fulfillment, a machine for transforming a flexible, open or closed container of at least two faces and with an external surface, and of an external perimeter contour is presented, defined by at least one perimeter side, which is partially or totally filled by at least on sealed closing, where at least a part of the content of the container comprehends some fluid, [(liquid or/and pasty) or/and (air or/and gas)] and optionally with at least one solid or solids/granulates/powders or without them,

where the machine is characterized because it includes:

cylinders or clamps which can be fixed and/or anchored by means of a type of support as for example one, two or more columns, one, two or more platforms (18), one, two or more units of linear transfer (17), at least one cylinder or at least one clamp;

at least one sensor to detect the initial container and/or also the performance of the machine;

a triple or quadruple set of clamps (6, 8) (or also two double sets of clamps (6, 8)) on the top part, and

a triple or quadruple set of clamps (6, 8) (or also two double sets of clamps (6, 8)) on the bottom part, on which the set of clamps (6, 8) of the top part and the one from below are aligned or align themselves vertically and have a separation between them in which at least as a minimum the container already transformed or the initial container may pass or enter between these two sets of clamps (6, 8).

The impact clamp(s) (6) of each set [(triple and/or quadruple) and/or one or two double sets] are fixed to the tappet of a spin cylinder (16) [on which the impact clamp (6) of these double/triple/quadruple sets may be, in turn, fixed or not to the tappet of a linear cylinder (9) in vertical], and the sealing clamps (8) or sealing and cutting clamps (8) of each triple/quadruple set of clamps (6, 8) is fixed to its corresponding impact clamps (6).

From here, the initial container will hit or bump whether falling to the emptiness or whether dragged by a mechanical arm or robot arm, first over the top part of the impact clamps (6) therefore originating one or two flaps. After that, the sealing or sealing and cutting clamps (8) when actuated, catch and hold the flaps originated, which are optionally sealed but not cut (sectioned), therefore leaving the container held by both clamps (6, 8), this way immediately after the container spins 180° [due to that the impact clamp (6) is fixed to the tappet of a spin cylinder (16)] downwards without falling, and next the other lateral side parallel to the lateral side where the flaps have been originated hits or bumps (or vice versa) against/over/on the other impact clamp (6) which is located on the bottom part.

Finally, the flaps or triangular geometric bodies originated both on a lateral side as on the other will be sealed or sealed and cut by the sealing (8) or sealing and cut clamps. [Optionally the flaps will also be sealed and adhered or be folded and attached].

Once the initial container is transformed into the shape or geometric body on 3D wanted, the impact clamp will rotate 180° down to deposit the container in a conveyor belt, vessel or box.

This transformer machine on 3D is more optimized when it is used with initial container of big size as for example the half liter, on liter or two liters, in which for example liquids or thicks are packaged on their interior.

The machine may incorporate a column in vertical where two sets of clamps (double, triple, quadruple) are fixed and anchored where the impact clamp (6) of any clamp is joined to the tappet of a spin cylinder (16) and which, in turn, this last is fixed or anchored in horizontal position and creating a straight angle in regards to the column. This cylinder spins 180 degrees or 360 degrees. The two sets of clamps are aligned in perfect symmetry one below the other. The distance between them depends on the length of the height of the initial container being this in standing vertically, in other words: it should be possible to fit or pass the initial container between these two sets of clamps without touching any of these sets of clamps. Also, there are optical or infrared sensors (1).

An obtainable container is an additional object of the invention according to the previously proposed method, and the preferential fulfillments of such methods for the transformation of containers that comprehend a first stage or pushing to define the flap and afterwards:

without making anything in it;

fold the flap and adhere/attach the flap to the rest of the container;

seal the flap;

seal the flap and then fold and adhere/attach it to the rest of the container;

seal the flap and then fold it.

The obtained container may show, according to different fulfillments shown and described by means of the figures, perpendicular sealing lines (2) which are perpendicular to the sealed closing of the contour of the initial container or to the own external perimeter contour.

Model of a Vertical Transformer Machine that Transforms Initial Containers into Containers with a Tridimensional Geometric Body.

1st Stage:

We have to place the initial container on a vertical standing position between the holding clamps (3) (propelled by a clip cylinder or of two linear cylinders (9) or of double tapper or double effect) which will catch/grab and/or immobilize by the area wanted from this, preferentially by the are or part of the initial container non adjacent to the lateral perimeter side where the flaps are going to be originated, by the area of the center (or approximate) of the initial container.

It comprehends the different ways to carry out with it:

A) The conveyor belt that transfers the initial container is adequately articulated as for being able to spin laterally and vertically when an object placed exactly below the conveyor belt obstructs its path, therefore this way also, being the initial container placed in vertical position but still being to the side.

It will be, then, as a second linear conveyor belt (this will not spin and, also, will have on each side, rigid bars or an elevated surface to enough height as for the initial container not to be able to tilt-lean to any side, and therefore be able to stand vertically at all times) which runs to the side of the first conveyor belt, which receives this initial container in vertical position but to the side.

Next, for this to be able to stand vertically (it already is) but standing and not to the side, there will be a transversal bar or an object, as a way of lever, and almost touching the top surface of the second conveyor belt, this way, as the initial containers are transferred or are in movement, they spin a quarter of a turn when being blocked by the bottom part by this outstanding bar placed transversely in regards to the second conveyor belt.

Once we already have the initial container in vertical position and standing, they will accumulate one after the other, for finally these being deposited or to fall exactly between the holding clamps (3) when the trap door opens (10). It is also possible dropping the initial container in vertical into a second conveyor belt, which has separators and/or supports.

B) The initial container which is transferred in horizontal position lying on a first conveyor belt will be picked up directly by the arm-claw of a robot of 5/6 axis, therefore this way it is deposited exactly between the holding clamps (3) (propelled by a clip cylinder or of two linear cylinders (9) or of double tapper or double effect) or also by means of the hand of a person or the claw of a robot of 4/5/6 axis which will be used to grab the initial contained by the top part, for then deposit it between the holding clamps (3).

For any of the two options:

There may be a height-adjustable trap door (10) in the machine or underneath the holding clamps (3), with the only function of putting the initial container to the precise height, as for, precisely, the holding clamps (3) go through the initial container which is in vertical position, exactly by the part of the center or the middle part of it, therefore the same amount of the initial container outstands over the top and under the bottom of these holding clamps.

In the option of the letter (A), the trap door will be indispensable.

In the option of the letter (B) it will not be necessary—even though it can carry it—since the movements of the arm of the robot may be entered (by introducing parameter through the computer and with digital camera) to the millimeter, making easier the exact location (to the left or to the right) and to the exact height that the robot will keep the initial container suspended, for later the holding clamps (3) (propelled by a clip cylinder or of two linear cylinders (9) or of double tappet or double effect) to catch it exactly by the center area of this or by the area wanted from this.

2nd Stage

The initial container will be transformed into the shape of a tridimensional volumetric geometric body, by the action of frontal, oblique or diagonal hitting of the impact clamps (6) which are propelled or actuated by linear cylinders (9) or spin cylinders (16), and which are positioned or placed above and/or below the initial container or holding clamps (3), in this type of machine.

After this, the sealing or sealing and cutting clamps (8) will be actuated, this way to seal or seal and cut/section one, two, three, four or more (provided that the initial container from which we start to be transformed has an irregular shape with more than four vertexes) of the flaps. (It can also be done by means of a way for folding or folding and adhering/attaching at least one of the flaps or triangles to the rest/body of the container).

This way, the container already transformed will remain in time with the shape of a tridimensional geometric body which was pretended or wanted to be obtained or give.

Both types of clamps (6, 8) may be fixed in/over the same frame or go separately individually ones from the others.

On any case, they can be placed in the following ways:

The impact clamp (6) can be fixed or anchored directly to one or two of the columns in vertical/horizontal/different degrees of slope and also, in turn, this clamp may be fixed or anchored to the tappet both of a linear cylinder (9) and of a spin cylinder (16) of a platform (18) propelled by units of transfer (17) such as a frame or chassis in which at the same time this is fixed or attached to a linear cylinder (9) or a spin cylinder (16).

The sealing and cutting clamps (8) which can be attached or fixed to one of the columns in vertical/horizontal/different degrees of slope to the right or to the left, to the impact clamp (6) by means of a clip cylinder or linear cylinder (9) or of double tappet and double effect, attached to the platform managed by two units of linear transfer. Also, in turn, this clamp (8) may be fixed or anchored to the tappet both of a linear cylinder (9) or spin cylinder (16), such as a frame or chassis in which this may also be fixed or attached to a linear cylinder (9) or a spin cylinder (16).

In the other hand, both clamps may also be attached or fixed to the same column.

The different sets of clamps (6, 8) attached or not over the same frame, may be arranged or placed regarding to the initial container, in the following ways:

Set of double clamps which is placed diagonally regarding to the tips from the initial container, and is composed of an impact clamp (6) and a sealing and cutting clamp (8).

Set of triple clamps which is place in front (frontal) and parallel to the lateral, edge, welding line of the two sides (the one on the top and the one on the bottom) of the initial container. It is composed of an impact clamp (6) in the center and two sealing and cutting clamps (8) to the left and to the right of the impact clamp (6).

Set of quadruple clamps which is place in front (frontal) and parallel to the lateral, edge, welding line of the two sides (the one on the top and the one on the bottom) of the initial container. It is composed of two impact mini clamps (6) joint between them and in the middle, and two sealing and cutting clamps (8) to the left and to the right of the clamp (6).

They operate the following way:

After the first stage and immediately, the impact clamp (6) will be actuated propelled by a cylinder or actuator (linear or of spin) in order to penetrate and adhere over/on the intermediate area/part of the sides or areas adjacent to the four vortexes of the initial container, and by the part from the above and/or below of this initial container.

An adjustable cushioning system such as a spring may be added between the joint of the tappet and this clamp (6) as a method for guaranteeing the homogeneity of the containers produced, since this way the impact clamp (6) may hit against the holding clamp (3) since this one retracts, therefore this clamp (6) will always remain adhered to the holding clamp (3), working this way as a measure for the clamp (6) to push or introduce to the interior the same amount or part of the lateral perimeter sides of the initial container.

On every hitting action and for each impact clamp (6) one or two flaps or triangles will be originated and, at the same time, it will case the initial container to swell, as a soufflé, to acquire this way the shape of a tridimensional geometric body which was wanted to be transformed or obtained.

Therefore, depending on the depth that we let the impact clamp (6) to penetrate to the interior of the initial container, the flaps originated will be of bigger size, so we will obtain a transformer container with bigger volume and more volumetric and, on the contrary, the wrapping of the container has been reduced in size. Also due to the fact that bigger flaps have been originated, sealed or sealed and cut, this will cause the initial container to transform itself into a shape of a geometric body on 3D, more square and with less height.

In turn, other factors influence also, such as for example: the size or the width of the impact clamp (6) in relation to the width of the sides of the initial container (more width=less flap), of the amount of fluid contained [(liquid or/and pasty) or/and (air or/and gas)] and at least one solid or solids/granulates/powders or without them, on the interior of the initial containers.

In any case, the frontal bump hitting action by means of the impact clamps (6) will produce, same way and naturally and spontaneously, that the initial container swell as a soufflé, independently from the other flaps or triangles originated to be sealed or cut and sealed.

The impact clamps (6) may carry or have, on their ends and both lateral sides and on the surface that acts as a support or as the base for the clamp (8), a rubber or any other piece or material that may be suitable as for guaranteeing the good performance of the system or welding method to be used or employed.

The impact clamps (6) may be of two types:

1) of one piece.

2) of two separated pieces that align themselves, in which both remain attached one to the other, in the following way:

a—both (6) joint by two or more fixed bars.

b—both (6) joint by a pneumatic or electric mini cylinder of double tappet and double effect, this way to move-open to the exterior (until almost making contact with the sealing and cutting clamps (8) which will be placed and aligned exactly in front) for the flaps to form properly by impeding or facilitating that no wrinkles or foldings are formed in the area of the container or the line of the joint, between the flap and the rest of the container. It could also help the flap to form properly or complete and, at the same time, to expel from the flap the fluid [(liquid or/and pasty) or/and (air or/and gas)] and with at least one solid or solids/granulates/powders or without them.

Also, the impact clamps (6) may carry, adhered to the surface or external lateral sides where they receive the bump from the sealing and cutting clamp, a rubber, the fact of not carrying it, or being of any other piece or material not suitable to guarantee the good operation or performance of the system or method for welding which will be used or employed.

But in any case, all the types of impact clamps (6) have the same objective: other than serving to create flaps and to transform the container into the shape of a tridimensional geometric body wanted and to act as a surface of support for a sealing and cutting clamp (8). Also, if the clamps (6, 8) were not joint on the same frame, the impact clamp (6) will be used to indicate where the sealing and cutting clamps (8) should be located and standing (to align in a line).

Next, instantaneously and simultaneously, the sealing clamps or sealing and cutting clamps (8) are actuated propelled by an actuator or linear cylinder (9) and/or spin cylinder (16) or pneumatic or electric clip cylinder, this way to hit or bump against the impact clamp (6) and, at the same time, to catch/trap the flap between the two clamps (6, 8), for after, by means of a heat source or welding system, (resistance, ultrasound head, laser, or rotation, thermal sheet, by friction . . . ) to seal or to seal and to cut the flap, preferentially by the part or the side or line transversal of intersection of the flap with the rest of the container already transformed into the shape of shape of a tridimensional geometric body on 3D.

The cutting of the flap can be done my means of a way for example of a blade.

This clamp (8) can also carry, between the tappet and the clamp itself, a cushioning system by means of a way for example a spring, this way to join or hit without brusqueness against the impact clamp (6). Also, it may have at the end of the tappet, a ball that fits or is introduced into the empty semi spherical cap or cushioning (a little more than the half of an empty sphere) which will be fixed on the part of the back of the sealing clamp (8) or sealing and cutting clamp (8).

In every process the holding clamps (3), always keep the container grabbed, for only releasing it when this has been already transformed into the shape of a tridimensional geometric body which was pretended or wanted.

All the type of clamps, elements, devices or pieces or this machine can be adjusted both in height as in linear length.

The clamps (6, 8) or sets of double, triple or quadruple clamps or also every flap or triangle can actuate or sealed themselves—as many as there are on each machine—all at the same time or separated individually, one by one, two by two, three by three, four by four, or more by more, since this does not affect at all the final result of the container of tridimensional geometric body that we would wanted to obtain from the beginning.

Also, it can also be added to this vertical transforming machine of initial containers on 3D, or may randomly comprehend multiple possible combinations, of at least one or less than one of the following elements, devices, pieces or clamps:

A) Trap door (10) which is placed below the holding clamp (3) of the initial container, to act as a support base for the initial container, which other than being able to be adjusted (different heights), will also be used for the holding clamps (3) to remain aligned exactly to the intermediate line (which transversely divides in two equal halves) or central middle area of the initial container which will be in vertical position.

This will be triggered by a pneumatic or electric cylinder (9) as well as, also, by a pneumatic or electric spin cylinder (16) which is anchored or fixed to one of the columns.

B) Fixing bars (11) which delimit the exact place where the initial container is deposited.

This way, it will be of more help if it fits, that the initial container prior to being grabbed and pressed by the holding clamps, to be in perfect verticality without bending or crushing the bottom part of the container.

It is only necessary in some type of initial containers that tend to fold or bend, whether for being manufactured with materials of few gauges (50-60) or whether because they are initial container of a considerable size and weight as the ones of the containers of half liter or one liter.

C) Locking bar (12) which helps that the initial container, which has been deposited by the lateral and above the trap door, to stand exactly in the place indicated by this bar. This system is used when the clamps (6, 8) from above of the holding clamp (3) cannot move forward or backwards to clear the area this way.

D) Guide clamp (13) which is used only for propelling out of the machine the containers already transformed in the shape of a cubic figure which remain supported above the clamps (6, 8) of the lower part, since the machine does not count anymore with devices such as the units of transfer (17), spin cylinders for dump truck (16) or simply no count with more linear cylinders.

The guide clamp (13) is connected to the tappet of a linear cylinder (9) or of pneumatic/electric spin.

This clamp (13) has the shape of a straight line or whether it has, to the middle of the straight line, a curve with an angle of about 20°, conditioned this way, for the initial container already transformed into a new shape of cubic figure, to be ejected—pushed by the guide clamp (13)—in a straight line to finally fall above a conveyor belt, vessel or box.

E) Sweeping bristles (14) which will carry out the same function than the guide clamp, in other words, to eject out of the machine the containers already transformed into the shape of a cubic figure, but which in this case, the bristles are hooked or fixed to the edge of one of the two sides with more length of the trap door (10). These fall down.

F) Air shooter (15) which is used to impel or to more away the containers already transformed into a shape of a cubic figure, to the outside or to a box, vessel or conveyor belt which, precisely, are placed below the vertical machine.

This is fixed to the column and situated or placed at the same height than the one of the container already transformed into the shape of a cubic figure.

G) Spin cylinder/engine for dump truck (16) pneumatic or electric cylinder/engine which is anchored or fixed to one of the columns. They have two functions:

g1) to be used to enable space (rotating upwards) for the initial container to be introduced between the holding clamps (3) without difficulties, if it is above the clamps from the top part,

g2) every time it is placed below on the bottom part, to be used to knock the container over—once it has been already transformed into the shape of a cubic figure—turning it downwards, this way to, by its own, end up falling above a conveyor belt, vessel or box.

H) Units of linear transfer (17) pneumatic or electric which anchor or fix into the columns. Depending on their function there are two types:

h1) two units of linear transfer (17) with a platform (18) which are parallel and make couple to the left and to the right of the machine.

The clamps (6, 8) are placed or installed over/on this platform to facilitate, this way, that, in one hand, (provided that these are installed in the top part) they leave free space for the initial container to be deposited between the holding clamps (3); and in the other side, if the platform (18) with two units of linear transfer, would transfer the clamps (6, 8) from the top part (6, 8) of the bottom part, these will be used for the containers already transformed into the shape of a cubic figure and the flaps that were wanted to be sealed and cut, to be able to fall without difficulty and without obstructions to a conveyor belt (opportunely placed under the machine), vessel or box.

h2) a unit of individual linear transfer (17) which transfers the holding clamp (3) and, at the same time, the initial container, this way for being able to move away both from placing exactly above of the clamps of sets of clamps (6, 8), this way therefore, when the holding clamps (3) are opened, the cubic container falls over a conveyor belt, box or vessel.

3^{a} Stage [c]:

The flaps or triangles already sealed and cut (sectioned) separate from the container already transformed into a volumetric tridimensional geometric body, in the following ways:

a) by blowing, orientation or direction to a specific location.

b) by falling directly to the floor or over a vessel-box, since that under the vertical machine there is no conveyor belt or anything that prevents it. In the case that a conveyor belt is installed under the vertical machine, these are the possibilities given:

c) by passing from a conveyor belt to another, since there is a space between them, big enough as for the flaps that will always be smaller, to fall into the floor or over a vessel.

d) by means of a conveyor belt with mesh, since it counts with holes wide enough as for, by their own, the flaps to fall to the floor of over some vessel, which will be placed exactly underneath.

The containers already transformed into the shape of a tridimensional geometric body, separate from the container in the following ways:

a) by falling directly into a vessel or box, since that under the vertical machine there is not a conveyor belt or anything that may prevent it.

b) by falling directly into a conveyor belt that runs exactly or is installed underneath and/or to the side of the vertical machine of the invention by means of a unit of linear transfer (17) which transfers or directs the holding clamp (3) and also the container—since these are fixed or anchored to this unit of transfer (17)—from left to right, this way freeing the area of below where the clamps (6, 8) are located or are placed or any of the elements, devices or pieces of the own vertical machine.

c) by falling by means of a trap door (10) or from another conveyor belt, directly to a/another conveyor belt or also to a box or vessel.

d) be trapped/grabbed (selected) and directed by the claw of the arm of a robot or also by the clamp(s) of a mechanical arm.

e) by means of an air shooter (15) oriented or directed for propelling the container already transformed container into a specific place.

d) by means of a guide clamp (13).

Pinching Clamps (19)

According to a preferential fulfillment, in order to elaborate the containers, pinching clamps (19) can be added to the edge or external surface of the container in order to generate by means of the sealing, at least one line of the edge type (4) to provide rigidity and stability to the container.

These are folded or smashed by pinching or catching any of the edges a container already transformed into the shape of a tridimensional geometric body, for a burr or flap outstanding to the outside of the edge to be originated and then every set of two pinching clamps to seal this burr or flap originated in the edge. Optionally, they can also seal and cut or seal and attach the burr to the rest of the container.

The objective immediate of this technique or process is to provide or to give to any of the containers already transformed into a shape of tridimensional geometric body a higher consistency and stability, even though it is not necessary, since that without this application or process, which is optional, the containers are already stable and consistent, keeping standing on their own.

Each set of two pinching clamps (one of impact and the other of sealing and cutting) can be placed to carry out or to actuate with the movements similar to the ones of a normal set of two clamps, or otherwise it can also carry out the movements similar to those from a common clip.

These pinching clamps (19), once the container is grabbed and/or immobilized and this being transformed to the shape of a tridimensional geometric body, will clamp, pinch or catch between the two pinching clamps, any of the edges of the container, for then after these two pinching clamps (19) join to both sides of the edge, seal or seal and cut the part wanted from this edge/burr which has been pinched/trapped. The sets of pinching clamps (19) can move or actuate in the following ways:

6.1) Lineally and exactly in front in regards to the edge, which may be impelled by means of a way such as one or more linear cylinders (9) or spin cylinders (16) or of clip.

In this case, there are two possibilities of action and movements:

6.1.1: the set of two pinching clamps (19) which is located in front of any of the edges, will go forward (the distance wanted) hitting this way the two faces/sides adjacent to the edge. Following this, the two pinching clamps will close and join one with the other [since each one of the two pinching clamps (19) is fixed to the tappets of a linear cylinder (9) in which, at the same time, this two linear cylinders are fixed to the tappet of a linear cylinder (9) or of spin (16)] this way forming the burr of flap which will be sealed or sealed and cut leaving the millimeters wanted from it.

But also, being optional, once the two clamps (19) have the flap or burr trapped and before this is sealed or sealed and cut, the two clamps can go backwards in order to make the flap or burr to stretch, with the only purpose of assuring that fits, the creation of this flap or burr more stretched and without any wrinkle or folding.

6.1.2: the set of two pinching clamps (19) which is placed aligned exactly on one side and on the other of the edge, will only go forward (the distance wanted) this way hitting the two sides or faces adjacent to the edge, therefore originating the burr or flap, which after and instantly, these two parallel pinching clamps will seal or seal and cut this burr or flap, leaving the millimeters wanted from it. Each one of these pinching clamps (19) may be fixed or attached to the tappet of a linear cylinder (9), or otherwise it can also be fixed or attached to the tappet of a linear cylinder of double tappet and double effect.

But also, being optional, one the two clamps (19) have the flap and the burr trapped and before this is sealed or sealed and cut, the two clamps may go backwards, therefore making the flap stretch, with the only intention of making the flap be better formed by being more stretched and without any wrinkle or folding.

6.2) Lineally and exactly in front in regards to the edge but with a movement similar to the ones of a clip, which may be impelled by means of a way such as one or more linear cylinders (9)/spin cylinders (16) and/or of double tappet and double effect: in which the two clamps (19) are joint by a transversal axis located to the middle, and between clamp (19) and clamp (19) and on the part of the back or more to the back of the transversal axis, a cylinder of double tappet double effect or otherwise also two linear cylinders (9) placed vertically which impels each one of them to each one of the two clamps (19). Therefore, while it goes forward (the distance wanted) in order to hit the two sides or faces adjacent to the edge, it can open itself or previously be completely open, this way originating the burr or flap, which then and instantly, these two parallel pinching clamps will seal or seal and cut this burr or flap, leaving the millimeters wanted from it.

But also, being optional and once the two clamps (19) have the flap trapped and before this is sealed or sealed and cut, the two clamps may go backwards, therefore making the flap or burr stretch, with the only intention of making the flap be better formed.

Following this, with the help of the figures, several preferential fulfillments are proposed for a number of especially remarkable containers.

1.—The transformed container may be originated from an initial container of squared or rectangular shape, as well as two flaps have been generated, which have been adhered, sealed, sealed and adhered or sealed and cut, obtaining a container with a face of support with rectangular or squared shape.

2.—Be part of an initial container of squared or rectangular shape, as well as three flaps have been generated, which have been adhered, sealed, sealed and adhered or sealed and cut, obtaining a container with a parallelepiped shape with a face of support with rectangular or squared shape, as well as an additional flap has been generated, opposed to the face of support, and which has not been sealed nor cut, to define a dispenser neck or outstanding neck.

3.—Be part of an initial container of squared or rectangular shape, as well as four flaps have been generated, which adhered, sealed, sealed and adhered or sealed and cut, obtaining a container with a parallelepiped shape.

4—Be part of an initial container of quadrangular shape with three adjacent sides mutually perpendicular and a diagonal side, as well as two flaps have been generated on the opposite side to the diagonal side, obtaining a polyhedric container with a rectangular or squared face of support, opposed to the diagonal side, as well as with a dispenser neck pointing to an end of the diagonal side.

Lastly, as a specially interesting case, a set of container which incorporates at least a flexible container of the already described throughout all the invention is described, where the container is obtainable according to a procedure on which all the flaps have been sealed and cut; as well as additionally the container or the containers are sterilized and contain in an stagnated way, a freezable liquid, where the set of container additionally comprehends at least one wrapping which wraps one or many of the containers in order to preserve the sterilization of the containers.

This fulfillment allows to have a flexible container full of a product which may be repeatedly frozen without the necessity of being refilled after every use, and may be employed for any use that required of a sterilized cold body, for example, as freezing food or beverages, applying on inflammations, etc.

Process to Give the Containers Transformed into Containers of Tridimensional Geometric Body of One or More Necks, Tip or Outstanding Peaks, as a Way of Dispenser and Easy to Open:

1.1) Seal and cut (section) with a set of two multiform clamps (FIGS. 22, 23, 24) [one of sealing and cutting (8) and another one of impact (6) or normal clamp which are aligned in parallel and when actuated are placed over plane by both faces of the initial container], one or more of the parts wanted or of the transversal or longitudinal of the top part (it can also be carried out in the lower part or on any of the sides that the initial container may have and adding the sides wanted) of the initial container, on which two or three of the adjacent sides can be trapped-smashed if it is an initial container of four sides and with squared or rectangular shape, or also of more adjacent sides if it is an initial container or irregular shape in which there are more than four sides/vortexes.

Sealing and cuts of multiple and different forms and combinations between them can be done, of different type of lines: oblique (FIGS. 22, 23), rectilinear, curve, curvilinear, elliptical, diagonal, sinuous, of saw, etc. The can also be circular and of any size wanted, producing with this a hole that may serve as a handle to be used for hanging the container already transformed into a container of tridimensional geometric body.

This way then, depending on the parts that have already been sectiones (sealed and cut) on the initial container, containers with multiple and different shapes of irregular polyhedron which are very attractive and original will be obtained, since they can simulate and type of letter or object due to the delimitation or sectioning of the initial container with perimeter welding lines (1) of the shape of the letters or objects.

Next, the types and shapes of containers are explained with examples:

Those that are expressed in the drawings or the FIGS. 25/26/27/28/29/30/31/32/33;

Or others with the same letter shape as for example an <M>, <B>, <H>; or also shapes that simulate objects as for example a Crown with two or more vortexes/tips that outstand upwards, a baseball Glove, Mitt, a Teapot, the Chimneys of a steam ship, of a Bottle with a neck, Jar, of a Crocodile, a motor Yatch, a sail, a Shirt with its neck, of a Comp for the hair with its spikes, of Trident, of a Castle with its battlements, of a Cup with its handle, of a magical Lamp, of a Chicken's head or any other animal, with the shape of the Statue of liberty, etc.

These sets of two clamps (8, 6) parallel multiform (not of an only rectilinear in horizontal and transversal of an only direction) of sectioning of the initial container by its two faces, may have form or be composed of one or more different rectilinear joint between them, on which each one of the one that would be there, is place on different degrees of slope or in different directions. In other words, fixed or joint to any of these ends of a game of two rectilinear multiform clamps (6, 8) or on the degrees of slope wanted.

Being possible to repeat this (the adding of as many sets of two multiform and multidirectional clamps (6, 8) as wanted) successively as many times as wanted and with multiple possible combinations, since every set of two multiform clamps (6, 8) may be rectilinear, curve, elliptical, curvilinear, oblique diagonal, sinuous, with saw tips, sinuous, wavy, etc.

These irregularly sectioned parts with multiform clamps (6, 8) applied to the initial container will affect or implement to the final result of the container of tridimensional geometric body which was wanted to be obtained, with the following characteristics and qualities:

several different shapes of containers of volumetric tridimensional geometric body or of irregular polyhedric shapes can be manufactured and customized. To this type of container, only two of the flaps or triangles from the bottom part of the lateral side of the bottom part of the initial container are going to be preferentially originated, sealed or sealed and cut.

This new, multiple and varied designs of containers suppose an important advantage in the Marketing sector, since a concrete product and a specific brand can be related or identified with a concrete shape (original, practical and attractive) of unique/exclusive design of a container with the shape of a volumetric tridimensional geometric body.

on the top part (one or more of the transversal side from higher and, also, one of more of the sides adjacent to the transversals) of the container already transformed, outstanding tips/peaks/necks are created or originated, which may be used one or more of these as dispenser peak-tip-neck, from where the content [(liquid o/y pasty) o/y (air o/y gas)] and optionally with at least one solid or solids/granulates/powders or without them] packaged on the inside will flow and/or come out to the exterior of the container.

it gives more consistency and rigidity to the container already transformed into a shape of a volumetric tridimensional geometric body.

the content packaged in the interior of these container can be measured out, in a way much more accurate, clean and comfortable due to its volumetric and also to the tips-peaks-vortexes which have been created standing out to the outside, which facilitate the serving with these: the content packaged on its interior, being of great use for food products such as for example: sauces, jam, honey, syrup, cleaning products, perfumes, etc.

it can be added by means of a opening way or easy-to-open, a small groove applied on the end part of the burr or perimeter welding line (1) of any of the peaks, tips or vortexes which have been able to be created on any of the ones from these containers with the shape of a tridimensional geometric body or of irregular polyhedric shape. This way, by tearing by this groove, the measuring out of the content packaged inside the contained will be facilitated. Also, it can be places/installed by means of a type of dispenser as for example: a cap, valve, nozzle or aluminum strip.

On any of the machines transformed on 3D of the invention and after the 1st face and previous to the 2nd face and the 3rd face, it can be carried out this process of adding dispensers by means of the sectioning of the sealing and cutting of the parts wanted from the top part of the initial container. In this case, therefore, it shall be carried out exactly after the initial container has been grabbed and/or locked in the position wanted, as for example lying or in vertical, by the holding clamp(s) (3).

This process can also be carried out, although in a more complicated way: after the initial container has been already transformed into a container with a volumetric tridimensional geometric body of three or more faces, by means of the same type of clamps (6, 8): one of sealing or sealing and cutting and one mobile impact clamp), in which these that align will hit at the same time by both faces the wanted part of the container, this way to seal or seal and cut the chosen part.

Due to this, the already explained in the process of the 1st stage of the second (b1) and third (b2) transforming machine may be used as one of the way to carry out these irregular sectionings or sealings and cuttings of these parts from the top part of the initial container, for which, prior to commencing with the 1st stage of the first (a), fourth (c) and fifth (d) machines, the initial containers can be grabbed and/or locked by one or more holding clamps (3) or one or more sets of two or more holding clamps (3) as described on the 1^{st} stage (b1, b2).

Practical explanation with an example, represented by the following drawings: the container from FIG. 28, has been produced or created by the sectioning (by means of a set of two multiform clamps which in this case is a rectilinear in diagonal) of the top part (or of one of the parts) of the initial container, as expressed in the drawing from the FIG. 23 y FIG. 24.

This way, an irregular tridimensional polyhedric container with the shape of a House but with a 3-sided roog, in which it can be appreciated on the highest part, a face with the shape of a triangle and which, in turn, this face can be divided into three mini-faces with the shape of a triangle.

Also, on this same higher part and to three quarters of that same face, a peak-tip-vortex with a slope of about 45° stands out upwards, corresponding or matching exactly on that particular point due to that it is exactly where the set of two multiform clamps (6, 8) in diagonal have initiated the sealing and cutting of the lateral side in horizontal of the highest part of the initial container. And on which, also, on the left part of the container already transformed, there is a peak, tip or vortex standing out to the left, which matches or corresponds exactly on that particular point due to that it is exactly where the set of two multiform clamps (6, 8) in diagonal have initiated the sealing and cutting of the lateral side in vertical of the left part of the initial container.

1.2) Leaving without originating, sealing or sealing and cutting one or two of the flaps or triangles of an initial container of at least two faces, this way originating one or two dispenser necks or outstanding tips-peaks that stand out on the top part of the container already transformed into a shape of a tridimensional geometric body to the left and/or to the right.

Practical explanation with two examples, on which it has been used an initial container with the shape of a square or of a rectangle with two faces and four sides, in case we would like to obtain a transformed container with an only dispenser neck on the top part and to the left side or to the right side, two flaps or triangles will be originated on the lateral side of the lowest part of the initial container. And on the lateral side of the highest part of this initial container, an only flap will be originated, sealed and cut, being either the left or the right one.

Therefore, we will obtain a transformed container with the shape of a tridimensional geometric body, as expressed in the drawing or FIG. 40.

in case we would like to obtain a transformed container with two dispenser necks on the top part, two flaps or triangles will be originated on the lateral side of the lowest part of the initial container.

And on the lateral side of the highest part of this initial container, no flap or triangle will be originated, sealed and cut; therefore it will remain as it is. Therefore, we will obtain a transformed container with the shape of a tridimensional geometric body, as expressed in the drawing or FIG. 30.

1.3) Combining both methods or processes of the sections [1.1 and 1.2]. In this case, once the initial container has been already transformed into a container with the shape of an irregular polyhedron with one or more tips, vortexes or dispenser necks, to this container on the face(s) of the highest part or of the lateral perimeter sides of the highest part, two flaps or triangles can be originated, sealed or sealed and cut (one on the part of the left and/or the other on the part of the left).

This way, therefore, we will obtain a transformer container with the shape of a tridimensional geometric container, in which the shape of irregular polyhedron that was first obtained will be modified even more, for which it can still obtain different and original irregular polyhedric shapes, producing with this the possibility of appearing mini-faces with the shape of for example a triangle: equilateral, rectangular, scalene, isosceles, obtusangular.

2—The procedure and processes explained in the previous section, in which the parts wanted from the initial container are sectioned, can also be done—in the same method/mechanism/operation—by connecting or directly substituting this type of multiform and multidirectional clamps, to the sets of two clamps of the Machines for filling and packaging in vertical, which are the ones that manufacture the initial container of at least two faces.

2A—Functioning of the Multiform Clamps and the Rectilinear Clamps in Horizontal, on Any of the Vertical/Horizontal Filling Machines that Manufacture Initial Containers of at Least Two Faces:

For a good use in regards to effectiveness and efficiency, two different types of sets of two parallel clamps that seal and but by both faces of the initial container are going to coexist: one set of two rectilinear clamps in horizontal position and another set of two multiform clamps, one in top or on one side of the other, without obstructing one to the other, in order to being able to be actuated in separate, since it will be needed that both combine simultaneously and alternating one with the other at the time of sealing and cutting the initial container by both faces.

On each manufacture cycle, there two different type of set of clamps (the multiform and the rectilinear in horizontal), interact the following way:

First: the set of two rectilinear clamps in horizontal position of sealing and cutting are actuated, which is the normally used on any of the vertical/horizontal filling Machines, available in the market nowadays.

Second: the set of two multiform clamps of sealing and cutting—already described in the previous section with the n°1—are actuated, in which this will never have the shape of an only rectilinear in horizontal which seals and cuts all the width of the initial container.

Third: the set of two rectilinear clamps in horizontal position is actuated again, same as in the First step.

Fourth: the set of two multiform and multidirectional clamps are actuated, same as in the Second step.

This way, initial containers of irregular shapes are obtained, in other words, without these have a square or rectangular shape.

Therefore, by means of this procedure in which these two type of sets of parallel clamps (one rectilinear in horizontal and the other of multiform) are alternated, we obtain at the same time and in the same vertical/horizontal Machine that manufactures the initial containers of at least two faces, the following types of initial containers:

2A.1: The same initial container is obtained twice in duplicate on each manufacture cycle of alternation of the two types of sets of clamps due to that one of the sets of two clamps is a rectilinear in horizontal position, and the other of the sets of two clamps which is multiform is a rectilinear in diagonal position with the length and with the degrees of slope wanted.

Therefore it is obtained, on each cycle, two identical containers, on which these are at the moment of being manufactured are placed or are located on in front of the other, but looking at each other or being together exactly by the lateral side of the initial container which is a rectilinear in diagonal, therefore one of the initial containers is looking to the contrary direction.

This way, initial containers with the same shape of initial containers and which, in this case, is similar to the shape of the figure of a windsurf Sail, will be manufactured.

2A.2: If, on the contrary, we use a set of two parallel multiform clamps on which these are not of an only rectilinear, but they are or have more than two lines or sides (these may be of any shape, length, width, in any degree of slope, and on which these can also randomly combine between them, in the multiple and varied way wanted), it is obtained on each cycle of alternation of the two types of sets of clamps, two irregular initial containers (not square nor rectangular) which are or have different shapes one in regards to the other, on which, according to the case, one or more of their lateral sides are going to have different shapes and be placed in a different way and others one or more of their lateral sides are going to have the same shape and are going to be located in the same place.

Next, we have a description of the two different models of initial containers which can be obtained from each set of multiform clamps of two or more sides, which will be used together with another set of clamps of an only rectilinear in horizontal position.

Therefore, on each cycle of these sets of clamps, it will always be obtained two different initial containers, which at the same time these, once two flaps are originated, sealed or sealed and cut on each lateral horizontal side of the bottom part of each initial container, each one of this will transform into a different container with the shape of a tridimensional geometric body.

Therefore, each couple of these different initial containers as well as the couple of different containers already transformed on 3D, we have named one as the positive and the other as the negative, or also <ON>y<OFF>: 2A.2.1)

Set of multiform clamp: it is composed of a rectilinear side placed in horizontal position (it can also be curvilinear, elliptical, sinuous, semi cylindrical, of saw, oblique, etc.) and in the length wanted, and on the other side which is rectilinear in diagonal position (can also be curvilinear, elliptical, sinuous, semi cylindrical, of saw, oblique, etc.), next or joint to any of the ends of the previous side which is a rectilinear in horizontal:

Initial container OFF: the lateral side placed on the bottom part of the initial container and which will work as a base of support for the future container transformed into the shape of a tridimensional geometric body will be a rectilinear (it can also be curvilinear, elliptical, sinuous, semi cylindrical, of saw, oblique, etc.) placed in horizontal position and with the length wanted. The lateral side which may be the one on the left or the one on the right, is a curvilinear (it can also be curvilinear, elliptical, sinuous, semi cylindrical, of saw, oblique, etc.) placed in vertical position and with the length wanted, and the other of the lateral sides that may be the one on the left or the one on the right, is a rectilinear (it can also be curvilinear, elliptical, sinuous, semi cylindrical, of saw, oblique, etc.) placed in vertical position but of a smaller size than the one of the other lateral side.

And in the lateral sides of the top part and the center of the initial container: two are rectilinear lateral sides (can also be curvilinear, elliptical, sinuous, semi cylindrical, of saw, oblique, etc.) joint in one piece, in which one is place in diagonal position and pointing upwards and to the exterior with the length and the degrees of slope wanted, and the other lateral side is places in horizontal position, with the length wanted.

Finally, only two flaps or triangles are going to be originated, sealed or cut in the lateral side of the lowest part which will be used as a base of support of the container already transformed.

Initial container ON: the lateral side located on the bottom part of the initial container and which will be used as the base of support for the future container transformed into the shape of a tridimensional geometric body will be a rectilinear (it can also be curvilinear, elliptical, sinuous, semi cylindrical, of saw, oblique, etc.) placed horizontally and with the length wanted.

The lateral side which can be the one of the left or the one of the right is a rectilinear (it can also be curvilinear, elliptical, sinuous, semi cylindrical, of saw, oblique, etc.) placed vertically and with the length wanted, and the other of the lateral sides which can be the one of the left or the one of the right is a rectilinear (it can also be curvilinear, elliptical, sinuous, semi cylindrical, of saw, oblique, etc.) placed vertically but of a smaller size than the one of the other lateral side.

And on the lateral sides of the top part and the center of the initial container, they are two rectilinear lateral sides (they can also be curvilinear, elliptical, sinuous, semi cylindrical, of saw, oblique, etc.) joint in one piece, in which one is place horizontally with the length wanted and the other lateral is placed in diagonal and pointing downwards and to the outside with the length and the degrees of slope wanted.

Finally, only two flaps or body of triangular figure are going to be originated to this initial container, in the lateral perimeter side that works as a base of support, which are folded and attached to the container, are sealed and adhered to the container, are only sealed or are sealed and cut.

Product or container manufactured by the Procedure and Machines of transformation from initial containers of at least two faces, manufactured with flexible material and sealed, which contain in their interior, at least one fluid [(liquid or/and pasty) or/and (air or/and gas)] and optionally with at least one solid or solids/granulates/powders or without them], into containers of geometric body, totally volumetric on 3D, which characterizes for that the container already transformed has a shape similar to the outline of a ship's Sail, and has five faces. This container may have any size, from sizes so small as the one of an eraser up to sizes so big as the one of a microwave oven, and also it can be given any length wanted to this container, both to the height and to the width.

The container may be manufactured with any type of flexible material, in single layer or multilayer, and also in tube, semi-tube, laminated or complex. All of the faces of this container may be flat with no flap or triangle if the flaps or triangles are sealed and cut.

The highest part of this container has the shape of the Sail of a boat, which is composed of a rectilinear (it can also be curvilinear, elliptical, sinuous, semi cylindrical, of saw) placed in diagonal which has a pronounced slope of about 45° to 65° degrees approximately.

The part or the face to the left side is place in diagonal an open to the outside, with some degrees of slope between 60° and 85° (or approximate), in which this depends on the size of the flap or triangle (the bigger the flap originated, sealed or sealed and cut, the bigger will be the slope to the outside).

The part or the face to the right side is place in diagonal upwards and to the outside, with some degrees of slope of 45° approximately.

The part or face from the lowest part of the container is a flat surface which according to the case may be square, rectangular, circular/circular elliptical.

Apart from this, this containers already transformed into a tridimensional geometric body has the peculiarity at the same time of having the shape of a wedge, since the highest part exactly at the end flattens until the two faces of the container join each other (forming an edge), and as it goes down, the containers grows wider and growing in volume, until reaching the end and the lowest part where it grows wider the most, where there is a flat and smooth face which works as a base of support for the container.

The container with the shape of the Sail of a boat which is in vertical standing position and in front of us (in a view of the lifting), has the outline (marked by the lateral perimeter sides) and the welding lines described as follows:

a) On the top part, there is or it has a welding line (1) or rectilinear in the middle or to the middle in diagonal position, which has a pronounced slope upwards of about 45 to 65 degrees approx.

b) The part of the face on the left side is place in diagonal and opened to the outside, with some degrees of slope between 60 to 85 degrees (or approximate). Also, optionally, in the center and longitudinally, it may carry or have a perimeter welding line (1).

c) the faces from the front and the back are two irregular flat polygons with the same shape of the outline of the Sail of a boat (it can be more rectangular or more square) in which these have a slope to the inside of about 30 to 80 degrees (or approx.), but when it is more optimized is when they have a slope between 45 and 60°. Also, optionally, in the center and longitudinally, it may have [a longitudinal welding line (4) on the front side] and/or [a longitudinal welding line (4) on the back side].

d) The flat face from the lowest area which acts as a base (may be square, rectangular, circular, elliptical, etc.) has in the center a perimeter welding line (1) in horizontal and longitudinal, and two perpendicular welding lines (2) in which the flaps have not been cut.

Optionally, two flaps, sealed or not and adhered or not to the rest of the container could have been left or carried.

In this particular case, as expressed in FIG. 56, an initial container of two faces, square or rectangular, has been used to manufacture this container, which only has two perimeter welding lines (1) in horizontal, although it can also carry [one or two longitudinal welding lines (4) in the front face and/or in the back face] and/or [one or two welding lines (1) placed in vertical in the left side and/or on the right side of the initial container or the container already transformed into a tridimensional geometric body].

One or two of the perpendicular welding lines (2), may not be rectilinear and perpendicular [90° regarding to the welding line (1)], this way being able to make different shapes as for example: curvilinear, elliptical, semi cylindrical, in triangles of saw, oblique, sinuous.

1. Procedure to transform a flexible container, wherein the container is equipped with:
At least two faces that delimit an interior enclosure, and that at the same time, these faces are delimited by an outer contour perimeter defined by at least one side edge, and/or
At least one line of sealing or fold that closes the container partially or in whole, in which container houses at least one fluid and can optionally or additionally accommodate at least one solid or solids, granulates or powdery, where the procedure is characterized by comprising the following stages:
to press in direction of the indoor enclosure of the container, by means of a pushing mode such as using at least one impact body (6) over at least one part of at least one side edge of the outline or also against/with/among/in the intermediate zone, partial area, full zone or zone of two lateral perimeter adjacent to one end or corner: of one, two or more of the lateral sides perimeter or vertices of the initial package, or vice versa {the perimeter against/with/among/inside the impact body (6)} as well as {being both moving [at least one impact body (6) and at least one lateral side perimeter when impacting}, in a way that part of the fluid is displaced towards the contour of the container, increasing the pressure inside the container, as well as producing an effect of local inflation, obtaining:
at least one face of support or additional face in the area of the container that impacts the impact body (6) which keeps the container of foot stably as also, in turn, modify the geometric configuration of the container, and
at least a flap or triangular body contiguous to the face of support or additional face and formed by at least two sides of the container, and
to seal, for example, by means of a heat source, by at least one of the faces of at least a part of at least one flap, to maintain permanently stable at least one the face of support or additional face.

2. Procedure in accordance with claim 1 characterized by that the sealing stage is carried out in an area of intersection of flap or triangular body of configuration with the face of support or the rest of the container.

3. Procedure according to claim 1 characterized in that includes an additional step of cutting total or partially at least one of the flaps or triangular bodies of configuration.

4. Procedure in accordance with claim 1 characterized in that incorporates additionally the steps of:
fold the flap or triangular body with respect to the face of support (or additional face) or rest of the container, and
to adhere or to paste the above mentioned flap or triangular body, to the face of support (or additional face) or to the rest the container, using an adhesion medium.

5. Procedure to transform a flexible packaging, wherein the container is equipped with:
at least two faces that delimit an interior enclosure, and which, in turn, these faces are delimited by an outer contour perimeter defined by at least one side edge, and/or
at least one line of sealing or fold that closes the container partially or in its entirety, in which the container houses at least one fluid and can additionally accommodate at least one solid or solids, granulates or powdery,
where the procedure is characterized by comprising the following stage:
to press in direction of the indoor enclosure of the container, by means of a pushing mode as it can be when using at least one impact body (6), on at least a part of at least one side edge of the contour or also against/with/between/in the intermediate area, partial zone, zone or area full of two lateral sides edge adjacent to an end or corner: one, two or more lateral sides of the edge or vertex of the initial container, or vice versa {the side edge against/with/between/in the body of impact (6), so that part of the fluid is moved toward the edge of the container, increasing the pressure inside the container, as well as producing an effect of local inflation, obtaining:
at least one face of support or additional face in the area of the container that impacts the impact body (6) which keeps the container standing in a stable way, and
at least a flap or triangular body contiguous to the face of support or additional face and formed by at least two sides of the container.

6. Procedure in accordance with claim 5, wherein the procedure is characterized by comprising the following stages:
to fold the flap or triangular body with regard to the face of support (or additional face) or rest of the container, and
to adhere or to paste the above mentioned flap or triangular body, to the face of support (or additional face) or to the rest the container, using an adhesion medium.

7. Procedure in accordance with any one of claim 1 or 5, characterized in that the stage of pressing is done by directing the container into the body of impact, and in accordance with a selected operation between manually or automated using mechanical means as for example a robot gripper.

8. Procedure according to any one of claim 1 or 5 characterized in that it incorporates, previously to the step of pressing with the impact body (6), an additional step of holding the container to grab or exert pressure on the fluid packed in the interior of the container to the contour of the container in a distant area to the area of the flaps, where the body impact acts (6) and an additional step of liberation of the container (or release, but still exerting pressure on the container, to keep it grabbed) when applying these bodies of impact, in such a way that enables inflation of the container so that in this way this one acquires the form of a three-dimensional geometric body.

9. Procedure according to any one of claim 1 or 5 characterized in that the stage pressing involves applying pressures simultaneously through the bodies of impact in two or more different directions by either side: creating a cavity in which the initial container adapting to it, will acquire the same shape.

10. Procedure according to any one of claim 1 or 5 characterized in that that impact bodies comprise a double set of clamps gags (6, 8), that comprise a body of impact (6) and a sealing clamp (8) or of sealing and cutting (8) or, also but, two bodies of impact (6): which are positioned facing each other during the press on at least a part of both sides contiguous perimeter, and move by defining a flap between the sides perimeter.

11-12. (canceled)

13. Procedure of development and improvement of other procedures of three-dimensional configuration containers that are manufactured with flexible materials by example type film in coil, where the procedure comprises the following steps:
to generate a flexible container body by example from the film in a coil; and
to configure least a flap or bodies of outstanding triangular configuration of the body of the container;
characterized in that it additionally comprise the following step:
to seal at least one, two, three, four or more than four of the flaps or body of triangular configuration for at least one of the faces of at least part of at least a flap or body of triangular configuration, using a means of sealing as for example that of a heat source.

14. Procedure in accordance with claim 13 characterised because the stage of sealing is performed in an area of intersection of the flap or body triangular configuration with the face of support (or additional face) or the rest of the container.

15. Procedure in accordance with the claim 13, characterized in that it includes an additional step of cutting total or partially at least one of the flaps or bodies of triangular configuration.

16. Procedure in accordance with claim 13 characterized in that it incorporates additional steps:
to fold the flap or triangular body with respect to the face of support (or additional face) or to the rest the container, and
to adhere or to paste the above mentioned flap or triangular body, to the face of support (or additional face) or to the rest the container, using an adhesion medium.

17. Procedure of improving and upgrading of the filling machines that manufacture packaging or initial sealed containers of at least two sides and that inside it houses at least one fluid [(liquid or/and pasty) or/and (air or/and gas)] and can additionally lodge at least one solid or solids, granules or powdery, which includes:
means of generating bodies of containers from the film in coil,
At least one device of jaws or set of two parallel jaws with which they are sealed and cut transversely and horizontally (above and below) the initial containers of at least two faces,
that is characterized by comprising:
A set of two jaws of sealing and cutting, parallel and twin, in straight form in a horizontal position, designed to seal and cut horizontally on the top and the bottom the that will be containers or initial containers of at least two faces.
A set of two twin jaws and parallel of sealing and cutting equipped with multiform stretches (never in a single straight horizontal line), destined to seal the container in an intermediate position between the above and below and generate simultaneously two containers of complementary forms, in which these can be in each cycle of manufacture, of two types:
when the containers/initial containers resulting are two complementary forms different between them, which I have called the “ON” container and the “OFF” containers, where the multiform jaw does not have the form of a single straight line.
when the containers/initial container resulting are two complementary of identical forms between them, where the multiform jaw has the form of a single straight line arranged diagonally, with the desired degrees of inclination.

18. Machine to transform a flexible container, being said container fitted with:
At least two sides that delimit an interior enclosure, and that in turn these faces are delimited by an external contour edge defined by at least one side edge, and
At least one line of sealing or fold that closes the container,
In the that the packaging is home to at least a fluid and in addition can hold at least one solid or solids, granules or powdery,
where the machine is characterized by comprising:
at least one support, at least one sensor (1) designed to detect the initial container or the container initially introduced;
at least one body of impact (6) mobile [powered by means of linear displacement (9) and/or rotatory (16)] or/and immobile: aimed at exerting pressure in one, two or more lateral directions of the outer perimeter edge, one or more sides perimeter to generate at least a flap or body triangular configuration;
At least one sealing jaw (8) or of sealing and cutting (8) driven by means of linear displacement (9) and/or rotatory (16), intended to seal or seal and cut in one or more of the faces and/or part of the outer contour or side edge, at least part of at least one of these flaps or body of triangular configuration, in which the sealing jaws (8) have at least one mode of heat source, to permanently retain the support face or additionally generated face.

19. Machine according to claim 18, characterized in that the sealing jaws (8) and the bodies of impact (6) are selected from among:
a set of double jaws which includes a sealing jaw (8) or of sealing and cutting (8) and a body of impact (6) aligned (or to be aligned) with the sealing jaw or of sealing and cutting (8);
A set of triple jaws which comprises two sealing jaws (8) and a body of impact (6) that is located in the middle of the sealing jaws (8) or of sealing and cutting (8) and aligned (or to be aligned) with those jaws of sealing or of sealing and cutting (8), and
a set of quad jaws which includes two sealing jaws (8) and two bodies of impact (6) that are located in the middle of the sealing jaws (8) or of sealing and cutting (8) and aligned with the sealing jaws (8) or sealing and cutting (8).
The games of jaws are aligned or are to be aligned, and have a separation between them that allows entering the initial container between them, except when two double sets interact in a same side edge.

20. Machine in accordance with claim 18, characterized in that includes two sets of jaws (6.8) that align or are aligned, and that have to have a separation between them, in which at least as minimum the container or the initial container which you want to transform, is able to enter or be entered between the set of jaws (6.8).
The jaws (6.8) are selected from among the following sets of jaws:
one or two sets (triple or/and quad) or/and one, two, three or four double sets: in which the jaw of impact (6) may be mobile [powered by means of linear displacement (9) and/or rotatory (16)] or/and immobile.

21. Machine according to claim 18, 19, or 20 characterized by including at least one additional step and prior to being introduced the initial container to the machine or between the clamping jaws (3): in which at least a body of impact (6) or/and at least one sealing jaw (8) or of sealing and cutting (8) or, but also, at least one set of double, triple or quadruple jaws (6.8) or/and, in some cases, the jaws (3): to be displaced and after returning to the starting point, by means of a mechanical mode drive or as a linear cylinder (9) or/and rotating (16) or as well the unit of a linear movement (17): with the purpose as well only to enable space for which the initial container can be introduced without difficulty in the point or the place of start the machine, where the initial container is transformed to the shape that we want to of geometric body in 3D.

22. Machine according to claim 18, 19, or 20 characterized in that it also comprises at least one clamping jaw (3) or one or more sets of two or more clamping jaws (2, 3) designed to grab the container and/or to exercise pressure on the fluid in the inner container towards the contour of the container, in a remote area to the area of the flaps where acts the body of impact (6), in which the clamping jaws are retractable to release (or release but still putting pressure on the container, so keep it grabbed) when they apply such impact bodies, in such a way that enables the inflation of the container so that this take the form of a three dimensional geometric body. Also, the pressure enhances the formation of the flap.

23. Machine according to claim 18, 19, or 20-characterized in that it also includes a trap door (10), driven by means of linear displacement and/or rotating, which is intended to be positioned below and away from the initial container or the clamp (3), to well serve as a basis of support for the original packaging prior to its transformation, as well as includes means of travel in height of the flap designed to regulate the height of the template and to put the initial container to the exact height we want, for which the clamping jaws (3) grab the initial container in the middle area, on the ends or the non-contiguous area of the lateral side perimeter from where originate the flaps.

24. Machine in accordance with claim 18, which is characterized by including:
at least one support,
at least one sensor (1) designed to detect the initial container or the container initially introduced in the machine,
a set of triple or quadruple jaws (6, 8) at the top [or also one or two sets of jaws (6, 8)], and
a set of triple or quadruple jaws (6, 8) in the top [or also one or two sets of jaws (6, 8)] at the bottom, in which:
The set of jaws of the top (6, 8) and the one of the below part, are aligned or are to be aligned vertically, and have a separation between them in which at least as minimum the already transformed container or the initial container may pass or be introduced between these two sets of jaws (6, 8), in which the jaws of impact (6) (preferentially with a cylinder shape) of each set are attached to the stem of a rotating cylinder (16) and that, in turn,
the rotating cylinder (16) of the top is attached to the stem of a linear cylinder (9) in vertical].
The sealing jaws or of sealing and cutting of each set or triple/quad of jaws (6.8), are fixed to their respective jaws of impact (6);
the initial container will hit or collide:
in a first instance, on the top of the jaws of impact (6) so it can originate one or two tabs.
In the second instance, the other side parallel to the lateral side where the flaps are clinched by jaws (6.8):
hit [driven by the linear cylinder (9) of the top] against the jaw of impact (6) which is located in the below part, so it can cause the other one or two flaps.
The sealing jaws (8) or of sealing and cutting (8), when operated trap and secured to the container by the flaps (to the container) to be these trapped between two jaws (6.8).
The clamping jaws (6) are intended to turn the container 180° [because to the jaw of impact (6) is attached to the stem of a rotating cylinder (16)] downwards, followed by depositing or releasing the container and, subsequently, the jaw of impact return to the starting point, by turning 180° upwards.

25. Filling machines that manufacture containers or initial containers sealed with one, two, three, four or more welds or sealing of at least two sides, and in its interior accommodate at least a fluid [(liquid or/and pastes) or/and (air or/and gas)] and complementary can accommodate at least one solid or solids, granules or powdery, which consists of:
mediums of generation of bodies of containers from the film in coil,
at least one device of jaws or set of two parallel jaws with which are sealed and cut transversely and horizontally (above and below) the initial container of at least two faces, which is characterized in that it includes:
a set of two jaws of sealing and cutting, and parallel and twins, with rectilinear form in horizontal position, designed to seal and cut horizontally from above and below which will be containers or initial containers of at least two faces.
A set of two jaws parallel and twins of sealing and cutting equipped with multiform stretches (never in a single straight line in horizontal), destined to seal the container in an intermediate position between the above and below and generate simultaneously two containers of complementary shapes.

26. Flexible container, characterized in that it is obtainable by the procedure described in claim 1.

27. Flexible container, characterized in that it is obtainable by the procedure described in the claim 5.

28. (canceled)

29. Flexible container, characterized in that it is obtainable by the procedure described in claim 13.

30. Flexible container, characterized in that it is obtainable by the procedure described in claim 17.

31. Flexible container in the form of a tri dimensional geometric body, in which the container that houses at least a fluid and in addition can accommodate at least one solid or solids, granules or powdery, which is characterized in that it is part of an initial container preferentially square or rectangular in shape, as well as have been generated two flaps that have been: folded and adhered, sealed, sealed and adhered or sealed and cut, obtaining a container with a shape of a vessel hull overturned, which is equipped with a flat supporting square, rectangular or circular face, which have been generated by two lines of welding (2) or two lines of fold at the intersection between the flaps and the rest of the container, as well as in continuity of the face of support, from each end on its left and its right arise two faces in the shape of triangular body arranged in diagonal position upwards on the outside, where the side of the triangle base that makes this intersection with the crease line or welding line of perpendicular type (2) of the flat face of support. Also, the front face and back arise two faces, in this case have trapezoidal body form. The pack has five faces.

32. Flexible container in the form of tri dimensional geometric body, in which the container houses at least a fluid and in addition can accommodate at least one solid or solids, granules or powdery, which is characterized in that it is part of an initial container that has a straight side in a horizontal position, and a plurality of sides (made by means of a sealing mode and cut as for example the multiform jaws) that are of any shape, length, width, in any degree of tilt, and in which these can be combined also randomly among them, of the multiple and varied as we want, or if not, also not taking this initial container of a quadrangular shape with four angles of 90 degrees, So if it has one or more lines (rectilinear; curvilinear; elliptic; winding; semi-cylindrical; zigzag, oblique; etc.) ready or willing between them in many and varied positions (horizontal, vertical; in the degrees of tilt that you want to; etc.), obtaining a container dimensional irregular polyhedral five-sided, once has been generated two flaps or bodies of triangular figure that have been: folded and adhered, sealed, sealed and adhered or sealed and cut, obtaining a container equipped with a flat supporting face with rectangular shape, square or circular, generating two weld lines (2) perpendicular type as well as in continuity of the face of support, of each end to the left and right there are two sides to form Triangular body arranged in diagonal position upwards and outwards, to the desired angle with respect to the bearing face, where the lateral side of the triangle base that makes this intersection with the crease line or welding line of perpendicular type (2) of the flat face of support.

33. Flexible container in the form of tri dimensional geometric body, in which the container houses at least a fluid and in addition can accommodate at least one solid or solids, granules or powdery, which is characterized in that it is part of an initial container preferentially square or rectangular in shape, as well as have been generated by three flaps that have been: folded and adhered, sealed, sealed and adhered or sealed and cut, obtaining a container with parallelepiped shape with a flat supporting face with rectangular, square or circular, as well as it has generated an opposite to the bearing face: a neck meter or an outstanding tip (or an additional flap that was neither folded and adhered, its not sealed, its not sealed and adhered or it's not sealed and cut), obtaining a container of parallelepiped shape similar to that of a teapot shape.

34. Flexible container in the form of tri dimensional geometric body, in which the container houses at least a fluid and in addition can accommodate at least one solid or solids, granules or powdery, which is characterized in that it is part of an initial container preferentially square or rectangular in shape, as well as has been generated four flaps, which have subsequently been: folded and adhered, sealed, sealed and adhered or sealed and cut, obtaining a container of parallelepiped shape of six faces.

35. Flexible container in the form of a tri dimensional geometric body, in which the container houses at least a fluid and in addition can accommodate at least one solid or solids, granules or powdery, which is characterized in that it is part of an initial container rectangular or square shape with three contiguous sides mutually perpendicular and a diagonal side, as well as have been generated two flaps on the opposite side of the diagonal side [generating two weld lines (2) of type perpendicular, as well as in continuity of the face of support, of each end to the left and right there are two sides to form triangular body arranged in diagonal position upwards on the outside, with the desired inclination with respect to the bearing face, Where the lateral side of the triangle base that makes this intersection with the crease line or welding line of perpendicular type (2) of the flat supporting face], which have subsequently been: folded and adhered, sealed, sealed and adhered or sealed and cut, obtaining a container with the polyhedral face flat supporting the opposite diagonal face: rectangular, square or circular, as well as a pronounced meter neck: at one end of the diagonal side.

36-42. (canceled)

43. Container or set of containers, characterized in that it comprises:
at least one flexible packaging such as the ones described in any one of claims 26 to 35 or 69 to 81 in which, preferentially, all flaps have been sealed and cut to ensure, on the one hand, a more hygienic product and, on the other hand, optionally, in any of at least one of their faces: serve as advertising space to be printed by means of at least one ink (preferentially between sheet and sheet of the plastic material); the container is sterilized by the outer surface and contains in a watertight manner a freezable liquid and, in addition, it also includes a shroud, which involves at least one of the containers or more than one at a time, in order to preserve the sterilization.

44. Flexible container in accordance with any one of claims 26 to 35 or 69 to 81 characterized in that any of the flaps or bodies of triangular configuration of each of the containers can be arranged randomly and in combination, in between these alternatives:
without making anything in it;
folded and glued or attached to the rest of the container;
sealed only;
sealed, folded and glued or attached to the rest of the container;
Sealed and cut.

45. Flexible container in accordance with any one of claims 26 to 36 or 69 to 81, characterized in that in any of the containers of the invention in 3D, at least one or more of the perpendicular welding lines (2) can be carried out not only being straight, but also being this of different forms, such as for example: curvilinear, semi-cylindrical concave or convex, semi-cylindrical elliptical concave or convex, zigzag, diagonal, sinuous, undulating, in which any of these can be arranged alternately on a random basis and in combination.

46. Flexible container in accordance with claim 43 characterized in that any of the flaps or bodies of triangular configuration of each of the containers can be arranged randomly and in combination, in between these alternatives:
without making anything in it;
folded and glued or attached to the rest of the container;
sealed only;
sealed, folded and glued or attached to the rest of the container;
Sealed and cut.

47. Flexible container in accordance with claim 43, characterized in that in any of the containers of the invention in 3D, at least one or more of the perpendicular welding lines (2) can be carried out not only being straight, but also being this of different forms, such as for example: curvilinear, semi-cylindrical concave or convex, semi-cylindrical elliptical concave or convex, zigzag, diagonal, sinuous, undulating, in which any of these can be arranged alternately on a random basis and in combination.

48-62. (canceled)

63. Procedure according to claim 2 characterized by that includes an additional step of cutting total or partially at least one of the flaps or triangular bodies of configuration.

64. Procedure in accordance with claim 2 characterized in that incorporates additionally the steps of:
fold the flap or triangular body with respect to the face of support (or additional face) or rest of the container, and
to adhere or to paste the above mentioned flap or triangular body, to the face of support (or additional face) or to the rest the container, using an adhesion medium.

65. Procedure in accordance with the claim 1 characterized in that it comprises additionally a stage of applying at least to one of the edges or exterior surface of the container by means of pinching clamps (19): a line edge weld (3) generated by together, folding and sealing the part either of at least part of at least two adjacent sides of an edge or outer surface of the container.

66. Procedure in accordance with the claim 5 or 6 characterized in that it comprises additionally a stage of applying at least to one of the edges or exterior surface of the container by means of pinching clamps (19): a line edge weld (3) generated by together, folding and sealing the part either of at least part of at least two adjacent sides of an edge or outer surface of the container.

67. Procedure in accordance with the claim 14, characterized in that includes an additional step of cutting total or partially at least one of the flaps or bodies of triangular configuration.

68. Procedure in accordance with claim 14 characterized in that it incorporates additional steps:
to fold the flap or triangular body with respect to the face of support (or additional face) or to the rest the container, and
to adhere or to paste the above mentioned flap or triangular body, to the face of support (or additional face) or to the rest the container, using an adhesion medium.

69. Flexible container, characterized in that it is obtainable by the procedure described in claim 2.

70. Flexible container, characterized in that it is obtainable by the procedure described in claim 63.

71. Flexible container, characterized in that it is obtainable by the procedure described in claim 64.

72. Flexible container, characterized in that it is obtainable by the procedure described in the claim 3.

73. Flexible container, characterized in that it is obtainable by the procedure described in the claim 4.

74. Flexible container, characterized in that it is obtainable by the procedure described in the claim 65.

75. Flexible container, characterized in that it is obtainable by the procedure described in the claim 6.

76. Flexible container, characterized in that it is obtainable by the procedure described in the claim 66.

77. Flexible container, characterized in that it is obtainable by the procedure described in claim 14.

78. Flexible container, characterized in that it is obtainable by the procedure described in claim 67.

79. Flexible container, characterized in that it is obtainable by the procedure described in claim 68.

80. Flexible container, characterized in that it is obtainable by the procedure described in claim 15.

81. Flexible container, characterized in that it is obtainable by the procedure described in claim 16.

82. Procedure in any of the containers of the invention contains within only a gaseous fluid such as air and/or gas, in accordance with anyone of claim 1 or 5 characterized in that once the initial container has been transformed in 3D container of the invention will be emptied by means of a mode as for example by crushing and/or folding the container in 3D, therefore previously by a mode has undergone a notch or cut in at least part of the area or line of welding in the top of the container; so that, subsequently, the container will be carried to another Production Plant, in this way the containers will be filled again within any fluid or/and at least one solid or solids/granules/powders, as well as optionally, an additional sealing step of partial or full (Sealingly) container using a mode such as a heat source.

83. Procedure of development and improvement of other procedures of three-dimensional configuration containers that are manufactured with flexible materials by example type film in coil, where the procedure comprises the following steps:
to generate a flexible container body by example from the film in a coil;
characterized in that it additionally comprise the following step:
applying at least to one of the edges or exterior surface of the container by means of pinching clamps (19): a line edge weld (3) generated by together, folding and sealing the part either of at least part of at least two adjacent sides of an edge or outer surface of the container, to provide rigidity and stability to the container, as well as optionally provide a weld line opening through which opening the container.

84. Flexible container, characterized in that it is obtainable by the procedure described in the claim 82.

85. Flexible container, characterized in that it is obtainable by the procedure described in the claim 83.
